(19) United States
(12) Patent Application Publication
(10) Pub. No.: US 2015/0034753 A1
(43) Pub. Date: Feb. 5, 2015

(54) SEATBELT RETRACTOR

(71) Applicant: ASHIMORI INDUSTRY CO., LTD., Osaka-shi, Osaka (JP)

(72) Inventors: Eri Yamane, Osaka (JP); Insu Choi, Osaka (JP)

(21) Appl. No.: 14/381,080

(22) PCT Filed: Feb. 25, 2013
(86) PCT No.: PCT/JP2013/054802

§ 371 Date: Aug. 26, 2014

(30) Foreign Application Priority Data
Mar. 7, 2012 (JP) 2012-050616

(51) Int. Cl. B60R 22/40; B60R 22/46; B60R 22/34

(52) U.S. Cl. CPC B60R 22/40; B60R 22/341; B60R 22/4633; B60R 2022/468
USPC 242/384.5

(57) ABSTRACT

A pilot lever includes: a sleeve portion configured to be rotatably fitted on a mounting boss erected on a clutch rotatably arranged coaxially with a take-up drum; and an engagement claw portion projecting outward from an outer circumferential surface of the sleeve portion so as to face a locking gear attached integrally and coaxially with the take-up drum, and configured to engage with the locking gear. In case of an emergency, the engagement claw portion engages with one locking gear tooth formed on an outer circumference portion of the locking gear. The engagement claw portion is then elastically deformable toward the sleeve portion when pushed by the one locking gear tooth under the engaged state. If the engagement claw portion and the one locking gear tooth are disengaged, the elastic deformation of the engagement claw portion is released.

### TECHNICAL FIELD

The present invention relates to a seatbelt retractor which prevents a webbing from being drawn out in case of an emergency such as vehicle collision.

### BACKGROUND ART

Conventionally, there have been proposed various types of seatbelt retractors which prevent a webbing from being drawn out in case of an emergency such as vehicle collision.

For instance, in a webbing-take-up device disclosed in Japanese Laid-open Patent Application Publication No. 2006-188148, on a lower end portion of a main body 130 of a sensor gear 128, a shaft 129 is formed projecting at an end portion of a pressing portion 168 projecting toward a V gear 126 side, opposite to the V gear 126 side. Further, an engaging claw 140 serving as a connecting member is supported at the shaft 129 and is rotatable around an axis. An acceleration sensor 142 is provided beneath the engaging claw 140. When a vehicle experiences an acceleration exceeding a predetermined value, a sensor claw 150 of the acceleration sensor 142 is pushed upward by a hard ball 148 to rotate the engaging claw 140 upward.

The V gear 126 is arranged on the rotation direction side of the engaging claw 140 rotated upward by the sensor claw 150. The V gear 126 has ratchet teeth on an outer circumference portion thereof, and thereby the engaging claw 140 engages the V gear 126. The engagement of the engaging claw 140 with the V gear 126 helps transmit the rotational force of the V gear 126 in webbing pull-out direction to the sensor gear 128, so that the pressing portion 168 rotates a lock pawl 160. By the rotation of the lock pawl 160, a pawl portion 166 engages with a ratchet portion 172 of a lock base 170 so that a spool 24 is prevented from rotating in the webbing pull-out direction.

### DISCLOSURE OF THE INVENTION

### Problem to be Solved by the Invention

However, in such a conventional webbing-take-up device as disclosed in the above-described patent publication, if out-of-synchronization causes a delay in the timing of the engagement of the pawl portion 166 of the lock pawl 160 with the ratchet portion 172 of the lock base 170 after the engagement of the engaging claw 140 with the V gear 126, a large impact load in a direction of the shaft 129 acts on the engaging claw 140 engaged with the V gear 126, by the rotation in webbing pull-out direction of the V gear 126 relative to the sensor gear 128.

This may cause damage in at least one of the engaging claw 140 and the V gear 126 so that the lock mechanism may become dysfunctional, and rotation in the webbing pull-out direction of the spool 24 may not be prevented. The improvement of the sensitivity of the acceleration sensor 142 requires downsizing the engaging claw 140 to have a smaller mass; however, the engaging claw 140 is difficult to be downsized due to its necessity to withstand the pressing load from the V gear 126.

The present invention has been made in view of the above-described problems and an object thereof is to provide a seatbelt retractor capable of preventing a damage of a pilot lever and a locking gear, as well as achieving the downsizing or the pilot lever.

### Means for Solving the Problem

To achieve the object of the present invention, there is provided a seatbelt retractor comprising: a housing; a take-up drum rotatably housed in the housing and configured to take-up and store a webbing; a ratchet gear configured to rotate integrally with the take-up drum; a lock mechanism configured to prohibit the take-up drum from rotating in a webbing-pull-out direction in case of an emergency; an inertial mass configured to oscillate in response to vehicle acceleration at a predetermined value or higher; and a sensor lever configured to be swung vertically upward by a push of the inertial mass to activate the lock mechanism, wherein the lock mechanism comprises: a clutch rotatably arranged coaxially with the take-up drum, and configured, by its rotation, to guide a pawl configured to engage with the ratchet gear and then prohibit the take-up drum from rotating in the webbing pull-out direction; a pilot lever rotatably supported at a mounting boss erected on the clutch and configured to rotate by a push of the swung sensor lever; and a locking gear attached integrally and coaxially onto the take-up drum and configured to engage with the pilot lever having rotated, wherein the pilot lever comprises: a sleeve portion configured to be rotatably fitted on the mounting boss; and an engagement claw portion projecting outward from an outer circumferential surface of the sleeve portion so as to face the locking gear, and configured to engage with the locking gear, and wherein, the engagement claw portion is configured to: on an emergency, engage with one locking gear tooth of locking gear teeth formed on an outer circumference portion of the locking gear; elastically deform toward the sleeve portion by a push of the one locking gear tooth after the engagement on the emergency, and release the elastic deformation when disengaged with the one locking gear tooth.

In the seatbelt retractor, the engagement claw portion of the pilot lever projects outward from the outer circumferential surface of the sleeve portion so as to face the locking gear and engages with the locking gear. The engagement claw portion is configured elastically deformable toward the sleeve portion if pushed by a locking gear tooth after engaging with the locking gear tooth formed on the outer circumference portion of the locking gear. The elastic deformation of the engagement claw portion is configured to be released when the engagement claw portion is disengaged from the locking gear tooth.

Accordingly, the impact load on the pilot lever and the locking gear can be reduced by the elastic deformation of the engagement claw portion toward the sleeve portion when the pilot lever is pushed by the locking gear, preventing a damage of the pilot lever and the locking gear. The engagement claw portion can be made thin and small to a degree that allows elastic deformation toward the sleeve portion when engaged with and then pushed by the locking gear tooth, and as a result, the pilot lever can also be downsized.

Further, in the above seatbelt retractor of the present invention, the engagement claw portion is configured to elastically deform in a large amount toward the sleeve portion by a push of the one locking gear tooth and to disengage from the one locking gear tooth currently engaged, if a delay occurs in timing of the engagement of the pawl and the ratchet gear when the engagement claw portion has engaged with the one locking gear tooth.

In the seatbelt retractor, on an emergency, if a delay is caused by out-of-synchronization in the timing of the engagement of the pawl and the ratchet gear after the engagement claw portion of the pilot lever has engaged with the locking gear tooth formed on the outer circumference portion of the locking gear, the engagement claw portion elastically deforms in a large amount toward the sleeve portion side and disengages from the locking gear tooth having engaged with, so that the damage of the pilot lever and the locking gear can be prevented.

Further, on an emergency, the engagement claw portion engages with the locking gear tooth formed on the outer circumference portion of the locking gear. Thereafter, even if the engagement claw portion of the pilot lever is disengaged from the locking gear tooth having engaged with, when a delay occurs in the timing of the engagement of the pawl and the ratchet gear, the engagement claw portion elastically returns to the original shape. Accordingly, if rotated vertically upward again and thereafter pushed by the sensor lever, the engagement claw portion can be engaged with a locking gear tooth opposite to the engagement claw portion, so that rotation of the take-up drum in the webbing pull-out direction can surely be prevented.

Further, after the engagement claw portion has engaged with the locking gear tooth formed on the outer circumference portion of the locking gear on an emergency, the engagement claw portion elastically deforms toward the sleeve portion and is disengaged from the locking gear tooth having been engaged with, when a delay occurs at the timing of the engagement of the pawl and the ratchet gear. Accordingly, a much smaller and thinner engagement claw portion can be realized, and as a result, a still smaller pilot lever can be realized.

Further, in the above seatbelt retractor of the present invention, the engagement claw portion is formed approximately L-shaped, when viewed in a rotational axis direction, with a tip portion thereof obliquely bent toward the locking gear. Further, the engagement claw portion is configured to elastically deform toward the sleeve portion, at a portion at which the tip portion of the engagement claw portion is obliquely bent, when pushed by the one locking gear tooth.

In the seatbelt retractor, the engagement claw portion of the pilot lever is formed approximately L-shaped when viewed from the rotational axis direction, with the tip portion thereof obliquely bent toward the locking gear, and is elastically deformable toward the sleeve portion side, at a portion where the tip portion of the engagement claw portion is obliquely bent, when pushed by a locking gear tooth after engaging with the locking gear tooth

Accordingly, when pushed by the locking gear tooth, the engagement claw portion elastically deforms toward the sleeve portion side at the portion at which the tip portion of the engagement claw portion is obliquely bent, which results in further reduction of an impact load on the pilot lever and the locking gear, and the damage of the pilot lever and the locking gear can effectively be prevented. Further, the tip portion of the engagement claw portion is obliquely bent toward the locking gear, enabling smooth disengagement from the locking gear tooth formed on the outer circumference portion of the locking gear at large amount of elastic deformation toward the sleeve portion. Thus, a further downsized and thin engagement claw portion can be obtained, and as a result, the pilot lever can be made further smaller.

Further, in the above seatbelt retractor of the present invention, the engagement claw portion is formed such that an end face portion facing the locking gear becomes gradually lower from both end portions of a base end portion on a side of the sleeve portion and the tip portion, toward an approximately central portion, across an entire width in the rotational axis direction. Further, the engagement claw portion is configured to elastically deform toward the sleeve portion, at the approximately central portion of the engagement claw portion, when pushed by the one locking gear tooth.

In the seatbelt retractor, the engagement claw portion of the pilot lever is formed such that the end face portion facing the locking gear becomes gradually lower, from both end portions of the base end portion on the sleeve portion side and the tip portion, toward the approximately central portion, across the entire width in the rotational axis direction. The engagement claw portion is configured elastically deformable toward the sleeve portion at the approximately central portion from the tip portion of the engagement claw portion to the base end portion on the sleeve portion side, when pushed by the locking gear tooth after engaged with the locking gear tooth.

Thus, by elastically deforming toward the sleeve portion side at the approximately central portion from the tip portion of the engagement claw portion to the base end portion on the sleeve portion side when pushed by the locking gear tooth, the engagement claw portion can further reduce the impact load on the pilot lever and the locking gear, and also effectively prevent a damage of the pilot lever and the locking gear. Further, the elastic deformation toward the sleeve portion side occurs at the approximately central portion from the tip portion of the engagement claw portion to the base end portion on the sleeve portion side. Accordingly, when the engagement claw portion elastically deforms in a large amount toward the sleeve portion, the engagement claw portion elastically deforms in an approximately U-shape when viewed from the rotational axis direction so as to enable smooth disengagement from the locking gear tooth formed on the outer circumference portion of the locking gear. Accordingly, the engagement claw portion can further be downsized and reduced in thickness, to realize a further smaller pilot lever.

Further, in the above seatbelt retractor of the present invention, the clutch comprises an opening portion configured to allow the pilot lever pushed and rotated by the sensor lever to enter therein and engage with one locking gear tooth. Further, when the engagement claw portion is pushed by the one locking gear tooth and elastically deforms toward the sleeve portion, a predetermined clearance is formed between an end portion of the opening portion on a side of the sleeve portion and the engagement claw portion.

In the seatbelt retractor, after entering inside the opening portion of the clutch and engaging with the locking gear tooth, the engagement claw portion is elastically deformed by the push of the locking gear tooth. A predetermined clearance is formed between the elastically-deformed engagement claw portion and the end portion on the sleeve portion side of the opening portion. Accordingly, the interference by the clutch to the elastic deformation of the engagement claw portion can be securely prevented, and the damage of the pilot lever and the locking gear can further be suppressed without hindering the elastic deformation of the pilot lever.

Further, in the above seatbelt retractor of the present invention, the pilot lever comprises: a contact portion having a thin plate-like shape arranged approximately parallel to the engagement claw portion, and configured to make contact with and to be pushed by the swung sensor lever; and a connecting plate portion having a thin plate-like shape and connecting both tip end sides of the contact portion and the engagement claw portion. Further, the contact portion is elastically deformable toward the sleeve portion, together with the engagement claw portion.

In the seatbelt retractor, both tip portions of the thin plate-like contact portion at which the engagement claw portion of the pilot lever makes contact with the sensor lever are connected by the thin plate-like connecting plate portion, and the contact portion is arranged elastically deformable toward the sleeve portion together with the engagement claw portion. Thus, the engagement claw portion can be further made thinner while maintaining the mechanical strength thereof, so that the pilot lever can be made lighter and smaller.

Further, in the above seatbelt retractor of the present invention, the clutch comprises a pilot lever support portion projecting so as to oppose to, and form a predetermined clearance with, an outer circumferential surface of the sleeve portion fitted onto the mounting boss, on an diametrically opposite side with regard to the engagement claw portion. Further, the pilot lever comprises an upward rotation restrictor portion erected radially outward from the outer circumferential surface of the sleeve portion so as to oppose to, and form a predetermined clearance in a rotation direction with, the pilot lever support portion. Further, if the engagement claw portion engages with one locking gear tooth formed on the outer circumference portion of the locking gear on an emergency, under a state where the upward rotation restrictor portion abuts on one end face in circumferential direction of the pilot lever support portion to regulate vertically upward rotation, the pilot lever causes the clutch to rotate along rotation of the locking gear.

In the seatbelt retractor, on an emergency, the engagement claw portion engages with locking gear tooth formed on the outer circumference portion of the locking gear and thereafter the pilot lever is further rotated by the push of the locking gear. At that time, in the pilot lever, the upward rotation restrictor portion abuts on one end portion in the circumferential direction of the pilot lever support portion so as to regulate vertically-upward rotation thereof.

Accordingly, the pressing load that the pilot lever receives from the locking gear is also supported by the pilot lever support portion through the upward rotation restrictor portion. Accordingly, the pressing load that the pilot lever receives from the locking gear can be supported not only by the mounting boss but also by the pilot lever support portion through the upward rotation restrictor portion. Thus, deformation or damage of the sleeve portion of the pilot lever or the mounting boss can be prevented with a simple configuration.

Further, in the above seatbelt retractor of the present invention, the pilot lever comprises a downward rotation restrictor portion erected radially outward from the outer circumferential surface of the sleeve portion with a predetermined clearance in a rotation direction between the pilot lever support portion, in such a manner that the pilot lever support portion is interposed between the downward rotation restrictor portion and the upward rotation restrictor portion. Further, if the engagement claw portion rotates by its own weight, the downward rotation restrictor portion abuts on another end face in the circumferential direction of the pilot lever support portion, to regulate the pilot lever with regard to vertically downward rotation.

In the seatbelt retractor, the pilot lever is configured such that the pilot lever support portion is interposed between the upward rotation restrictor portion and the downward rotation restrictor portion, while securing a predetermined clearance in the rotation direction. Accordingly, rotation of the pilot lever can be regulated with a simple configuration, and component shapes of the clutch and the pilot lever can further be simplified.

Further, in the above seatbelt retractor of the present invention, if the engagement claw portion engages with one locking gear tooth formed on the outer circumference portion of the locking gear on an emergency to cause the mounting boss to warp, under a state where the outer circumferential surface of the sleeve portion abuts on the pilot lever support portion, the clutch is rotated along the rotation of the locking gear.

In the seatbelt retractor, when the engagement claw portion engages with the locking gear tooth formed on the outer circumference portion of the locking gear on an emergency and causes the mounting boss to warp, the pressing load acting on the pilot lever from the locking gear can be supported by the pilot lever support portion through the outer circumferential surface of the sleeve portion and the upward rotation restrictor portion, so that even if a larger pressing load is applied by the locking gear, the deformation or damage of the mounting boss or the sleeve portion can further be prevented with a simple configuration. By enlarging the cross sectional shape of the pilot lever support portion projecting at the clutch, the mechanical strength of the pilot lever support portion can be made stronger, and deformation or damage of the mounting boss or the sleeve portion can be effectively prevented.

Further, in the above seatbelt retractor of the present invention, the clutch comprises an elastic engagement piece erected elastically deformably, radially outward with regard to the sleeve portion, while forming a predetermined clearance with the sleeve portion fitted on the mounting boss, and having, on a tip portion thereof, a fixing projection projecting toward the sleeve portion. Further, the pilot lever comprises a convex portion projecting radially outward from the outer circumferential surface facing the elastic engagement piece, of the sleeve portion fitted on the mounting boss. Further, through fitting the sleeve portion onto the mounting boss, the convex portion is arranged contactably with the fixing projection from a base end side of the elastic engagement piece, and the pilot lever is rotatably attached to the mounting boss.

In the seatbelt retractor, by fitting the sleeve portion onto the mounting boss, the convex portion projecting from the outer circumferential surface of the sleeve portion is contactably mounted onto the fixing projection projecting from the tip portion of the elastic engagement piece toward the sleeve portion side from the base end side of the elastic engagement piece, and the pilot lever is rotatably mounted onto the mounting boss. Accordingly, slip-off of the pilot lever from the mounting boss can securely be prevented with a simple configuration.

### BRIEF DESCRIPTION OF THE DRAWINGS

FIG. 1 is a perspective view showing an external appearance of a seatbelt retractor according to an embodiment;

FIG. 2 is a perspective view showing respective assemblies of the seatbelt retractor in a disassembled state;

FIG. 3 is a perspective view showing respective assemblies of the seatbelt retractor in a disassembled state;

FIG. 4 is an exploded perspective view of a housing unit;

FIG. 5 is an exploded perspective view of a ratchet gear, a take-up spring unit and a locking unit;

FIG. 6 is an exploded perspective view of the ratchet gear, the take-up spring unit and the locking unit;

FIG. 7 is a sectional view for illustrating a mounting operation of a spring case;

FIG. 8 is a sectional view for illustrating a mounting state of the spring case;

FIG. 9 is a cross sectional view of an assembled state including a locking arm of the locking unit;

FIG. 10 is a partial cutaway sectional view showing the locking unit with a bottom face portion of a mechanism cover partially cut away;

FIG. 11 is an enlarged sectional view of a principal portion of the seatbelt retractor including the take-up spring unit and the locking unit;

FIG. 12 is a perspective view showing an external appearance of a clutch;

FIG. 13 is a perspective view of an internal appearance of the clutch;

FIG. 14 is a perspective view of the clutch seen orthogonally from below;

FIG. 15 is a perspective view of a pilot lever;

FIG. 16 is a perspective view of the pilot lever;

FIG. 17 is an enlarged view of a principal portion of the pilot lever in a normal operation;

FIG. 18 is an enlarged view of the principal portion of the pilot lever engaged with a locking gear;

FIG. 19 is a view for illustrating an operation of the locking unit by pull-out acceleration of the webbing (before activation);

FIG. 20 is a view for illustrating an operation of the locking unit by pull-out acceleration of the webbing (at a start of the activation);

FIG. 21 is a view for illustrating an operation of the locking unit by pull-out acceleration of the webbing (in shifting to a locked state);

FIG. 22 is a view for illustrating an operation of the locking unit by pull-out acceleration of the webbing (in the locked state);

FIG. 23 is a view for illustrating an operation of the locking unit when starting to take up the webbing (at a start of webbing-taking-up);

FIG. 24 is a view for illustrating an operation of the locking unit at the start of webbing-taking-up (in shifting to a disengaged state);

FIG. 25 is a view for illustrating an operation of the locking unit at the start of webbing-taking-up (in the disengaged state);

FIG. 26 is a view for illustrating an operation of the locking unit by vehicle acceleration (before activation);

FIG. 27 is a view for illustrating an operation of the locking unit by vehicle acceleration (at a start of the activation);

FIG. 28 is a view for illustrating an operation of the locking unit by vehicle acceleration (in shifting to a locked state);

FIG. 29 is a view for illustrating an operation of the locking unit by vehicle acceleration (in a locked state);

FIG. 30 is a view for illustrating an operation of the locking unit when starting to take up the webbing (at a start of webbing taking-up);

FIG. 31 is a view for illustrating an operation of the locking unit at the start of webbing taking-up (in shifting to a disengaged state);

FIG. 32 is a view for illustrating an operation of the locking unit at the start of webbing taking-up (in the disengaged state);

FIG. 33 is a view for illustrating an operation of the locking unit by vehicle acceleration (when a pawl is out-of-synchronization);

FIG. 34 is a view for illustrating an operation of the locking unit by vehicle acceleration (in shifting to a locked state);

FIG. 35 is a view for illustrating an operation of the locking unit by vehicle acceleration (in shifting to the locked state);

FIG. 36 is a cross sectional view of an assembled state including a locking arm of FIG. 35;

FIG. 37 is a view for illustrating an operation of the locking unit by vehicle acceleration (in a locked state);

FIG. 38 is a sectional view of a take-up drum unit including an axial center thereof;

FIG. 39 is an exploded perspective view of the take-up drum unit;

FIG. 40 is a front view of the take-up drum seen from a side for mounting the ratchet gear;

FIG. 41 is a perspective view of the ratchet gear;

FIG. 42 is a front view of an inner side of the ratchet gear;

FIG. 43 is a cross sectional view taken along a line indicated by arrows X1-X1 in FIG. 38 and seen in the direction of the arrows;

FIG. 44 is an exploded perspective view of a pretensioner unit;

FIG. 45 is a view for illustrating an internal configuration of the pretensioner unit;

FIG. 46 is a cross sectional view for illustrating an operation of the pawl at vehicle collision;

FIG. 47 is a view for illustrating a pull-out-wire operation;

FIG. 48 is a view for illustrating the pull-out-wire operation;

FIG. 49 is a view for illustrating the pull-out-wire operation;

FIG. 50 is a view for illustrating the pull-out-wire operation;

FIG. 51 is a perspective view of a pilot lever of a seatbelt retractor according to a different embodiment;

FIG. 52 is a perspective view of the pilot lever of the seatbelt retractor according to the different embodiment;

FIG. 53 is a view for illustrating an operation of a locking unit by vehicle acceleration (when a pawl is out-of-synchronization), with regard to the seatbelt retractor according to the different embodiment;

FIG. 54 is a view for illustrating an operation of the locking unit by vehicle acceleration (in shifting to a locked state), with regard to the seatbelt retractor according to the different embodiment;

FIG. 55 is a cross sectional view of an assembled state including a locking arm of FIG. 54; and

FIG. 56 is a view for illustrating an operation of the locking unit by vehicle acceleration (in a locked state), with regard to the seatbelt retractor according to the different embodiment.

### DETAILED DESCRIPTION OF THE PREFERRED EMBODIMENTS

Hereinafter, an embodiment of a seatbelt retractor according to the present invention will be described in detail while referring to the accompanying drawings.

### [Schematic Configuration]

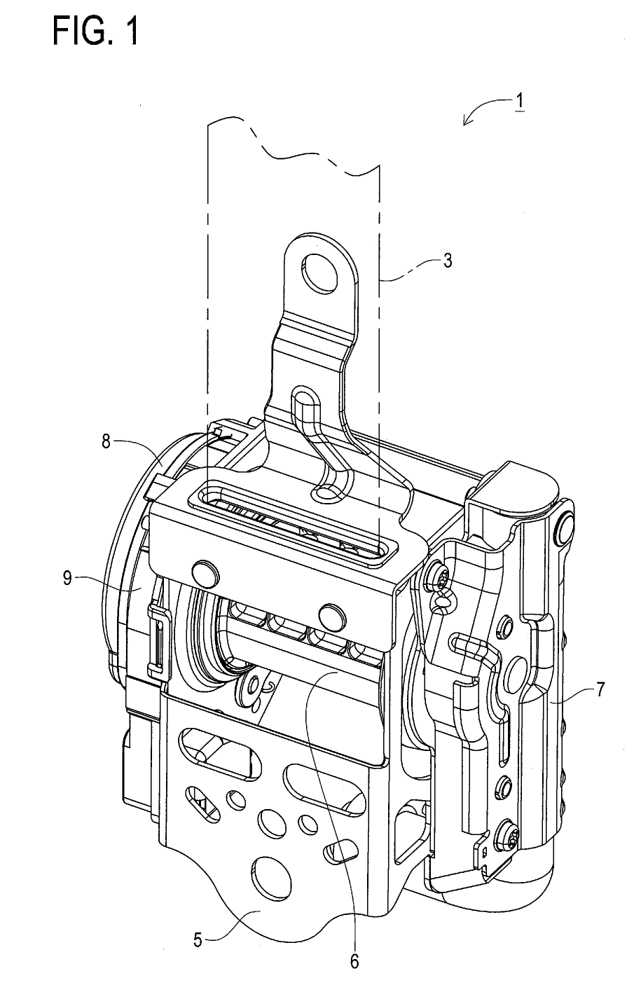

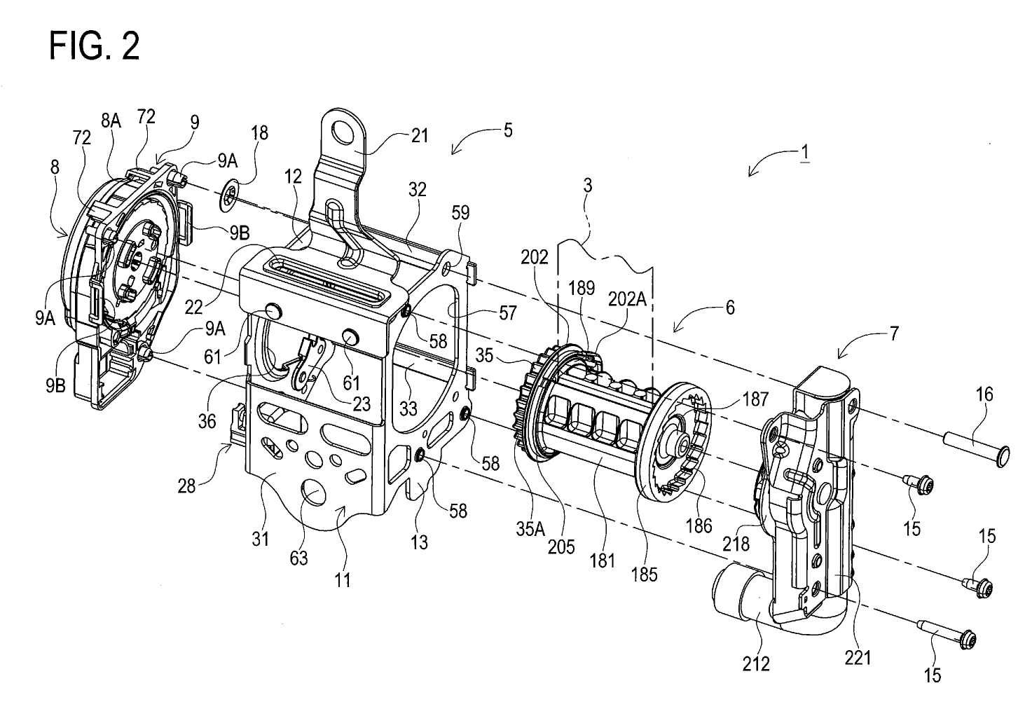

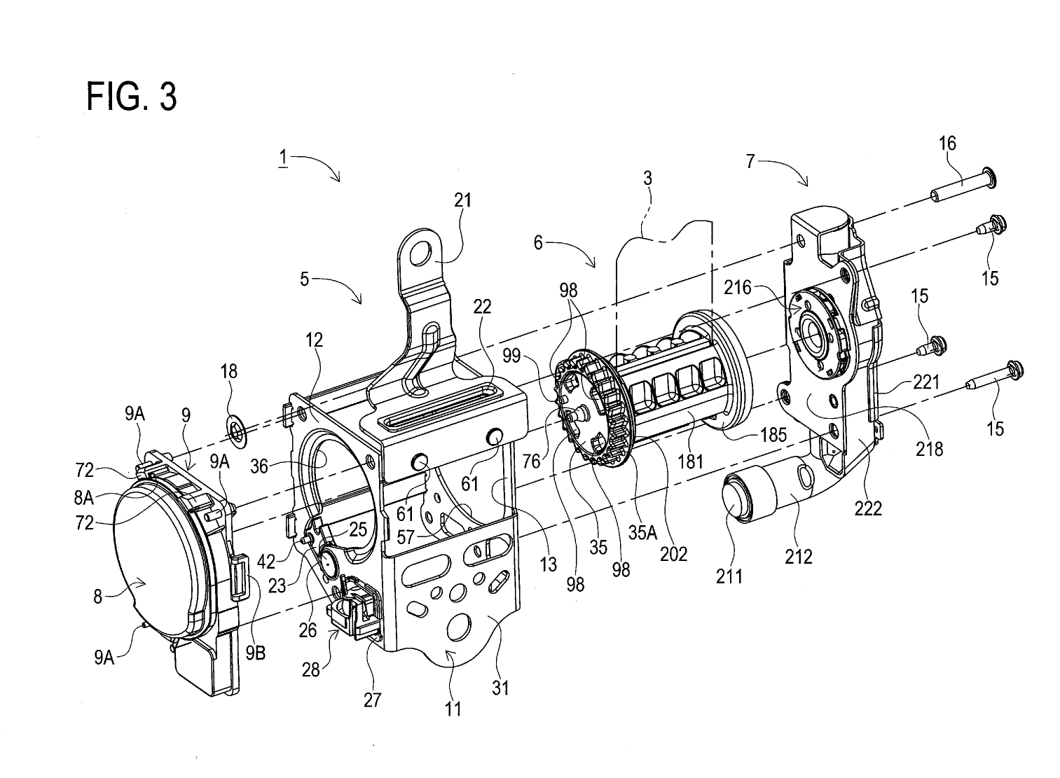

First, a schematic configuration of the seatbelt retractor 1 according to the embodiment will be described based on FIG. 1 through FIG. 3. FIG. 1 is a perspective view showing an external appearance of a seatbelt retractor 1 according to the embodiment. FIG. 2 and FIG. 3 each are a perspective view showing the respective assemblies of the seatbelt retractor 1 in a disassembled state.

As shown in FIG. 1 through FIG. 3, the seatbelt retractor 1 is a device for retracting vehicle webbing 3. The seatbelt retractor 1 has a housing unit 5, a take-up drum unit 6, a pretensioner unit 7, a take-up spring unit 8 and a locking unit 9.

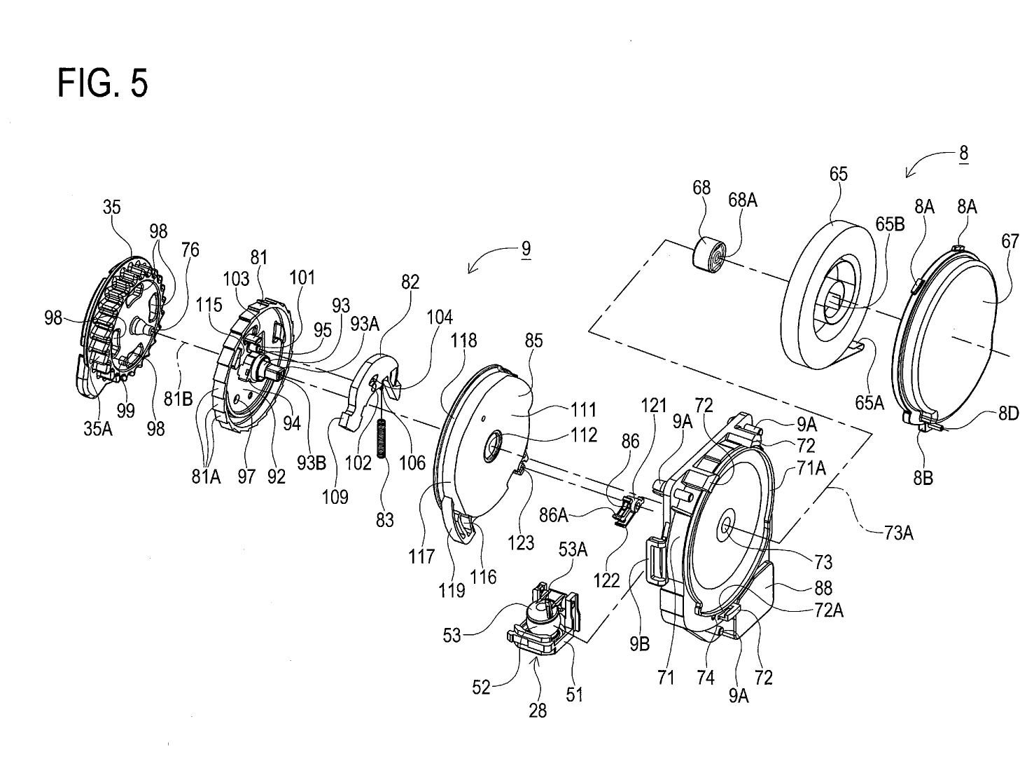

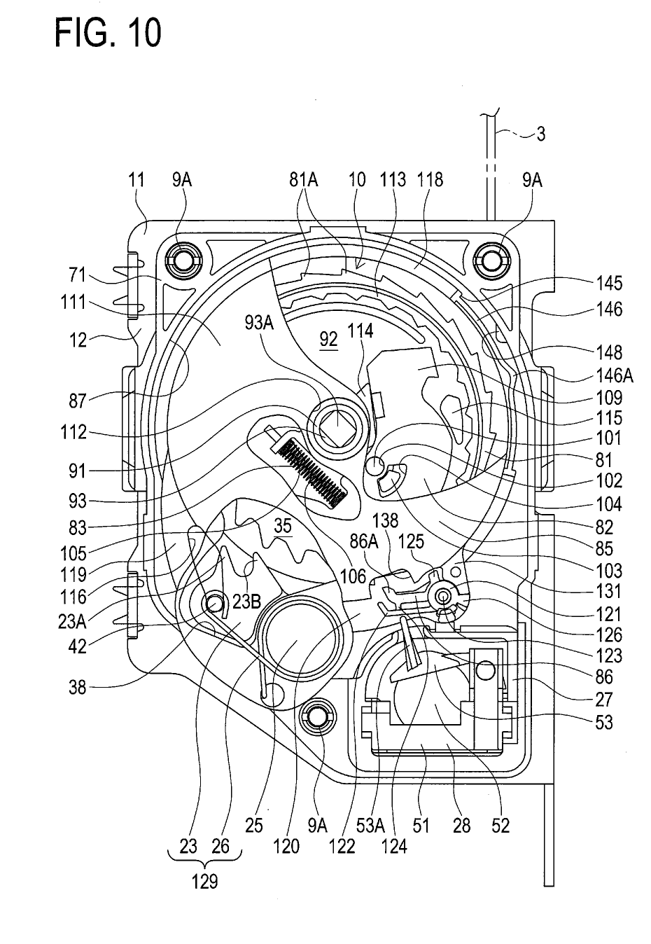

The locking unit 9 has a mechanism cover 71 (refer to FIG. 5) with nylon latches 9A and locking hooks 9B integrally formed thereat. The locking unit 9 is fixed by the nylon latches 9A and the locking hooks 9B at one side wall portion 12 of a housing 11 constituting the housing unit 5. The locking unit 9 constitutes a lock mechanism 10 (refer to FIG. 10) that stops pull-out of the webbing 3 in response to a sudden pull-out of the webbing 3 or an abrupt change in acceleration of a vehicle, to be later described.

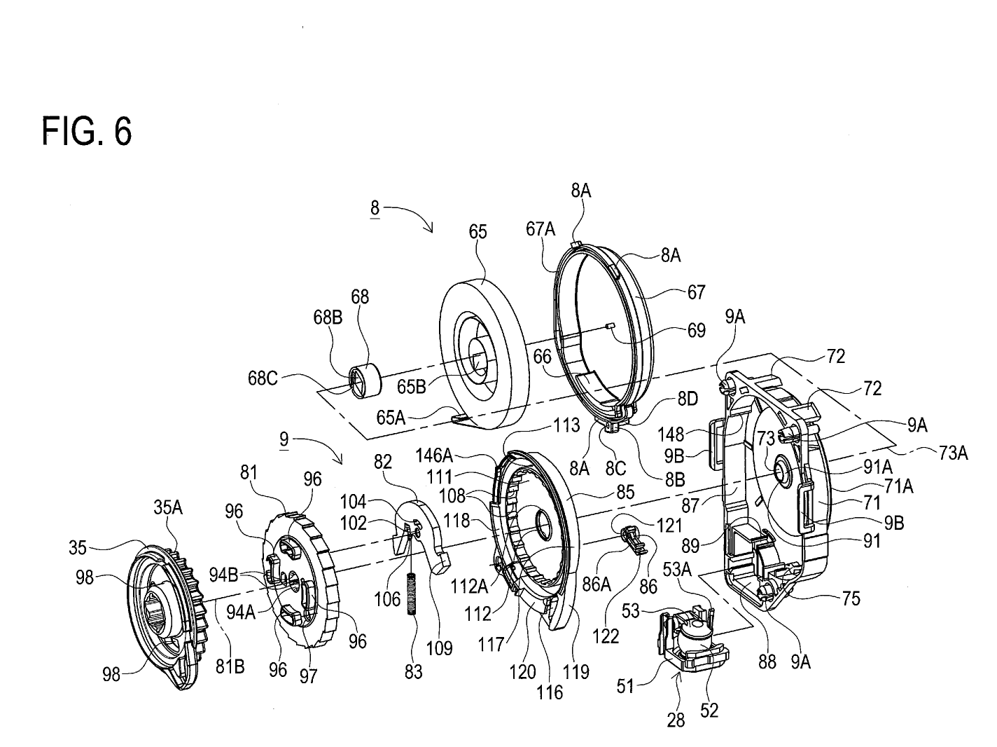

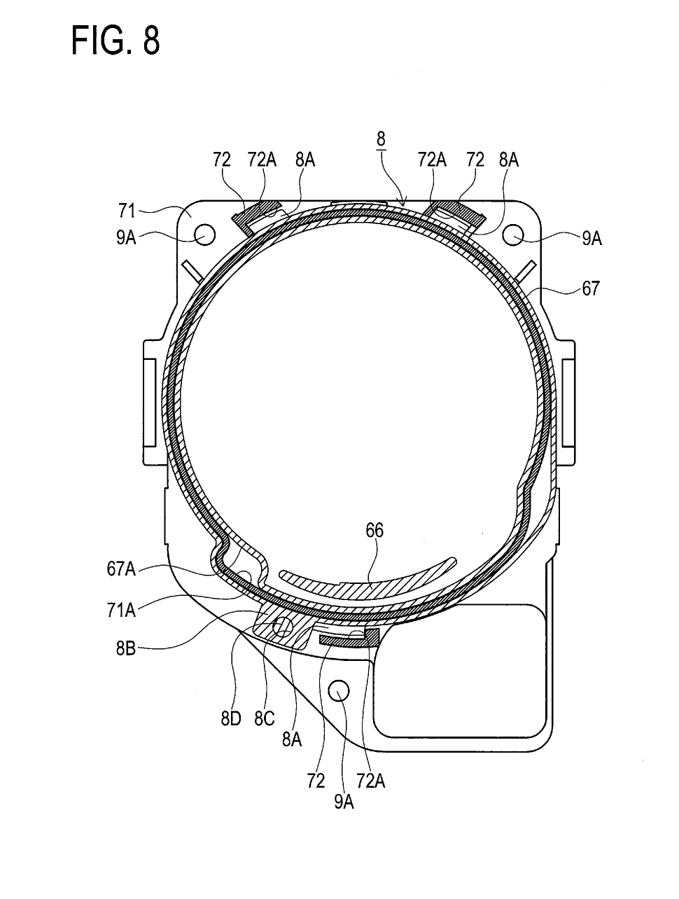

The take-up spring unit 8 is fixed onto the outside in a direction of a rotational axis of the take-up drum unit 6 of the locking unit 9 (refer to FIG. 8), to be later described, through three tabular engagement pieces 8A (refer to FIG. 6) projecting from an outer periphery of a spring case 67 (refer to FIG. 5).

The pretensioner unit 7 is mounted to at a side wall portion 13 of the housing 11. The side wall portion 13 is located opposite to the side wall portion 12 of the housing 11 having a substantially square-bracket shape in plain view, and screwed by screws 15 inserted through from an outside, in a direction of the rotational axis of the take-up drum unit 6, of the pretensioner unit 7. The pretensioner unit 7 is pinned with a stopper pin 16 and a push nut 18. The stopper pin 16 is inserted into the side wall portion 13 from an outside of the pretensioner unit 7 in the direction of the rotational axis of the take-up drum unit 6. The push nut 18 is inserted to the stopper pin 16 from an inside in a direction of the rotational axis of the take-up drum unit 6 with regard to the side wall portion 13.

A take-up drum unit 6 onto which the webbing 3 is wound is rotatably supported between the locking unit 9 fixed to the side wall portion 12 of the housing unit 5 and the take-up spring unit 8 fixed to the side wall portion 13 of the housing unit 5. The take-up drum unit 6 is constantly urged in a take-up direction of the webbing 3 by the take-up spring unit 8 fixed on the outside of the locking unit 9.

### [Schematic Configuration of Housing Unit]

A schematic configuration of the housing unit 5 will next be described referring to FIG. 2 through FIG. 4.

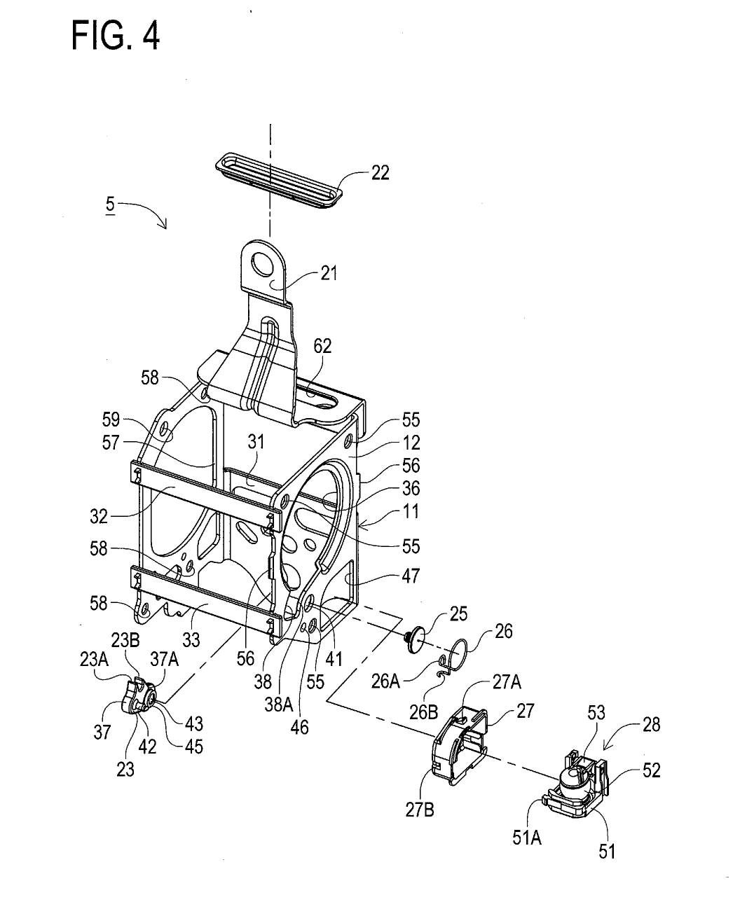

FIG. 4 is an exploded perspective view of the housing unit 5.

As shown in FIG. 2 through FIG. 4, the housing unit 5 includes the housing 11, a bracket 21, a protector 22, a pawl 23, a pawl rivet 25, a twisted coil spring 26, a sensor cover 27, an acceleration sensor 28, connecting members 32, 33, and rivets 61.

The housing 11 has a back plate portion 31 to be fixed at a vehicle body and the side wall portions 12, 13 opposed to each other and extending from both side edge portions of the back plate portion 31. The housing 11 is made of a steel material or the like and is formed to have a substantially square bracket-shape in planer view. The side wall portions 12, 13 are connected to each other with the connecting members 32, 33, each of which has a horizontally long thin plate-like shape, being long in a direction of the rotational axis of the take-up drum unit 6. An opening portion is formed in the center of the back plate portion 31, and helps reduce weight and regulates the accommodation amount of the webbing 3.

The side wall portion 12 has a through hole 36 into which a ratchet gear 35 of the take-up drum unit 6 is inserted with a predetermined clearance (for instance, a clearance of approximately 0.5 mm). The inner peripheral portion of the through hole 36 is recessed axially inward in a predetermined depth toward the take-up drum unit 6, opposing to the ratchet gear 35 of the take-up drum unit 6.

From an obliquely lower edge portion of the through hole 36 (at a portion obliquely lower left in FIG. 4), a notch portion 38 is notched outwardly regarding a rotation direction of the pawl 23 (in a direction away from the ratchet gear 35 of the pawl 23). The notch portion 38 is positioned opposite to a portion 37 of a tip side (the other end portion) of the pawl 23 including engagement teeth 23A, 23B, and is notched deep enough to receive a portion 37 of the tip side. A through hole 41 is formed at a position lateral to the notch portion 38, at the side of the back plate portion 31. The through hole 41 is configured to mount the pawl 23 in a rotatable manner. At a portion on the through hole 41 side on which the pawl 23 abuts, the notch portion 38 further has a guiding portion 38A shaped in a coaxial arc with the through hole 41.

Meanwhile, the pawl 23 is made of a steel material or the like and has a stepped portion 37A at a portion to abut on and move along the guiding portion 38A. The stepped portion 37A is formed at approximately the same height as the thickness of the side wall portion 12, recessed in an arc-like shape at the same radius curvature as the guiding portion 38A. The pawl 23 further has a guiding pin 42 at a tip portion on an axially outer side face (frontward in FIG. 4). The guiding pin 42 is inserted into a guiding hole 116 (refer to FIGS. 5 and 10) of a clutch 85 that forms the locking unit 9.

Further, at an base end portion (one end portion) of the pawl 23, there is formed a through hole 43 into which the pawl rivet 25 is inserted. The through hole 43 has, along the periphery thereof, a boss portion 45 to be rotatably inserted in the through hole 41 of the side wall portion 12, shaped cylindrically and at a height approximately the same as the thickness of the side wall portion 12. Further, in a state where the boss portion 45 is inserted in the through hole 41 of the side wall portion 12 from the inner side of the housing 11, the pawl rivet 25 is inserted into the through hole 43 from the outer side of the side wall portion 12 to rotatably fix the pawl 23. Accordingly, the engagement teeth 23A, 23B of the pawl 23 and ratchet gear portions 35A provided on the outer periphery of the ratchet gear 35 are arranged substantially on the same plane as the outer side surface of the side wall portion 12.

The head of the pawl rivet 25 is formed into a disk-like shape having a larger diameter than the through hole 41 and at a predetermined thickness (for instance, approximately 1.5 mm thick). Then, the twisted coil spring 26 that operates as an example of a return spring is arranged in a single wind to surround the periphery of the head of the pawl rivet 25, and one end side 26A thereof is attached to the guiding pin 42 of the pawl 23. Further, the wire diameter of the twisted coil spring 26 is approximately half the height of the head of the pawl rivet 25 (for instance, approximately 0.6 mm wire diameter). Accordingly, the spring height of the single wind of the twisted coil spring 26 is set to have approximately the same height of the head of the pawl rivet 25.

Further, the other end side 26B of the twisted coil spring 26 is passed at the side wall portion 12 side of the one end side 26A in such a way as to be able to slide on the side wall portion 12, then bent approximately at an right angle inward the side wall portion 12 (backside of the side wall portion 12 in FIG. 4), and inserted into a mounting hole 46 formed at the side wall portion 12. The end portion of the other end side 26B is bent into a U-shape side and abuts on the inner surface of the side wall portion 12, to form a slip-prevention portion. As a result, the pawl 23 is urged to rotate in a direction deeper into the notch portion 38 (counterclockwise in FIG. 3) by the twisted coil spring 26, and the tip portion 37 including the engagement teeth 23A, 23B is made to abut on the innermost side of the notch portion 38. Thus, the pawl 23 is urged to rotate by the twisted coil spring 26 in a direction moving away from the ratchet gear 35.

Further, as illustrated in FIG. 2 through FIG. 4, below the through hole 36 of the side wall portion 12 (downward in FIG. 4), there is formed an opening portion 47 which is substantially square-shaped. The opening portion 47 is opened from a portion below the center axis of the through hole 36 (downward in FIG. 4) toward the back plate portion 31. The sensor cover 27 is fitted into the opening portion 47. The sensor cover 27 is shaped in a shallow box body which is substantially the same square shape as the opening portion 47, and fitted from the outside (front side in FIG. 4). There, the sensor cover 27 made of resin is made to abut on the outer periphery portion of the opening portion 47 (periphery on the front side in FIG. 4) at a brim portion formed at the periphery on the opening thereof. At the same time, as a pair of fixing claws 27A projected at both end faces in the vertical direction in FIG. 4 of the sensor cover 27 (one of the fixing claws 27A on the upper end face is illustrated in FIG. 4) is inserted inward at the both sides in the vertical direction of the opening portion 47 in FIG. 4 and elastically locked.

Further, the acceleration sensor 28 includes a sensor holder 51, an inertia mass 52 and a sensor lever 53. The sensor holder 51 is made of resin, formed in an approximately box-like shape, opened on the vertically upper side (upper side in FIG. 4) and has a bowl-shaped mounting portion on a bottom face. The inertia mass 52 is made of metal such as steel formed into a spherical body and movably placed on the mounting portion. The sensor lever 53 is made of resin, placed on the vertically upper side of the inertia mass 52. The sensor holder 51 supports the sensor lever 53 at an end portion opposite to the pawl 23 (right end portion in FIG. 4), in a manner allowing vertical movement (in up/down direction in FIG. 4).

The sensor holder 51 has a pair of engagement claws 51A at both side face portions opposed to both side wall portions inside the sensor cover 27 (one of the engagement claws 51A is illustrated in FIG. 4). The acceleration sensor 28 is fitted into the sensor cover 27 so that the pair of engagement claws 51A is fitted into and locked at fixing holes 27B of the sensor cover 27. As a result, the acceleration sensor 28 is mounted onto the housing 11 through the sensor cover 27.

Further, the side wall portion 12 has mounting holes 55 into which the nylon latches 9A of the locking unit 9 are fitted, at three locations including both corners of the upper end portion (the upper end portion in FIG. 4) and the portion below the through hole 36 (the lower portion in FIG. 4). Further, engagement pieces 56 are formed at center portions (the center portions in vertical direction in FIG. 4) of right and left edge portions of the side wall portion 12, respectively. The engagement pieces 56 protrude orthogonal to the rotation axis of the take-up drum unit 6. The engagement pieces 56 are elastically engaged with locking hooks 9B of the locking unit 9, respectively.

Further, at a center in the side wall portion 13 is formed a through hole 57 into which the take-up drum unit 6 is inserted. Further, the side wall portion 13 has screw holes 58 into which the screws 15 are screwed and fixed, at three locations including the approximate center of the lower end portion (lower end portion in FIG. 2), the corner on a connecting member 33 side and the corner of the upper end portion (upper end portion in FIG. 2) and closer to the back plate portion 31. The screw holes 58 are formed by burring processing toward the pretensioner unit 7 side. The side wall portion 13 has a through hole 59 at the corner closer to a connecting member 32 of the upper end portion (upper end portion in FIG. 2). The stopper pin 16 is inserted through the through hole 59.

The bracket 21 is made of steel material or the like, and configured to be attached onto the upper end portion of the back plate portion 31 (the upper end portion in FIG. 2) by the rivets 61. The bracket 21 has a horizontally-long through hole 62, long in a width direction of the back plate portion 31, from which the webbing 3 is drawn out. The through hole 62 is formed in an extension portion extending approximately at a right angle from the upper end portion of the back plate portion 31 toward the connecting member 32. The horizontally long frame-like protector 22 made of synthetic resin such as nylon is fitted inside the through hole 62. A bolt insertion hole 63 is formed at the lower end portion of the back plate portion 31 (the lower end portion in FIG. 2). A bolt is inserted through the bolt insertion hole 63 when mounted onto a fastening piece of a vehicle (not shown).

### [Schematic Configuration of Take-up Spring Unit]

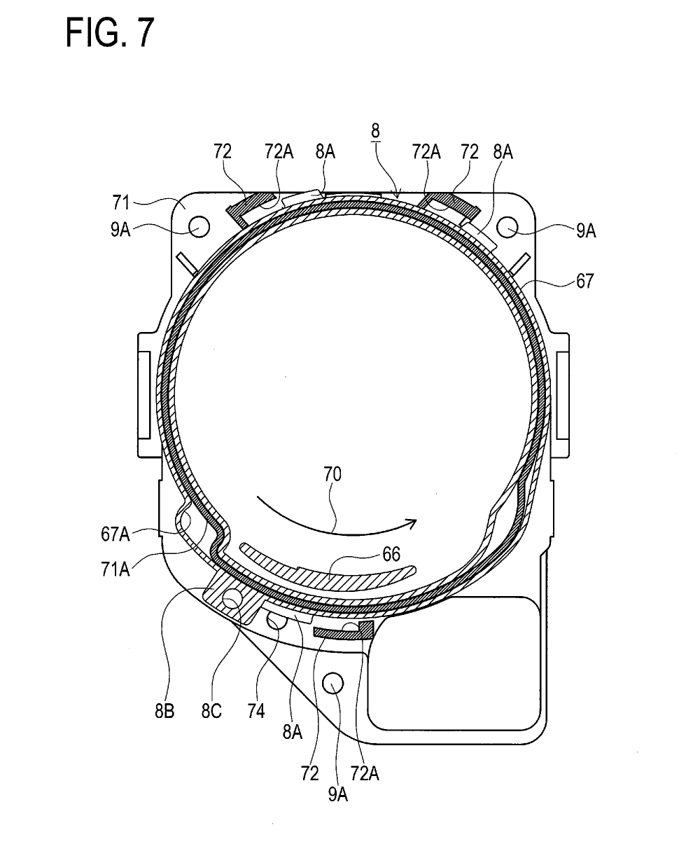

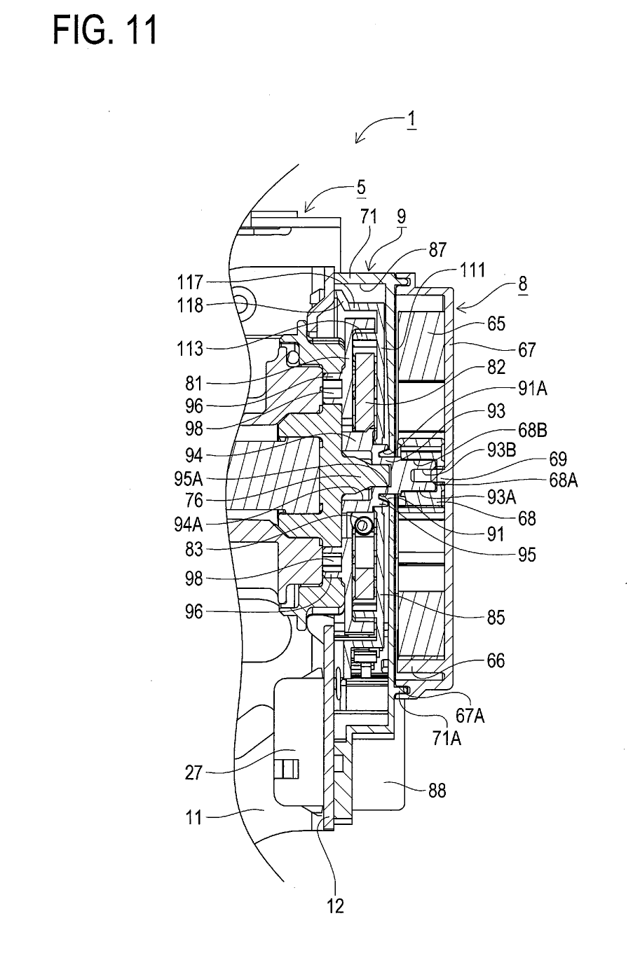

Next, a schematic configuration of the take-up spring unit 8 will be described based on FIG. 2, FIG. 3, FIG. 5 through FIG. 8, and FIG. 11. FIG. 5 and FIG. 6 each are an exploded perspective view of the locking unit 9 and the take-up spring unit 8 including the ratchet gear. FIG. 7 and FIG. 8 are a sectional view for describing a mounting operation of the spring case 67. FIG. 11 is an enlarged sectional view of a principal portion of the seatbelt retractor 1 including the take-up spring unit 8 and the locking unit 9.

As shown in FIG. 2, FIG. 3, FIG. 5, FIG. 6 and FIG. 11, the take-up spring unit 8 has a spiral spring 65, the spring case 67 and a spring shaft 68. The spring case 67 fixes an outer end 65A of the spiral spring 65 at a rib 66 projected from the bottom face of the inner peripheral portion thereof, and accommodates this spiral spring 65. In the spring shaft 68, the inner end 65B of the spiral spring 65 is fitted so that the spring shaft 68 is urged by the spring force. The spring case 67 has a groove portion 67A of a predetermined depth (for instance, approximately 2.5 mm deep) on a substantially entire periphery at the end portion on the mechanism cover 71 side constituting the locking unit 9.

Further, the tabular engagement pieces 8A substantially rectangular shaped in front view are projected at the end portion of the mechanism cover 71 side of the spring case 67, from three locations of the outer circumference portion. The engagement pieces 8A are projected coaxially with regard to an axial center 73A of a through hole 73 formed in the substantially center portion of the mechanism cover 71. Further, outer circumferential surfaces radially outward with regard to the axial center 73A of the through hole 73 of the engagement pieces 8A are formed so as to be positioned on concentric circles.

As shown in FIG. 6 and FIG. 7, a fixation portion 8B is connected to the engagement piece 8A positioned in the lower end portion of the spring case 67. The fixation portion 8B has a square cross section, and is formed continuously to an end portion on the counterclockwise direction side with regard to the axial center 73A of the through hole 73. The fixation portion 8B has: a through hole 8C parallel to the axial center 73A of the through hole 73 at the substantial center of the fixation portion 8B; and a fixation pin 8D integrally formed so as to close an end portion of the through hole 8C on the outside in the axial center 73A direction.

Further, the shaft diameter of the fixation pin 8D is substantially the same as the inner diameter of the through hole 8C. Through pushing the fixation pin 8D toward the mechanism cover 71 side at a predetermined load or higher, the fixation pin 8D can be inserted inside the through hole 8C. The length of the fixation pin 8D is designed to be larger than the thickness of the fixation portion 8B.

The mechanism cover 71 has thick plate-like holding portions 72 projecting toward the take-up spring unit 8 side from three locations of the outer circumference portion facing the engagement pieces 8A, respectively. Each of the holding portions 72 is substantially rectangular shaped in cross section. As illustrated in FIGS. 5 and 7, an engagement groove portion 72A is formed at a base end portion of each of the holding portions 72. The engagement groove portion 72A is cut-off in a counterclockwise direction with regard to the axial center 73A of the through hole 73, and closed at an innermost side end portion.

Further, in each engagement groove portion 72A, a bottom face portion on the outside radially with regard to the axial center 73A of the through hole 73 is formed so as to be disposed on concentric circles with a radius slightly larger (for instance, a radius larger by approximately 0.2-0.5 mm) than that of each radially outside end portion of the engagement pieces 8A of the spring case 67. The width dimension of the axial center 73A direction of each engagement groove portion 72A is designed to be substantially the same as the thickness dimension of each engagement piece 8A. As later described, the engagement pieces 8A are configured to be inserted inside the engagement groove portions 72A, respectively (refer to FIG. 8).

The mechanism cover 71 further has a substantially ring-like rib portion 71A, projecting along a peripheral portion outside with regard to a rotational axis direction of the take-up drum unit 6, at a predetermined height (for instance, a height of approximately 2 mm). The rib portion 71A is disposed at a position corresponding to the groove portion 67A. The inner diameter and outer diameter of the rib portion 71A are set so that, when the rib portion 71A is inserted in the groove portion 67A, a predetermined clearance (for instance, a clearance of approximately 0.1-0.3 mm) is formed, to each of the inner diameter and outer diameter of the groove portion 67A.

As illustrated in FIG. 5 through FIG. 7, a fixation hole 74 is formed at a position to face the fixation pin 8D when the spring case 67 is mounted onto the mechanism cover 71, to be later described. The fixation hole 74 is circular in cross section and located in vicinity of the holding portion 72 facing the lower end portion of the rib portion 71A, on a clockwise direction side with regard to the axial center 73A.

The inner diameter of the fixation hole 74 is formed so as to be smaller by a predetermined dimension (for instance, approximately by 0.1-0.3 mm) than the outer diameter of the fixation pin 8D of the spring case 67, and designed to allow press-fitting of the fixation pin 8D. Further, a cylindrical boss 75 is formed in a periphery of the fixation hole 74, on the inner back side thereof, namely, on the side wall portion 12 side of the housing 11. An inner back end of the cylindrical boss 75 is closed. The inner diameter of the cylindrical boss 75 is formed circular in cross section, with the same diameter as the fixation hole 74, and formed coaxially with regard to the fixation hole 74.

A method for mounting the take-up spring unit 8 onto the mechanism cover 71 will be described here.

As illustrated in FIG. 6, firstly, the outer end 65A of the spiral spring 65 is inserted in the rib 66 erected inside the spring case 67, and the spiral spring 65 is housed inside the spring case 67. Then the mounting groove 68C of the spring shaft 68 is fitted to the inner end 65B of the spiral spring 65.

Thereafter, as illustrated in FIGS. 5 and 6, a pin 69 is erected approximately at the center position of a bottom face portion of the spring case 67. The pin 69 is inserted into a through hole 68A in the bottom face portion of the spring shaft 68, to rotatably support the spring shaft 68 at the bottom face portion side.

Further, as illustrated in FIG. 7, the engagement pieces 8A projecting radially outward from three locations on the outer circumference portion of the spring case 67 are positioned so as to face end portions on the clockwise direction side in front view of the holding portions 72 of the mechanism cover 71, respectively.

Further, as illustrated in FIGS. 5 and 11, a locking gear 81 has a rotational axis portion 93 including a tip portion 93A. The tip portion 93A is configured to protrude from the through hole 73 of the mechanism cover 71 and formed in a rectangular cross-sectional shape. The tip portion 93A has a shaft hole 93B formed along the axial center, and configured to receive the insertion of the pin 69.

Thereafter, as illustrated in FIGS. 6 and 11, the tip portion 93A of the rotational axis portion 93 of the locking gear 81 protrudes from the through hole 73 of the mechanism cover 71, and is fitted inside a cylindrical hole 68B of the spring shaft 68. The cylindrical hole 68B is formed in a rectangular cross-sectional shape. Accordingly, the rotational axis portion 93 of the locking gear 81 is connected relatively non-rotatably with regard to the spring shaft 68. At the same time, as illustrated in FIG. 7, the rib portion 71A erected in the peripheral portion of the mechanism cover 71 is fitted inside the groove portion 67A of the spring case 67.

As illustrated in FIGS. 7 and 8, the spring case 67 is rotated in the webbing pull-out direction, namely, a counterclockwise direction in front view (in the direction of arrow 70 in FIG. 7), the engagement pieces 8A of the spring case 67 are fitted inside the engagement groove portions 72A of the holding portions 72 of the mechanism cover 71, respectively, and abut on the inner back sides of the engagement groove portions 72A, respectively. Accordingly, the spring case 67 is positioned so as not to shift in radial direction or axial direction with regard to the axial center 73A of the through hole 73 of the mechanism cover 71.

Thereafter, the fixation pin 8D of the spring case 67 in this state is pushed and press-fitted inside the through hole 8C of the fixation portion 8B and the fixation hole 74 of the mechanism cover 71, so that the take-up spring unit 8 is fixed in a relatively non-rotatable manner with regard to the mechanism cover 71. Thus, the take-up spring unit 8 is installed, abutting on the outer side in the rotational axis direction of the take-up drum unit 6 of the mechanism cover 71.

As a result, the rib portion 71A erected in the peripheral portion of the mechanism cover 71 is fitted inside the groove portion 67A of the spring case 67, so that fine particles or dust can be prevented from entering inside the spring case 67. As illustrated in FIG. 11, in a state that the bottom face portion side of the mechanism cover 71 at the spring shaft 68 rotatably abuts on the peripheral portion of the pin 69, a predetermined clearance (for instance, a clearance of approximately 0.3 mm) is formed between the end portion of the spring shaft 68 on the locking unit 9 side, and the peripheral portion on the back side of the through hole 73 formed at the substantially center portion of the mechanism cover 71.

At the same time, a predetermined clearance (for instance, a clearance of approximately 0.3 mm) is also formed between the bottom surface of the cylindrical hole 68B of the spring shaft 68 and the tip portion 93A of the rotational axis portion 93 of the locking gear 81. Accordingly, the spring shaft 68 is provided movably in an axial direction of the axial center 73A by the amount of the predetermined clearance between the spring case 67 and the mechanism cover 71.

### [Schematic Configuration of Locking Unit]

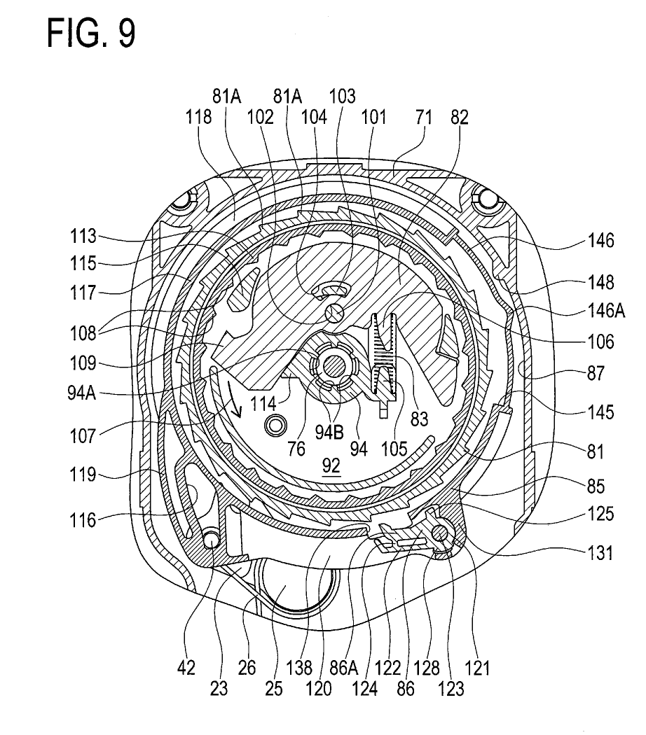

Next will be described a schematic configuration of the locking unit 9 composing the lock mechanism 10 that stops the pull-out of the webbing 3 in response to the abrupt pull-out of the webbing 3 or abrupt change in acceleration of a vehicle, referring to FIG. 5, FIG. 6, FIG. 9 through FIG. 18.

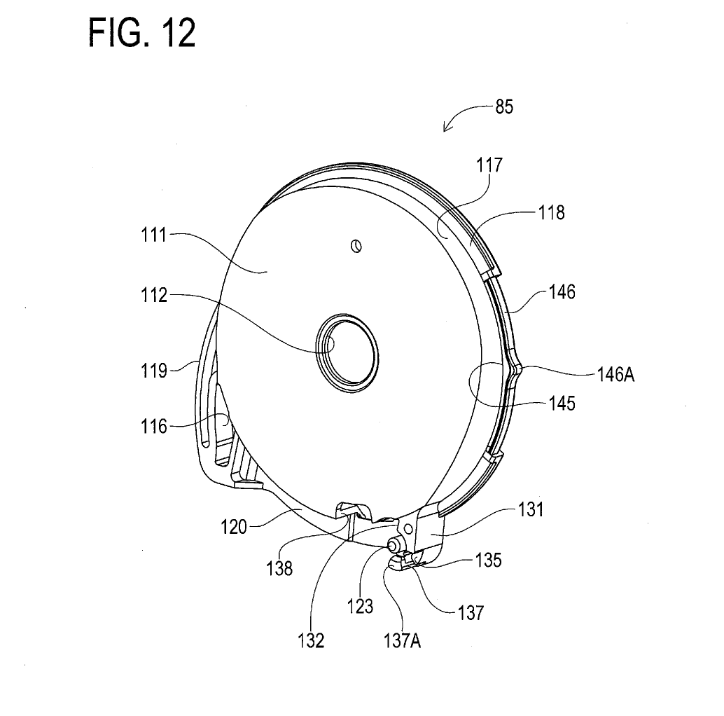

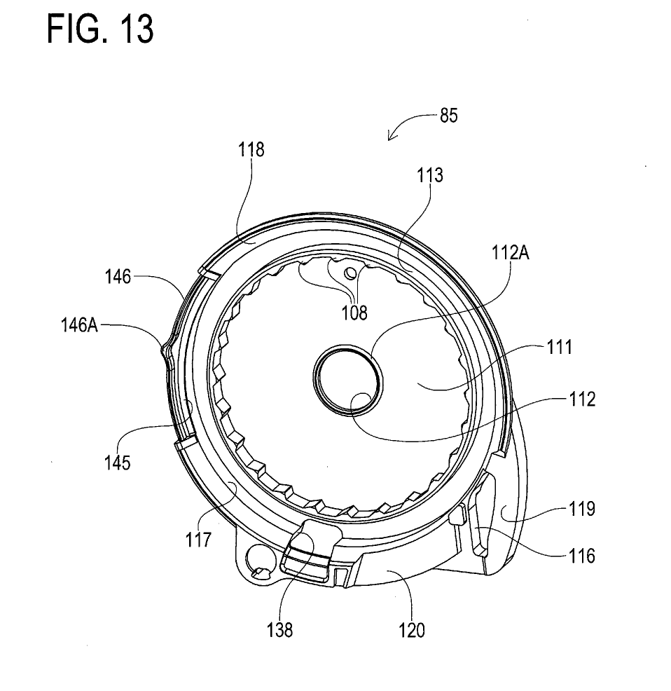

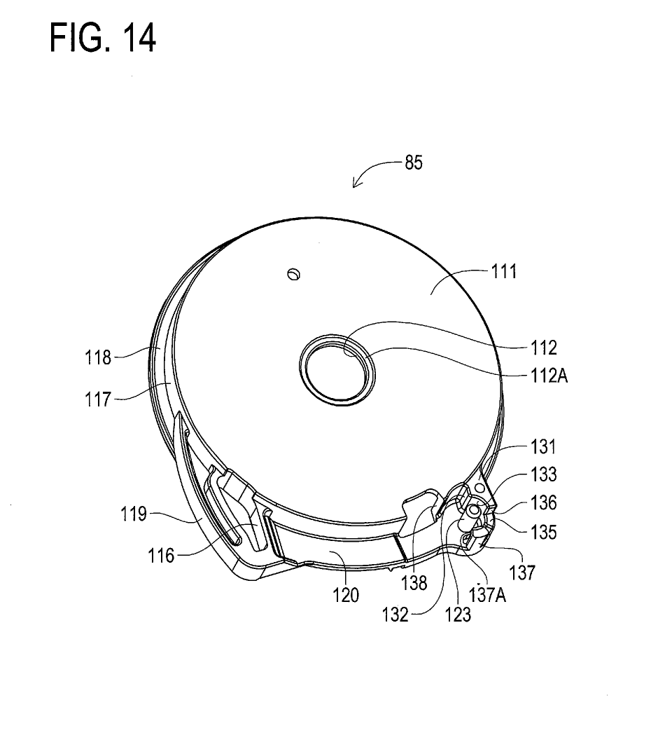

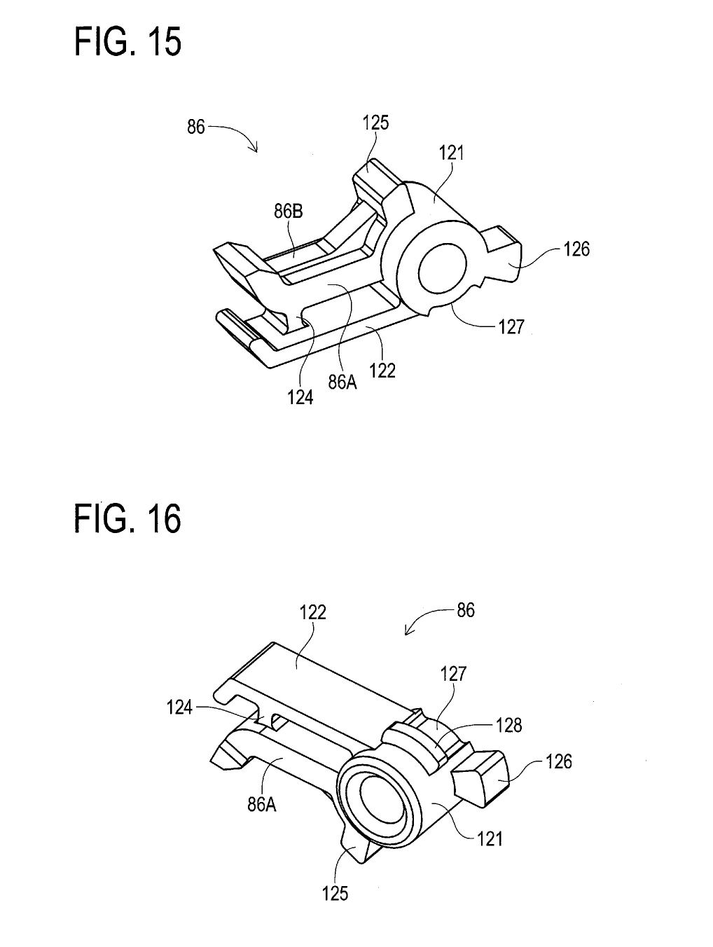

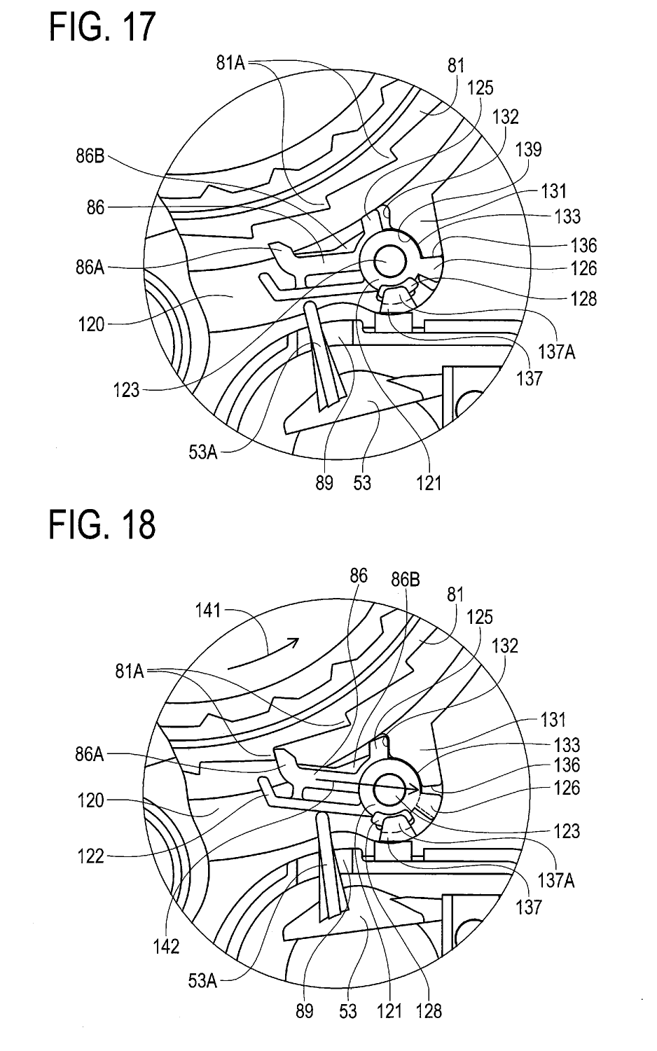

FIG. 9 is a cross sectional view of an assembled state including a locking arm of the locking unit 9. FIG. 10 is a partial cutaway sectional view showing the locking unit 9 with a bottom face portion of the mechanism cover 71 partially cut away. FIG. 12 is a perspective view showing an external appearance of the clutch. FIG. 13 is a perspective view showing an internal appearance of the clutch. FIG. 14 is a perspective view of the clutch seen orthogonally from below. FIGS. 15 and 16 each are a perspective view of a pilot lever. FIG. 17 is an enlarged view of a principal portion of the pilot lever in a normal operation. FIG. 18 is an enlarged view of a principal portion of the pilot lever engaged with the locking gear.

As illustrated in FIG. 5, FIG. 6, FIG. 9 through FIG. 11, the locking unit 9 includes the mechanism cover 71, the locking gear 81, a locking arm 82, a sensor spring 83, a clutch 85 and a pilot lever 86. In the embodiment, the members included in the locking unit 9 are made of synthetic resin except the sensor spring 83. Thus, friction coefficient of contact between the members is quite small.

The mechanism cover 71 has a substantially box-shaped mechanism housing portion 87 having a bottom face portion formed in substantially circular shape and opened on the side facing the side wall portion 12 of the housing 11, to house the locking gear 81, the clutch 85, and the like. Further, the mechanism cover 71 has a sensor housing portion 88. The sensor housing portion 88 is formed in a concave shape being rectangular in cross section, at a corner portion (downward left corner in FIG. 6) facing the acceleration sensor 28 attached to the housing 11 with the sensor cover 27.

The sensor holder 51 of the acceleration sensor 28 is configured to be fitted into the sensor housing portion 88 when the mechanism cover 71 is attached to the side wall portion 12 by the nylon latches 9A and the locking hooks 9B, so that the sensor lever 53 is housed in a vertically movable manner (in up/down direction in FIG. 6). Further, an opening portion 89 is opened to allow communication between the mechanism housing portion 87 and the sensor housing portion 88, on substantially middle of the lower end portion of the mechanism housing portion 87 of the mechanism cover 71 (substantially middle on the lower end portion in FIG. 6).

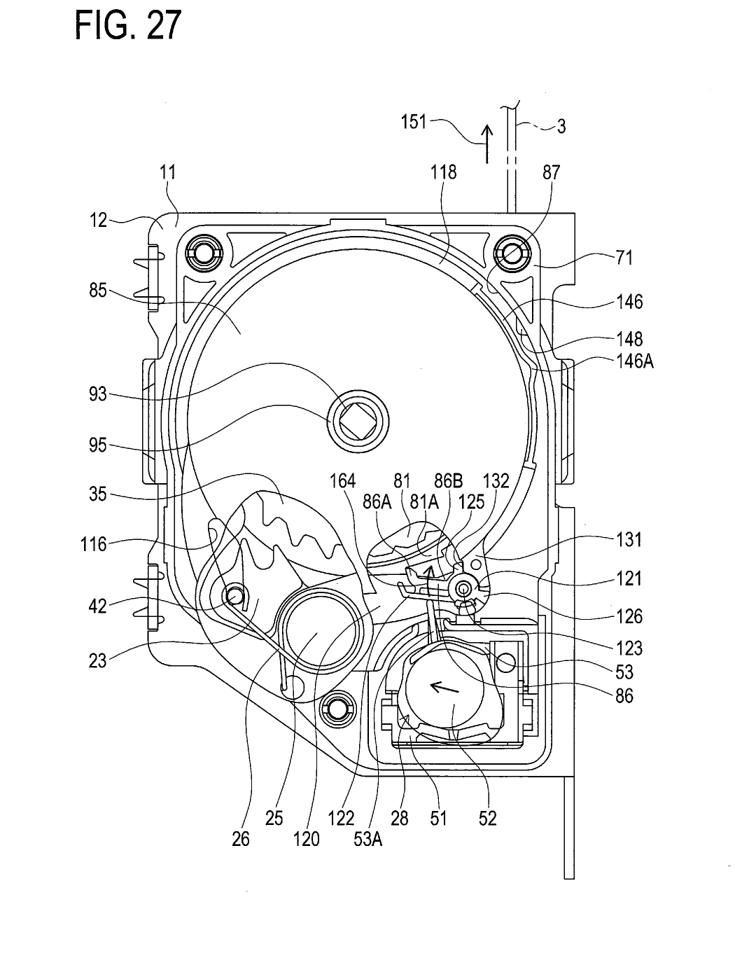

This opening portion 89 is formed to allow vertical movement (in up/down direction in FIG. 6) of the tip portion of a lock claw 53A. The lock claw 53A is projected in upward direction (upward in FIG. 6) from a top end portion of the sensor lever 53 of the acceleration sensor 28. In normal time, the tip portion of the lock claw 53A is positioned in vicinity of a receiving plate portion 122 of the pilot lever 86 (refer to FIG. 10). As later described, when the inertia mass 52 is moved by acceleration exceeding a predetermined value to pivotally move the sensor lever 53 vertically upward, the lock claw 53A abuts on the receiving plate portion 122 of the pilot lever 86 through the opening portion 89 to pivotally move the pilot lever 86 vertically upward (refer to FIG. 27).

The mechanism housing portion 87 has a cylindrical supporting boss 91 projected at a periphery of the through hole 73 formed in the center of the approximately circular-shaped bottom face portion thereof. A chamfered portion 91A is formed on the whole outer periphery of the tip portion of the supporting boss 91 on the locking gear 81 side, tapered toward the top with an inclination of a predetermined angle (for instance, approximately 30 degrees inclination). Further, the locking gear 81 has a disk-like bottom face portion 92 provided with the cylindrical rotational axis portion 93 projected from the back side facing the mechanism cover 71, at the center portion thereof. The cylindrical rotational axis portion 93 is inserted into the supporting boss 91, and held slidably and rotatably.

The locking gear 81 is formed as a circular ring-like projection projecting toward the clutch 85 side on the whole periphery of the disk-like bottom face portion 92 and has locking gear teeth 81A configured to engage with the pilot lever 86 on the outer peripheral portion thereof. A locking gear tooth 81A is formed to engage with an engagement claw portion 86A of the pilot lever 86 only when the locking gear 81 is rotated in the webbing pull-out direction (refer to FIG. 16).

As illustrated in FIG. 5, FIG. 6, FIG. 10 and FIG. 11, the center portion of the bottom face portion 92 of the locking gear 81 has a through hole, which fittingly receives a shaft portion 76 projecting at the center portion of the end face of the ratchet gear 35 on the locking gear 81 side. Further, a cylindrical pedestal portion 94 is formed projecting at the peripheral portion of the through hole on the mechanism cover 71 side, at a height substantially similar to the height in axial direction of the locking gear teeth 81A. Further, the cylindrical rotational axis portion 93 of the locking gear 81 is co-axially extended from the edge portion of the cylindrical pedestal portion 94 on the mechanism cover 71 side, at an outer diameter smaller than the pedestal portion 94 and substantially the same diameter as the inner diameter of the supporting boss 91, toward the mechanism cover 71 side. The end portion on the mechanism cover 71 side of the cylindrical rotational axis portion 93 is closed and the tip portion 93A having a rectangular cross-sectional shape is coaxially extended.

Accordingly, inside the pedestal portion 94 and the rotational axis portion 93, there is formed a shaft hole portion 94A, circular shaped in cross section. The shaft hole portion 94A is opened at the end face of the locking gear 81 on the ratchet gear 35 side, and fittingly receives the shaft portion 76 projecting at the center portion of the end face of the ratchet gear 35 on the mechanism cover 71 side. Further, on the inner periphery of the shaft hole portion 94A, a plurality of ribs 94B are projected along the axial direction at radially the same height, and configured to make contact with the outer periphery of the shaft portion 76 of the ratchet gear 35. Further, of a whole length of the shaft portion 76, an approximately half on the base end portion side is formed in a truncated cone, and the remaining approximately half on the tip portion side is shaped cylindrically, continuing to the truncated cone.

Around the base end portion of the rotational axis portion 93, a circular ring-like rib 95 is co-axially formed, at a height substantially the same as the thickness dimension of a substantially disk-like plate portion 111 of the clutch 85, and an insertion groove 95A is formed thereat. The inner circumferential wall portion of the circular ring-like rib 95 is inclined radially outward at an angle larger than the inclination of the tip portion of the supporting boss 91 (for instance, approximately 45 degrees inclination). Further, the outer diameter of the bottom face portion of the insertion groove formed inside the circular ring-like rib 95 is formed to be substantially the same as the outer diameter of the tip portion of the supporting boss 91.

Still further, the outer diameter of the circular ring-like rib 95 is formed substantially the same as the inner diameter of a through hole 112 formed at the center portion of the plate portion 111 of the clutch 85, and at the same time, smaller than the outer diameter of the pedestal portion 94. Further, a circular ring-like rib 112A is projected for whole periphery of the edge portion of the through hole 112 of the clutch 85 on the locking gear 81 side, at a predetermined height (for instance, approximately 0.5 mm high).

Accordingly, the circular ring-like rib 95 of the locking gear 81 is fittedly inserted into the through hole 112 of the clutch 85 so as to make the circular ring-like rib 112A abut on the outer peripheral side of the base end portion of the rib 95, and then the rotational axis portion 93 is inserted into the supporting boss 91 of the mechanism cover 71. Then the tip portion of the supporting boss 91 is made to abut on the bottom face portion of the insertion groove formed radially inside the circular ring-like rib 95, so that the rotational axis portion 93 projecting from the backside of the locking gear 81 is attached co-axially with regard to the supporting boss 91 for substantially the whole height and is pivotally supported. Further, the circular ring-like rib 95 of the locking gear 81 is inserted into the through hole 112 slidably and rotatably, and the clutch 85 is housed between the locking gear 81 and the mechanism cover 71 in a manner rotatable within a predetermined rotation range.

As illustrated in FIG. 5, FIG. 6 and FIG. 11, the locking gear 81 has four convex portions 96 formed each projecting in a substantially rectangular pipe shape with a circumferentially long cross section, on the end face thereof on the ratchet gear 35 side. The four convex portions 96 are positioned at equal center angles, on a concentric circle a predetermined distance away (for instance, approximately 14 mm away) from a rotational axis 81B, radially outwardly. Incidentally, a radially outward peripheral portion of one convex portion 96 is partially cut off. On a bottom portion of the locking gear 81, a positioning hole 97 having a predetermined inner diameter (for instance, inner diameter of approximately 3.5 mm) is formed at a substantially center position between one pair of convex portions 96 neighboring in circumferential direction.

Further, the ratchet gear 35 has four through holes 98 each having substantially the same shape as a convex portion 96 of the locking gear 81. The four through holes 98 each have a substantially rectangular shape with a circumferentially long cross section, on an end face portion thereof facing the locking gear 81. The four through holes 98 are positioned at equal center angles, radially outwardly a predetermined distance away (for instance, approximately 14 mm away) from a rotational axis 81B, at positions corresponding to the convex portions 96, respectively.

Further, the end face portion facing the locking gear 81 of the ratchet gear 35 has a positioning pin 99 erected at a position between one pair of through holes 98 neighboring in circumferential direction, the position opposite to the positioning hole 97. The positioning pin 99 has substantially the same outer diameter as the inner diameter of the positioning hole 97. Further, the height of the shaft portion 76 erected on the end face outside in the rotational axis of the ratchet gear 35 is designed to be substantially the same as the depth of the shaft hole portion 94A of the locking gear 81. The depth of the shaft hole portion 94A of the locking gear 81 is configured such that the top of the shaft portion 76 is located on the inner side in rotational axis direction than the top of the tip portion 93A of the rotational axis portion 93.

Accordingly, while the shaft portion 76 of the ratchet gear 35 is inserted into the shaft hole portion 94A of the locking gear 81, the positioning pin 99 of the ratchet gear 35 is fitted into the positioning hole 97 of the locking gear 81, and at the same time, each convex portion 96 of the locking gear 81 is fitted into each through hole 98 of the ratchet gear 35. As a result, with the locking gear 81 abutting on the axially outside end face of the ratchet gear 35, the locking gear 81 is co-axially mounted onto the ratchet gear 35 so as to be relatively non-rotatable. The shaft portion 76 of the ratchet gear 35 is positioned within the supporting boss 91 of the mechanism cover 71 and pivotally supported through the rotational axis portion 93 of the locking gear 81.

Further, a rib, which is not shown, is erected projecting radially outward on an outer circumferential surface of each of the convex portions 96 of the locking gear 81, along the rotational axis direction of the ratchet gear 35. Each of the convex portions 96 of the locking gear 81 is press-fitted while squeezing each rib, and fixed in each of the through holes 98 of the ratchet gear 35. Accordingly, the locking gear 81 can be fixed onto the ratchet gear 35 without backlash, and the locking gear 81 is held by the ratchet gear 35 so that the assembly operation can be streamlined.

Further, through the tip portion 93A of the rotational axis portion 93 of the locking gear 81, the ratchet gear 35 of the take-up drum unit 6 is mounted coaxially and relatively non-rotatably with on the spring shaft 68 of the take-up spring unit 8. Accordingly, the take-up drum unit 6 is constantly urged to rotate in the webbing take-up direction, through the take-up spring unit 8.

Each convex portion 96 is formed in a cylindrical shape. However, each convex portion 96 may be formed as a solid projection with substantially rectangular-shaped cross section, long in circumferential direction. The ratchet gear 35 has the four through holes 98 with substantially rectangular-shaped cross section, long in circumferential direction, each at a location corresponding to each convex portion 96. However, the ratchet gear 35 may have four concave portions having the same cross sectional shape as the through holes 98 and recessed inward at a height higher than that of each convex portion 96.

Further, as illustrated in FIG. 5, FIG. 6, FIG. 9 through FIG. 11, a columnar supporting boss 101 is projected on the surface of the bottom face portion 92 of the locking gear 81 on the clutch 85 side. The columnar supporting boss 101 is projected adjacent to the pedestal portion 94, at a height lower than the locking gear teeth 81A. The locking arm 82 made of synthetic resin is formed into approximately an arch shape so as to surround the pedestal portion 94. In the locking arm 82, a through hole 102 is formed in the edge portion at the approximately center portion in longitudinal direction on the pedestal portion 94 side, and the supporting boss 101 is rotatably inserted into the through hole 102 so that the locking arm 82 is rotatably supported.

The bottom face portion 92 of the locking gear 81 has an elastic engagement piece 103 projected at a position in vicinity of the radially outside of the supporting boss 101, on the mechanism cover 71 side. The elastic engagement piece 103 is reverse-L shaped in cross section. This elastic engagement piece 103 is inserted into a window portion 104 formed next to the through hole 102 of the locking arm 82, and engaged elastically and rotatably around the axis of the pedestal portion 94. The window portion 104 is formed in an approximately fan-like shape and has a stepped portion.

Further, as illustrated in FIGS. 9 and 10, in the locking gear 81, a spring supporting pin 105 is projected on the rib portion extended radially outward from the outer periphery of the pedestal portion 94. One end side of the sensor spring 83 is fitted onto the spring supporting pin 105. The spring supporting pin 105 is projected in webbing pull-out direction perpendicular to the axial center of the pedestal portion 94. Further, at the locking arm 82, a spring supporting pin 106 is projected on the side wall facing the spring supporting pin 105, and the other end side of the sensor spring 83 is fitted into the spring supporting pin 106.

Accordingly, as illustrated in FIGS. 9 and 10, by putting both ends of sensor spring 83 onto the spring supporting pins 105, 106, respectively, the locking arm 82 is urged with a predetermined load so as to rotate toward the webbing pull-out direction side (direction of arrow 107 in FIG. 9) centering the axis of the supporting boss 101. Further, the locking arm 82 has an engagement claw 109 configured to engage with a clutch gear 108 of the clutch 85, and at an edge portion on the engagement claw 109 side, abuts on a stopper 114 projecting radially outward from the pedestal portion 94 of the locking gear 81.

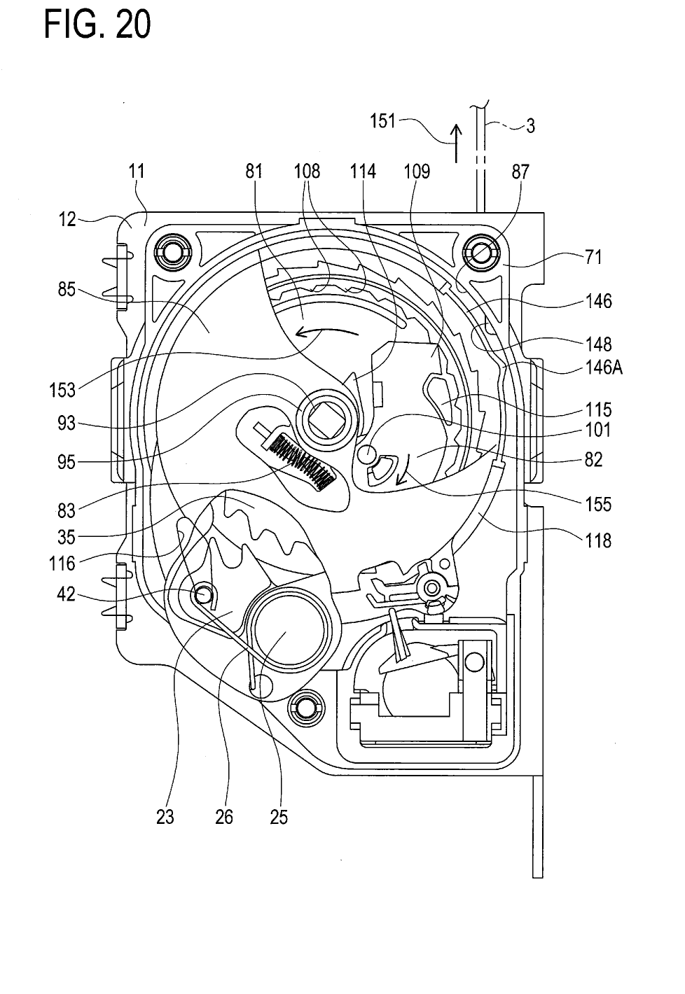

Meanwhile, as later described, when the locking arm 82 is rotated in webbing take-up direction (direction opposite to arrow 107 in FIG. 9) against the urging force of the sensor spring 83 and is engaged with the clutch gear 108, an edge portion opposite to the engagement portion of the engagement claw 109 forms a predetermined clearance (for instance, approximately 0.3 mm clearance) with a rotation restrictor 115 formed at the bottom face portion 92 of the locking gear 81. The rotation restrictor 115 is spindle-shaped in cross section (refer to FIG. 20).

Further, as illustrated in FIG. 5, FIG. 6, FIG. 9 through FIG. 14, the clutch 85 is housed in a manner rotatable within a predetermined rotation range in the mechanism housing portion 87, while being held between the locking gear 81 and the mechanism cover 71. On the locking gear 81 side of the clutch 85, there is provided a circular ring-like rib portion 113. The circular ring-like rib portion 113 is co-axially formed with regard to the through hole 112, and has a slightly smaller outer diameter than the inner periphery of the circular ring-like projection of the locking gear 81 having the locking gear teeth 81A on the outer periphery portion thereof.

The rib portion 113 has the clutch gear 108 configured to engage with the engagement claw 109 of the locking arm 82, on the inner periphery thereof (refer to FIG. 20). The clutch gear 108 is to engage with the engagement claw 109 of the locking arm 82 only when the locking gear 81 is rotated in the webbing pull-out direction around the axis of the through hole 112 (refer to FIG. 20).

Further, a circular ring-like outer rib portion 117 is formed at the outer peripheral portion of the substantially disk-like plate portion 111 of the clutch 85, so as to surround the rib portion 113. Further, on the whole periphery of the edge portion of the outer rib portion 117 on the ratchet gear 35 side, a flange portion 118 is formed, extending radially outward with respect to the central axis of the through hole 112, being slightly slanted toward the ratchet gear 35 side.

The outer rib portion 117 has a guiding block portion 119 extended on a portion opposing the pawl 23 (lower left corner portion in FIG. 9). The guiding block portion 119 is extended from the outer periphery of the outer rib portion 117 downward in vertical direction (downward in FIG. 5). The guiding block portion 119 has a long guiding hole 116 into which the guiding pin 42 formed on the side face of the tip portion including engagement teeth 23A, 23B of the pawl 23 is movably engaged from the ratchet gear 35 side.

The guiding hole 116 is, as illustrated in FIG. 10, formed at a corner portion opposed to the pawl 23 of the outer rib portion 117 into a long groove-like shape substantially parallel to the webbing pull-out direction (vertical direction in FIG. 10). Accordingly, when the clutch 85 is rotated in the webbing pull-out direction (direction of arrow 107 in FIG. 9) as later described, the guiding pin 42 is moved along the guiding hole 116, and the engagement teeth 23A, 23B of the pawl 23 are rotated so as to come closer to the ratchet gear portion 35A of the ratchet gear 35 (refer to FIGS. 20 through 22).

Further, the pawl 23 is rotatably urged in a direction away from the ratchet gear 35 by the twisted coil spring 26, and the guiding pin 42 of the pawl 23 movably engaged at the guiding hole 116 urges the clutch 85. The clutch 85 is urged by this urging force so as to achieve a rotated state where the guiding pin 42 of the pawl 23 makes contact with the edge portion of the guiding hole 116 (lower edge portion of the guiding hole 116 in FIG. 9) located farthest away from the ratchet gear 35 in radial direction of the rotation of the clutch 85, so that the clutch 85 is rotatably urged in the direction opposite to the webbing pull-out direction. Thus, a clutch urging mechanism 129 is configured by the pawl 23 and the twisted coil spring 26.

At the same time, as the guiding pin 42 of the pawl 23 is made to have contact with the edge portion of the guiding hole 116 (lower edge portion of the guiding hole 116 in FIG. 9) located farthest away from the ratchet gear 35 in the radial direction of the rotation of the clutch 85 to regulate the rotation of the pawl 23 in normal occasion, the pawl 23 is held to be positioned in vicinity of the rear side of the notch portion 38 formed at the side wall portion 12.

Further, an extending portion 120 is extended in a plate-like shape, radially outward in approximately arc-like shape from the flange portion 118, on the lower edge portion of the outer rib portion 117 of the clutch 85 (lower edge portion in FIG. 6). The extending portion 120 extends from the end face portion of the guiding block portion 119 on the ratchet gear 35 side, to the portion facing the upper portion of the sensor housing portion 88 (upper direction in FIG. 6). Further, as illustrated in FIG. 9, FIG. 10, FIG. 12 through FIG. 14, in vicinity of the edge portion opposite to the guiding block portion 119, the extending portion 120 has a mounting boss 123 on the mechanism cover 71 side at substantially the same height as the outer rib portion 117. The mounting boss 123 is thin columnar shaped and to be inserted into a cylindrical sleeve portion 121 of the pilot lever 86 (refer to FIG. 15).

Here, as illustrated in FIG. 9, FIG. 10, FIG. 15 and FIG. 16, the pilot lever 86 includes the cylindrical sleeve portion 121, the plate-like engagement claw portion 86A, the thin-plate-like receiving plate portion 122, and a thin-plate-like connecting plate portion 124. The length of the sleeve portion 121 in axial direction is set substantially the same as the height of the mounting boss 123 erected at the extending portion 120. Further, the plate-like engagement claw portion 86A is formed approximately L shaped when viewed in the rotation axis direction, with the tip portion thereof obliquely bent toward the locking gear 81 side. Further, the plate-like engagement claw portion 86A is projected from the outer periphery of the sleeve portion 121 to the guiding hole 116 side, in a predetermined length and at a width shorter than the length of the sleeve portion 121. The plate-like engagement claw portion 86A is projected so as to be substantially horizontal when the pilot lever 86 is rotated by its own weight to regulate downward rotation in vertical direction.

Further, the thin-plate-like receiving plate portion 122 is projected from the outer periphery of the sleeve portion 121 to the guiding hole 116 side in tangential direction so as to oppose to the engagement claw portion 86A, and the tip portion is obliquely bent so as to be substantially parallel with the tip side of the engagement claw portion 86A. The thin-plate-like connecting plate portion 124 is formed to connect the tip portions of the engagement claw portion 86A and the receiving plate portion 122. In vicinity of the base end portion of the engagement claw portion 86A, an upward rotation restrictor portion 125 is projected radially outward from the outer periphery of the sleeve portion 121. The upward rotation restrictor portion 125 regulates the rotation of the pilot lever 86 in a direction of the locking gear 81 side, namely, the rotation upward in vertical direction. Further, the upward rotation restrictor portion 125 is projected at substantially the same width dimension of the width of engagement claw portion 86A and at a predetermined height (for instance, approximately 1.5 mm high) so as to form a right angle with the base end portion of the engagement claw portion 86A.

The engagement claw portion 86A further has a rib portion 86B on an end face portion facing the locking gear 81 (on an upper end face portion in FIG. 15). The rib portion 86B is formed at approximately the center portion in width direction, along a longitudinal direction from the portion at which the tip portion is obliquely bent toward the locking gear 81 side to the base end portion of the engagement claw portion 86A. The width of the rib portion 86B is half the width of the engagement claw portion 86A. The rib portion 86B is formed at a low, constant height (for instance, a constant height of approximately 1 mm) from the portion where the tip portion is obliquely bent toward the locking gear 81 side, to the approximately center portion in the longitudinal direction, and then erected in an approximately triangular shape when viewed in a rotational axis direction, continuously from the approximately center portion in the longitudinal direction, to the base end portion of the upward rotation restrictor portion 125.

Thus, by the rib portion 86B, the bending strength from the portion obliquely bent toward the locking gear 81 side to approximately the center portion in the longitudinal direction is configured to be greater than the bending strength at the tip portion, with regard to the bending strength in the direction of the locking gear 81 side in the engagement claw portion 86A. Further, by the rib portion 86B, the bending strength from the approximately center portion in the longitudinal direction to the base end portion on the sleeve portion 121 side of the engagement claw portion 86A is configured to be greater than the bending strength from the portion obliquely bent toward the locking gear 81 side to the approximately center portion in the longitudinal direction, with regard to the bending strength in the direction of the locking gear 81 side in the engagement claw portion 86A.

The sleeve portion 121 has a downward rotation restrictor portion 126 on a side opposite to the receiving plate portion 122 in a direction of the tangent line. The downward rotation restrictor portion 126 projects radially outward from an outer circumferential surface of the sleeve portion 121, and restricts the rotation of the pilot lever 86 in a direction of the sensor lever 53 side, in other words, the rotation in vertically downward direction. The downward rotation restrictor portion 126 projects, from the end portion opposite to the ratchet gear 35 of the sleeve portion 121, at a width dimension in the rotational axis direction narrower than the width of receiving plate portion 122 in the rotational axis direction and at a predetermined height (for instance, approximately 1.5 mm high) so as to face the base end portion of the receiving plate portion 122.

The sleeve portion 121 further has a concave portion 127 on the outer circumferential surface from the base end portion of the receiving plate portion 122 to the base end portion of the downward rotation restrictor portion 126. The concave portion 127 is formed as a substantially fan-like shape in cross section, recessed to the approximately center portion in axial direction to have a predetermined depth (for instance, approximately 0.5 mm deep) in radial direction. This concave portion 127 has a plate-like convex portion 128 on an end portion thereof on the center portion side in axial direction. The convex portion 128 is formed all across the entire width in circumferential direction of the concave portion 127, projecting radially outward in a concentric circular-arc shape at a predetermined height (for instance, approximately 1.5 mm high).

As illustrated in FIG. 9, FIG. 10, FIG. 12 through FIG. 14, at the edge portion of the extending portion 120 facing to the mounting boss 123, a pilot lever supporting block 131 is projected toward the mechanism cover 71 side at a substantially the same height with the outer rib portion 117. As illustrated in FIG. 14, on the inner surface of the pilot lever supporting block 131 facing the mounting boss 123, an upward rotation restricting end face portion 132 is extended vertically downward from an outer circumferential surface of the outer rib portion 117. The upward rotation restricting end face portion 132 is configured to make contact with the upward rotation restrictor portion 125 when the pilot lever 86 is rotated toward the locking gear 81 side, as later described.

As illustrated in FIG. 14, a load receiving surface 133 is formed on the inner surface of the pilot lever supporting block 131 facing the mounting boss 123, extending further from the upward rotation restricting end face portion 132 to an end portion on the vertical downward side of the extending portion 120, formed co-axially with the mounting boss 123 into an approximately semicircular smooth curved face in front view at a radius curvature slightly larger (for instance, approximately 0.1 mm larger) than the radius of the outer periphery of the sleeve portion 121 of the pilot lever 86.

As illustrated in FIG. 12 and FIG. 14, the end portion on the vertically downward side of the pilot lever supporting block 131 has a stepped portion 135 formed by cutting-off at a predetermined height toward the extending portion 120 side thereon, and a downward rotation restricting end face portion 136 configured to abut on the downward rotation restrictor portion 126 when the pilot lever 86 rotates by its own weight, as later described. Further, the height of the stepped portion 135 from the extending portion 120 is designed to be lower than the downward rotation restrictor portion 126.

Further, an elastic engagement piece 137 is erected on an end portion of the extending portion 120 facing the mounting boss 123 from vertically downward thereof. The elastic engagement piece 137 is inverted L shaped in cross section, formed elastically deformably in radially outward direction with regard to the mounting boss 123, and has a fixing projection 137A on a tip portion thereof. The elastic engagement piece 137 is formed so as to be positioned opposite to and with a predetermined clearance (for instance, a clearance of approximately 0.3 mm) with the convex portion 128 projecting on the outer circumferential surface of the sleeve portion 121 of the pilot lever 86. Also, the fixing projection 137A formed on the tip portion is configured to be slightly higher (for instance, approximately 0.2 mm higher) than the convex portion 128.

Further, as illustrated in FIG. 9, FIG. 10, FIG. 12 through FIG. 14, an opening portion 138 penetrating in vertical direction is formed on the outer rib portion 117, at a location that the engagement claw portion 86A of the pilot lever 86 faces. The opening portion 138 is formed by cutting out the outer rib portion 117 at a predetermined dimension and at a predetermined circumferential width, to a portion more inward than the edge portion of the plate portion 111. As later described, the opening portion 138 is formed so as to allow the engagement claw portion 86A to enter the opening portion 138 and engage with a locking gear tooth 81A, when the engagement claw portion 86A is pushed and rotated by the lock claw 53A of the sensor lever 53 (refer to FIG. 18).

Accordingly, as depicted in FIG. 17 and FIG. 18, the engagement claw portion 86A of the pilot lever 86 is set to oppose the opening portion 138. Then, the sleeve portion 121 is fitted onto the mounting boss 123 and pushed father inside until abutting on the extending portion 120, so that the fixing projection 137A of the elastic engagement piece 137 opposes the convex portion 128 with a predetermined clearance (for instance, a clearance of approximately 0.2 mm) therebetween, preventing the pilot lever 86 from coming off from the mounting boss 123.

The fixing projection 137A faces the circumference portion of the concave portion 127 formed on the sleeve portion 121 with a predetermined clearance (for instance, a clearance of approximately 0.2 mm) therebetween, and between the outer circumferential surface of the sleeve portion 121 and the load receiving surface 133 of the pilot lever supporting block 131, a predetermined clearance 139 (for instance, a clearance of approximately 0.1 mm) is formed, so that the pilot lever 86 can smoothly rotate vertically.

Further, as illustrated in FIG. 17, when the pilot lever 86 is rotated by its own weight to the lower side in vertical direction (in lower direction in FIG. 17), a downward rotation restrictor portion 126 makes contact with a downward rotation restricting end face portion 136 of the pilot lever supporting block 131 to regulate the rotation angle to the lower side in a vertical direction (in lower direction in FIG. 17). Further, in a normal state, the receiving plate portion 122 of the pilot lever 86 and the lock claw 53A of the sensor lever 53 have a clearance therebetween.

As illustrated in FIG. 18, when the sensor lever 53 is rotated vertically upward (in upward direction in FIG. 18), and the pilot lever 86 is rotated by the lock claw 53A vertically upward, the engagement claw portion 86A of the pilot lever 86 makes contact with the locking gear 81 and engages with a locking gear tooth 81A. Further, when the locking gear 81 is rotated in the webbing pull-out direction (in a direction of arrow 141) under the state where the engagement claw portion 86A of the pilot lever 86 is engaged with the locking gear tooth 81A (refer to FIG. 27), the engagement claw portion 86A is subject to a load in the mounting boss 123 side direction (in a direction of arrow 142).

Thereby, when the load applied to the engagement claw portion 86A elastically deforms toward the sleeve portion 121 side and further rotates the tip portion of the engagement claw portion 86A formed obliquely bent to the locking gear 81 side, the upward rotation restrictor portion 125 of the pilot lever 86 is made to abut on the upward rotation restricting end face portion 132 of the pilot lever supporting block 131. Further, when the mounting boss 123 is warped by the load applied to the engagement claw portion 86A, the outer periphery of the sleeve portion 121 makes contact with the load receiving surface 133 of the pilot lever supporting block 131.

Thus, the pressure load applied to the engagement claw portion 86A can be supported at the pilot lever supporting block 131 through the upward rotation restrictor portion 125 and the sleeve portion 121. Accordingly, even if the pilot lever 86 and the mounting boss 123 are made smaller, the upward rotation restrictor portion 125, the sleeve portion 121 and the mounting boss 123 that support the pressing load applied to the engagement claw portion 86A can be prevented from deforming or being damaged.

As illustrated in FIG. 6, FIG. 9, FIG. 10, FIG. 12 and FIG. 13, the flange portion 118 of the clutch 85 has a cutout portion 145 on a side substantially opposite to the through hole 112 of the guiding block portion 119. The flange portion 118 is cut out to the outer rib portion 117, at a predetermined center angle (for instance, at a center angle of approximately 60 degrees) with regard to an axial center of the through hole 112, to form the cutout portion 145. An elastic rib 146 is formed between both end portions of the cutout portion 145 in circumferential direction with regard to the axial center of the through hole 112, at a width narrower than the width of the flange portion 118, from one end portion to the other end portion. The elastic rib 146 has a circular-arc rib-like shape concentric with the axial center of the through hole 112.

At the circumferential center portion of this elastic rib 146, a clutch side projecting portion 146A is formed approximately U-shaped in cross section. The clutch side projecting portion 146A is projecting at a predetermined height (for instance, approximately 1.2 mm high) radially further outward than the outer periphery of the flange portion 118. Further, the elastic rib 146 having a rib-like shape is formed elastically deformable such that, the clutch side projecting portion 146A formed in the circumferential center portion is allowed to move radially further inward than the outer periphery of the flange portion 118, when the clutch side projecting portion 146A is pressed radially inward.

As illustrated in FIG. 6, FIG. 9 and FIG. 10, in the mechanism housing portion 87 of the mechanism cover 71, an inner circumferential wall facing the flange portion 118 of the clutch 85 is formed concentrically with regard to the axial center 73A of the through hole 73, arranged to face the flange portion 118 with a predetermined clearance (for instance, a clearance of approximately 1.5 mm) therebetween.

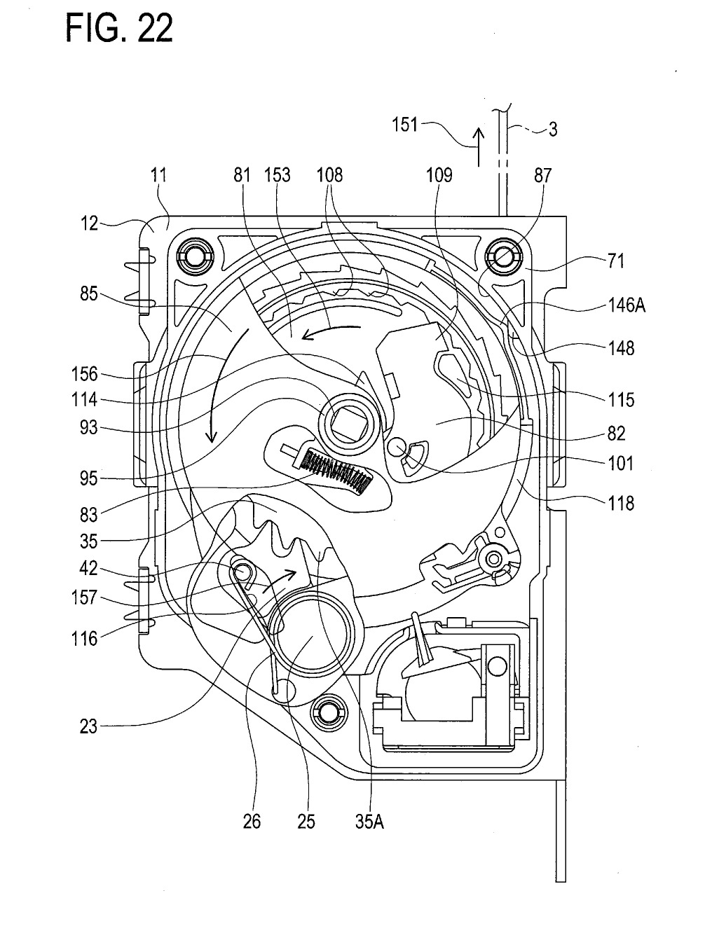

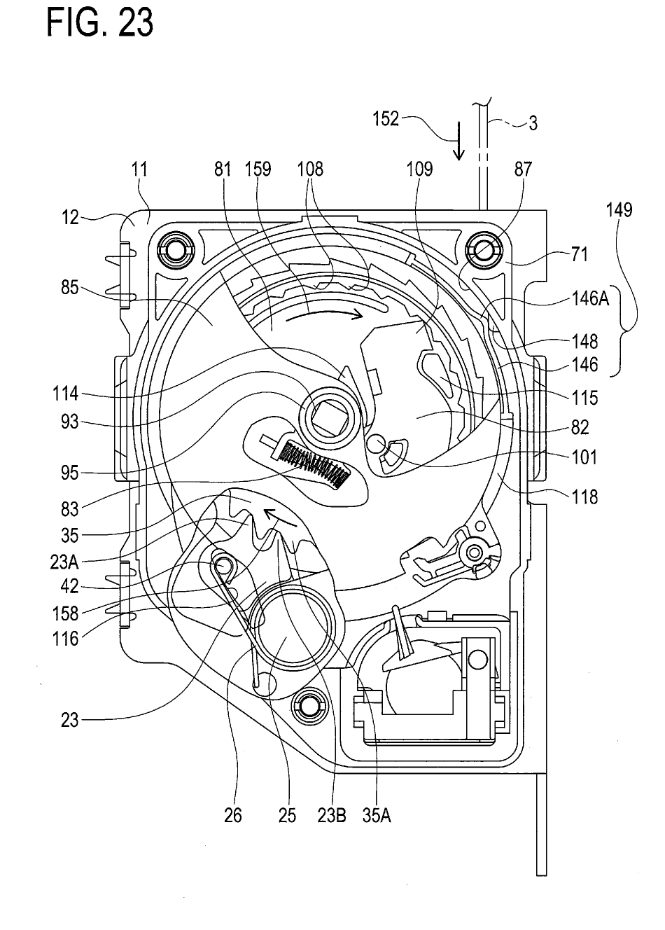

Further, on the inner circumferential wall of the mechanism housing portion 87, a rib-like fixed side projecting portion 148 is erected along the axial center 73A direction (refer to FIG. 22), in a portion opposite to the elastic rib 146 of the clutch 85. The rib-like fixed side projecting portion 148 is formed at a location over which the clutch side projecting portion 146A can ride, when the clutch 85 rotates in the webbing pull-out direction and the pawl 23 engages with the ratchet gear portion 35A of the ratchet gear 35, as later described. The fixed side projecting portion 148 is formed from the inner circumferential wall of the mechanism housing portion 87 to the radially inner side, in a substantially semicircular shape in cross section, projecting at a predetermined height (for instance, approximately 1.2 mm high).

The formation of the cutout portion 145 of the clutch 85 may not be limited to the portion of the flange portion 118 substantially on the opposite side of the through hole 112 of the guiding block portion 119; however, may be at a portion of the flange portion 118 substantially opposite to the through hole 112 of the extending portion 120, or a portion of the flange portion 118 substantially opposite to the through hole 112 of the pilot lever supporting block 131, and the elastic rib 146 is formed thereat.

The fixed side projecting portion 148 formed on the inner circumferential wall of the mechanism housing portion 87 may be formed at a position over which the clutch side projecting portion 146A can pass, at a portion of the inner circumferential wall corresponding to each elastic rib 146 when the pawl 23 engages with the ratchet gear portion 35A of the ratchet gear 35.

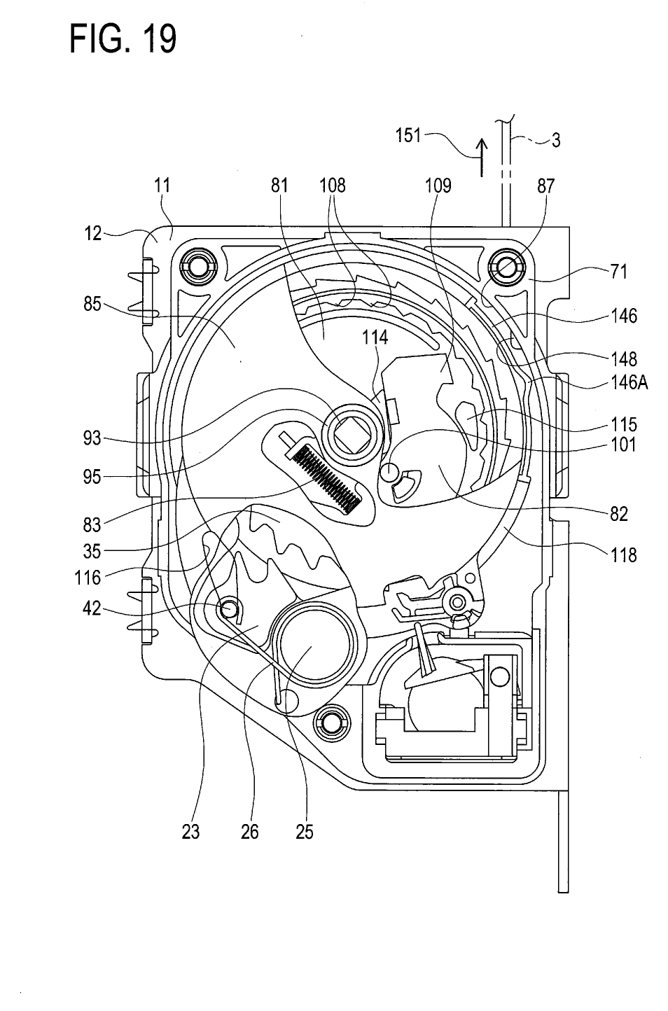

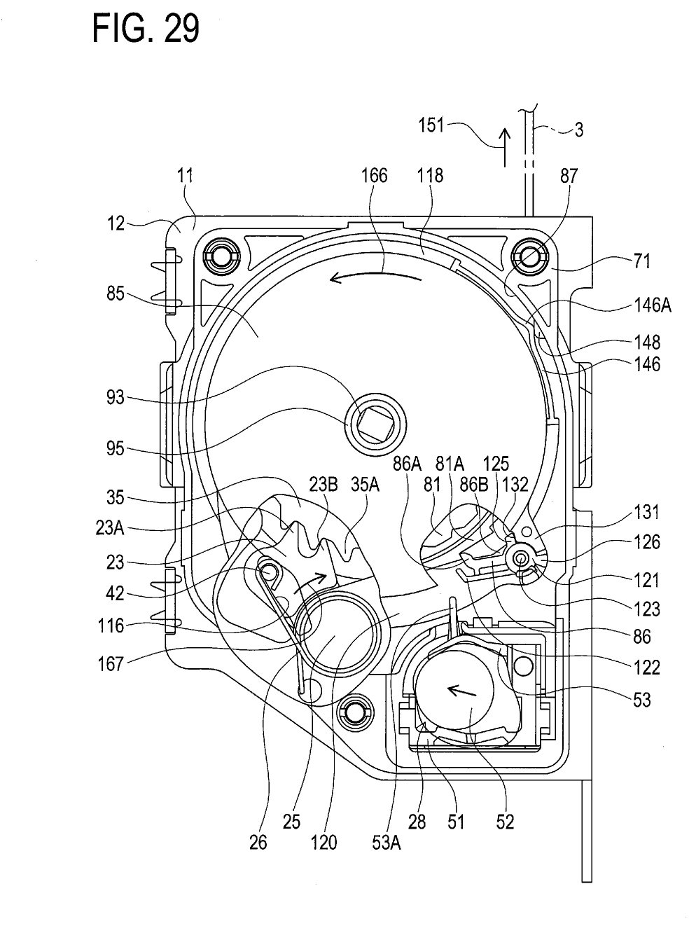

Next, the operation of the lock mechanism 10 will be described referring to FIGS. 19 through 37. In each figure, the pull out direction of the webbing 3 is indicated by arrow 151, and the take-up direction of the webbing 3 is indicated by arrow 152. Further, in each figure, the counterclockwise direction is the direction of the rotation of the take-up drum unit 6 when the webbing 3 is pulled out (webbing pull-out direction). Some parts on the drawings are cut off for the convenience of illustrating the operation of the lock mechanism 10, when necessitated.

Here, the lock mechanism 10 operates two types of lock mechanisms, including a “webbing-sensitive lock mechanism” which is activated in response to sudden pull-out of the webbing 3, and a “vehicle-body-sensitive lock mechanism” which is activated in response to acceleration caused by vehicle rocking or tilting. The “webbing-sensitive lock mechanism” and the “vehicle-body-sensitive lock mechanism” have a common operation with respect to the pawl 23. Accordingly, FIGS. 19 through 37 are depicted in a state with some portion cut off to reveal the relation between the pawl 23 and the ratchet gear 35.

### [Description of Operation in Webbing-sensitive Lock Mechanism]

First, the operation of the “webbing-sensitive lock mechanism” will be described referring to FIGS. 19 through 25. FIGS. 19 through 25 each are a view for illustrating an operation of the “webbing-sensitive lock mechanism.” To illustrate the “webbing-sensitive lock mechanism,” other portions are cut off to reveal the relation between the locking arm 82 and the clutch gear 108, and to reveal the operation of the sensor spring 83, in addition to the portion cut off to reveal the relation between the pawl 23 and the ratchet gear 35.

### [Locking Operation]

First, the locking operation of the “webbing-sensitive lock mechanism” will be described referring to FIGS. 19 through 22. As illustrated in FIGS. 19 and 20, the locking arm 82 is rotatably supported by the supporting boss 101 of the locking gear 81, so that when the acceleration to pull out the webbing 3 exceeds a predetermined acceleration (for instance, approximately 2.0 G, regarding 1G≈9.8 m/s²), an inertial delay is generated in the locking arm 82, to the rotation of the locking gear 81 in the webbing pull-out direction (in a direction of arrow 153).

As a result, the locking arm 82 abutting on the stopper 114 maintains the initial position against the urging force of the sensor spring 83, rotates clockwise (in a direction of arrow 155) centering the supporting boss 101 with regard to the locking gear 81, to the vicinity of the rotation restrictor 115. Accordingly, the engagement claw 109 of the locking arm 82 is rotated radially outward with regard to the rotational axis of the locking gear 81, and engaged with the clutch gear 108 of the clutch 85.

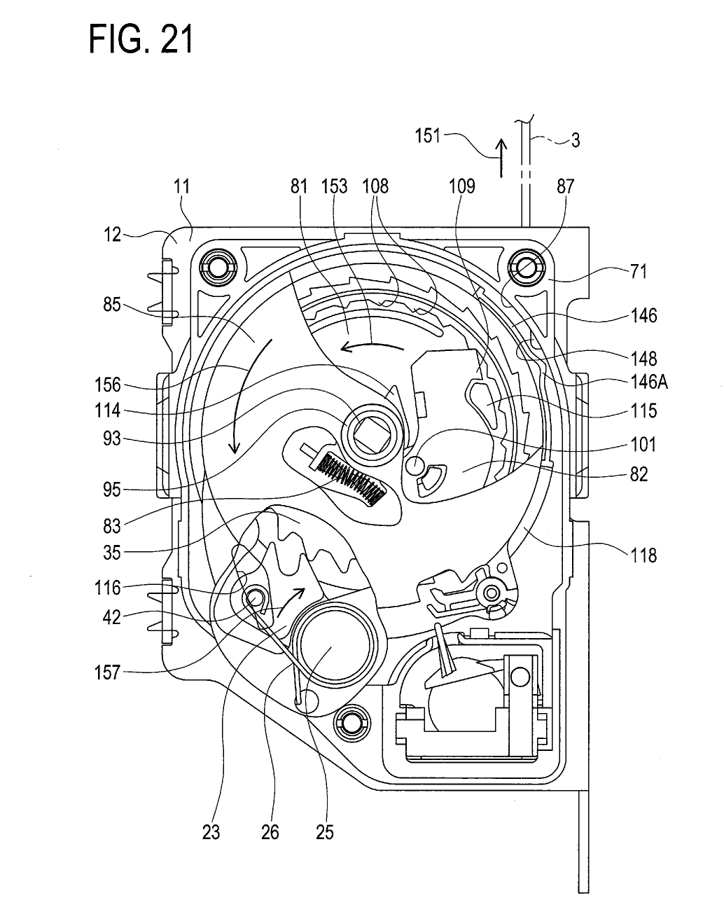

As illustrated in FIGS. 20 and 21, when the pull out of the webbing 3 is continued exceeding the predetermined acceleration, the locking gear 81 further rotates in the webbing pull-out direction (in the direction of arrow 153), so that the engagement claw 109 of the locking arm 82 is rotated in the webbing pull-out direction (in the direction of arrow 153) while being engaged with clutch gear 108.

Accordingly, as the clutch gear 108 is rotated in the webbing pull-out direction (in a direction of arrow 156) by the locking arm 82, the clutch 85 is rotated in the webbing pull-out direction (in the direction of arrow 156) around the axial center of the rib 95 of the locking gear 81, namely, around the axial center of the rotational axis portion 93, against the urging force of the guiding pin 42 of the pawl 23 rotatably urged by the twisted coil spring 26 in the direction away from the ratchet gear 35.

Thus, along the rotation of the clutch 85 in the webbing pull-out direction (in the direction of arrow 156), the guiding pin 42 of the pawl 23 is guided by the guiding hole 116 of the clutch 85, so that the pawl 23 is rotated toward the ratchet gear 35 side (in a direction of arrow 157) against the urging force of the twisted coil spring 26. The clutch side projecting portion 146A of the elastic rib 146 is formed elastically deformable toward the radially inside, on the flange portion 118 on the substantially diametrically opposite side of the guiding hole 116 of the clutch 85. The clutch side projecting portion 146A of the elastic rib 146 is also rotated in a direction of the fixed side projecting portion 148 erected on the inner circumferential wall of the mechanism housing portion 87 of the mechanism cover 71, together with the rotation of the clutch 85.

As illustrated in FIG. 22, if the pull-out of the webbing 3 exceeding the predetermined acceleration is herewith further continued, the clutch 85 is further rotated in the webbing pull-out direction (in the direction of arrow 156) against the urging force of the guiding pin 42 of the pawl 23 rotatably urged by the twisted coil spring 26 in the direction away from the ratchet gear 35. Accordingly, the guiding pin 42 of the pawl 23 is further guided by the guiding hole 116 of the clutch 85, and the pawl 23 is engaged with the ratchet gear 35, against the urging force of the twisted coil spring 26. Accordingly, the rotation of the take-up drum unit 6 is locked, and thus the pull out of the webbing 3 is locked.

Further, as the clutch side projecting portion 146A is further rotated toward the side having the fixed side projecting portion 148 erected on the inner circumferential wall of the mechanism housing portion 87, the elastic rib 146 of the clutch 85 makes contact with and is pressed by the fixed side projecting portion 148, and elastically deforms radially inward, and smoothly rides over the fixed side projecting portion 148. Then, each of the engagement teeth 23A, 23B of the pawl 23 makes contact with the ratchet gear portion 35A of the ratchet gear 3, stopping the rotation of the pawl 23, so that the clutch 85 stops rotating in the webbing pull-out direction (in a direction of arrow 156) at a position where the fixed side projecting portion 148 is overridden by the clutch side projecting portion 146A of the elastic rib 146.

There, the clutch side projecting portion 146A of the elastic rib 146, which is formed projecting radially outward from the outer circumference portion of the clutch 85, deforms radially inward elastically, and then rides over the fixed side projecting portion 148 provided on the inner circumferential wall of the mechanism housing portion 87, and makes contact with, or is positioned in the vicinity of, a side portion on the webbing pull-out side of the fixed side projecting portion 148.

### [Disengagement Operation]

Next the discussion is given on the disengagement operation of the “webbing-sensitive lock mechanism,” referring to FIG. 23 through FIG. 25. As illustrated in FIG. 23, after the rotation of the take-up drum unit 6 is locked and the pull-out of the webbing 3 is also locked, when the tensile force applied to the webbing 3 in the pull-out direction is slacked, and the webbing 3 is slightly taken in, (for instance, approximately 5 mm in the direction of arrow 152), the take-up drum unit 6 is slightly rotated in the webbing take-up direction (in a direction of arrow 158) by the urging force of the take-up spring unit 8.

As connected to the ratchet gear 35 with a relative rotation thereto prevented, the locking gear 81 is thereby slightly rotated integrally with the ratchet gear 35 in the webbing take-up direction (in a direction of arrow 159). Meanwhile, in the clutch 85, the clutch side projecting portion 146A of the elastic rib 146 makes contact with the fixed side projecting portion 148 in a state having ridden over the fixed side projecting portion 148, so that the rotation in the webbing take-up direction (in the direction of arrow 159) is relatively delayed with regard to the rotation of the locking gear 81.

Thus, as illustrated in FIG. 23, a rotary differential imparting mechanism 149 can be configured by the clutch side projecting portion 146A projecting from the elastic rib 146 integrally formed on the outer circumference portion located radially outward with regard to the rotational axis of the clutch 85, and by the fixed side projecting portion 148 erected radially inward on the inner circumferential wall of the mechanism housing portion 87 of the mechanism cover 71 fixed to the side wall portion 12 of the housing 11, projecting contactable with the clutch side projecting portion 146A at the rotation in the webbing pull-out direction of the clutch 85. The rotary differential imparting mechanism 149 can make the rotation of the clutch 85 in the webbing take-up direction relatively slow with regard to the rotation of the locking gear 81.

As a result, the locking gear 81 rotates in the webbing take-up direction, relatively preceding the rotation of the clutch 85 in the webbing take-up direction, and a clearance that allows the locking arm 82 to rotate in the rotation direction for disengaging the engagement with the clutch gear 108 is produced between the locking side corner portion of the engagement claw 109 of the locking arm 82 and the clutch gear 108. Further, a clearance that allows the pawl 23 to rotate in the rotation direction for disengaging the engagement with the ratchet gear 35 is also produced between the ratchet gear portion 35A of the ratchet gear 35 and the engagement teeth 23A, 23B of the pawl 23.

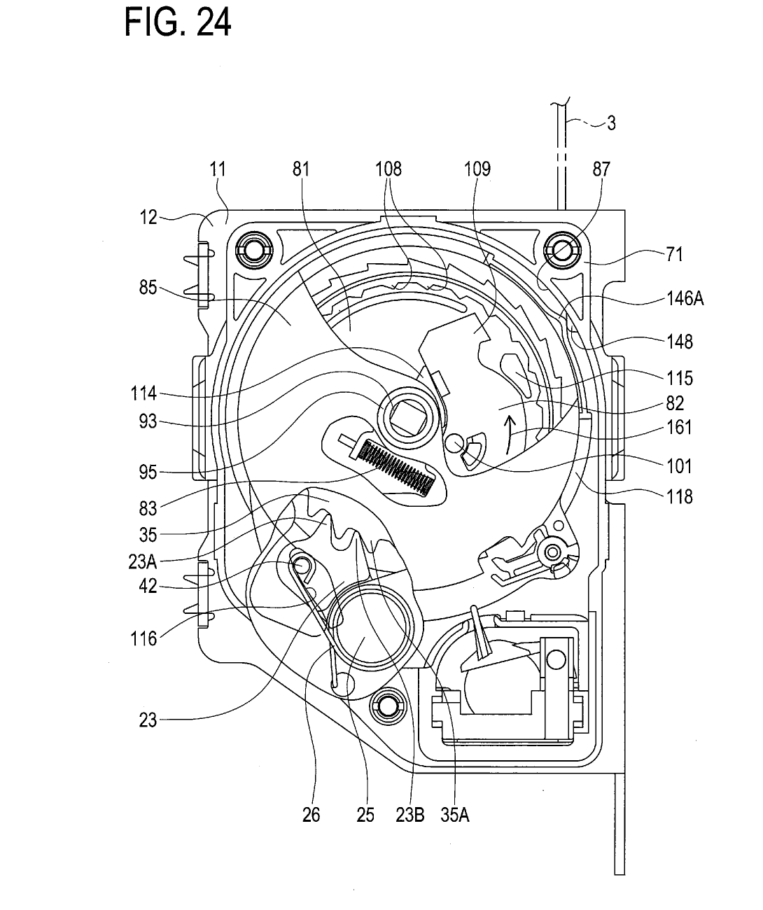

As illustrated in FIG. 24, the locking arm 82 then becomes rotatable in the direction for disengaging the engagement with the clutch gear 108, and is rotated centering the supporting boss 101, in the counterclockwise direction (in a direction of arrow 161) by the urging force of the sensor spring 83. The locking arm 82 is then released from the engagement with the clutch gear 108, and returns to the initial position abutting on the stopper 114.

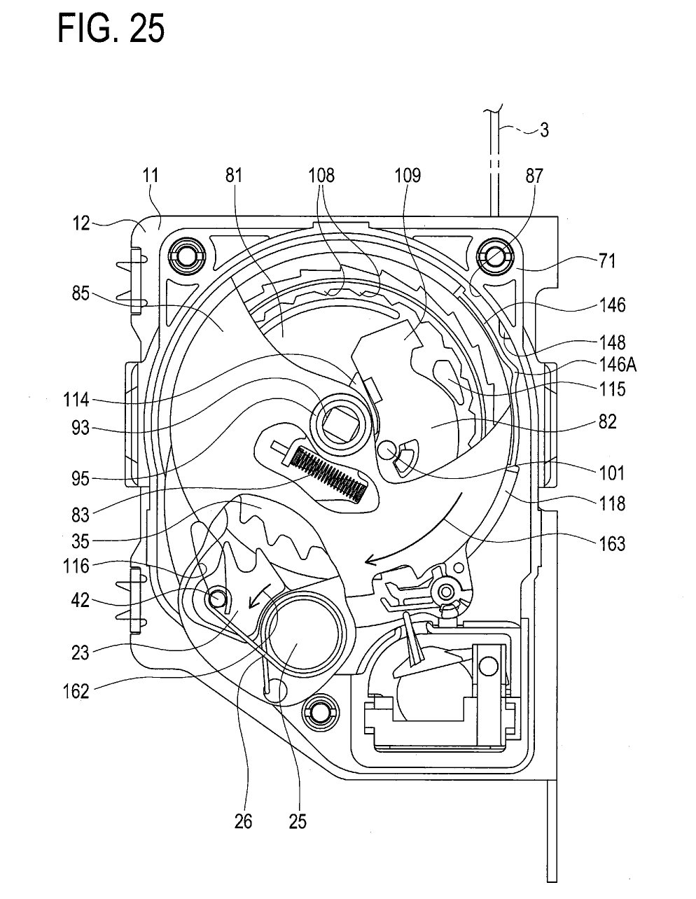

Subsequently, as illustrated in FIG. 24 and FIG. 25, the pawl 23 becomes rotatable in the rotation direction for disengaging the engagement with the ratchet gear 35, and is rotated in the direction removed from the ratchet gear 35 (in a direction of arrow 162) by the twisted coil spring 26, so that the engagement with the ratchet gear 35 is released. Further, at the same time, along the rotation of the pawl 23 by the urging force of the twisted coil spring 26, the guiding pin 42 of the pawl 23 moves the guiding hole 116 in the opposite direction of the direction at the lock activation, so that the clutch 85 is rotatably urged in the webbing take-up direction (in a direction of arrow 163).

In the elastic rib 146 of the clutch 85, the clutch side projecting portion 146A thereby makes contact with and is pressed by the fixed side projecting portion 148 provided on the inner circumferential wall of the mechanism housing portion 87, then makes elastic deformation radially inward, and smoothly rides over the fixed side projecting portion 148. Thereafter, the clutch 85 is, along with the rotation of the pawl 23 by the urging force of the twisted coil spring 26, rotated in the webbing take-up direction (in the direction of arrow 163), and returns to the standard rotation position of the normal state in which the guiding pin 42 abuts on the end portion located most removed from the ratchet gear 35 of the guiding hole 116 (in FIG. 25, the lower end portion of the guiding hole 116).

As the engagement of the engagement teeth 23A, 23B of the pawl 23 and the ratchet gear 35 is released and the pawl 23 moves away from the ratchet gear 35, the locked state of the take-up drum unit 6 by the pawl 23 is resolved, and it becomes possible to pull out the webbing 3. Accordingly, only a little amount of take-up of the webbing 3 is sufficient to release the lock of the rotation of the take-up drum unit 6.

### [Description of Operation in Vehicle-Body-Sensitive Lock Mechanism]

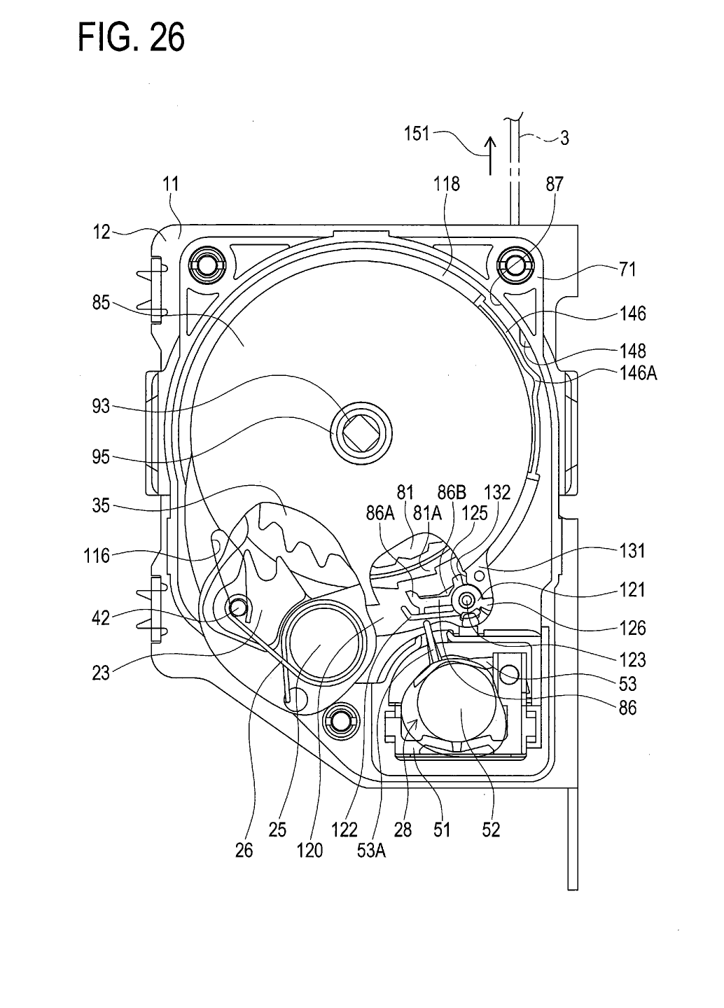

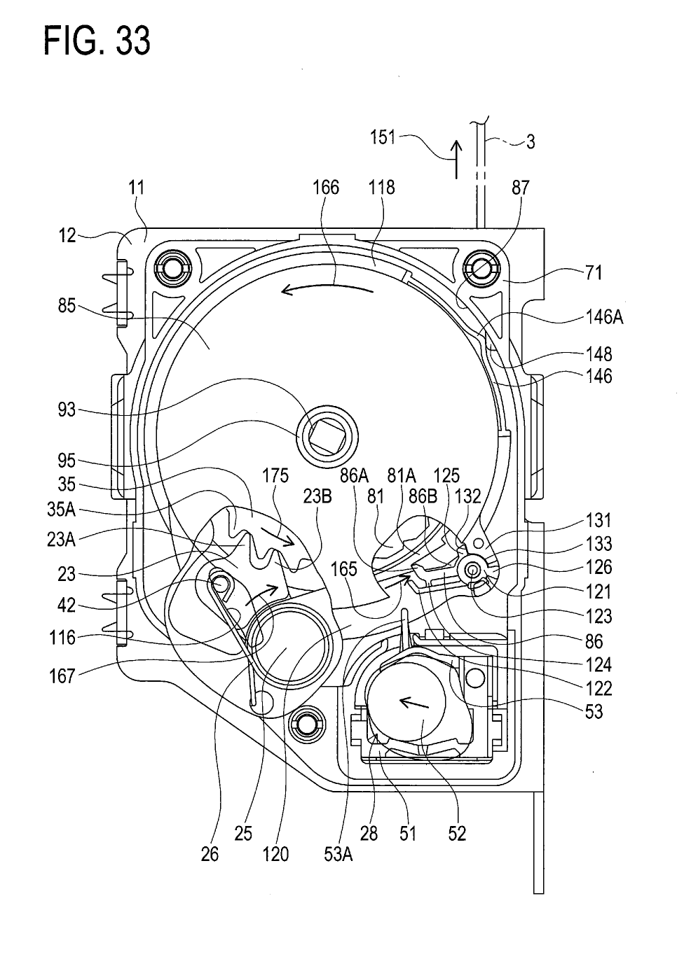

Next, the locking operation of the “vehicle-body-sensitive lock mechanism” will be described referring to FIGS. 26 through 37. FIGS. 26 through 32 are explanatory views depicting the operations of “vehicle-body-sensitive lock mechanism.” FIGS. 33 through 37 are explanatory views depicting the operations when the pawl 23 of the “vehicle-body-sensitive lock mechanism” becomes out of synchronization. To illustrate the “vehicle-body-sensitive lock mechanism,” other portions are cut off to reveal the relation between the pilot lever 86 and the locking gear 81, and to reveal the relation between the sensor holder 51 and the sensor lever 53 of the vehicle acceleration sensor 28, in addition to the portion cut off to reveal the relation between the pawl 23 and the ratchet gear 35.

### [Normal Locking Operation]

First, the normal locking operation of the “vehicle-body-sensitive lock mechanism” will be described referring to FIGS. 26 through 29. As illustrated in FIGS. 26 and 27, the spherical inertia mass 52 of the acceleration sensor 28 is placed on a bowl-like bottom face portion of the sensor holder 51, and moves on the bottom face portion of the sensor holder 51 to pivotally move the sensor lever 53 upward in vertical direction, if the acceleration due to rocking or tilting of the vehicle body exceeds the predetermined acceleration (for instance, approximately 2.0 G).

Thus, the lock claw 53A of the sensor lever 53 makes contact with the receiving plate portion 122 of the pilot lever 86 rotatably attached to the mounting boss 123 formed at the extending portion 120 of the clutch 85, to rotate the pilot lever 86 upward in vertical direction. Accordingly, the pilot lever 86 is rotated clockwise (in a direction of arrow 164) around the axial center of the mounting boss 123, and the engagement claw portion 86A of the pilot lever 86 enters inside the opening portion 138 of the clutch 85 (refer to FIG. 10), and is engaged with a locking gear tooth 81A formed at the outer peripheral portion of the locking gear 81. Here, a predetermined clearance (for instance, approximately 0.1 mm clearance) is formed between the upward rotation restrictor portion 125 and the upward rotation restricting end face portion 132 of the pilot lever supporting block 131.

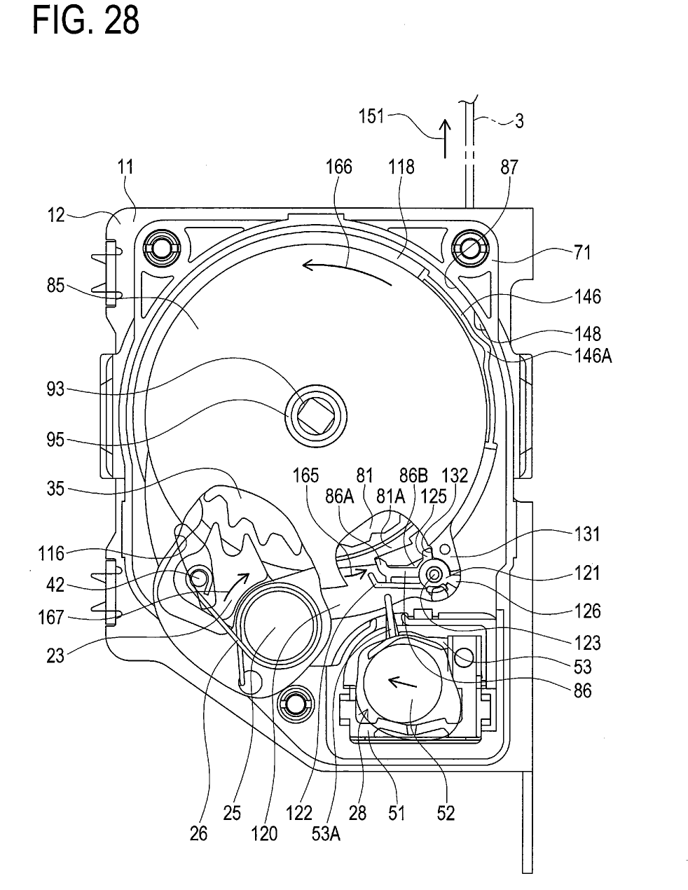

Then, as illustrated in FIGS. 27 and 28, when the webbing 3 is pulled out while the pilot lever 86 is engaged with the locking gear tooth 81A of the locking gear 81, the locking gear 81 is rotated in the webbing pull-out direction (in a direction of arrow 165). Further, the rotation of the locking gear 81 in the webbing pull-out direction is transmitted through the pilot lever 86, the mounting boss 123 and the pilot lever supporting block 131, to the clutch 85.

Accordingly, in response to the rotation of the locking gear 81 in the webbing pull-out direction, the clutch 85 is rotated around the axial center of the rib 95 of the locking gear 81, namely, around the axial center of the rotational axis portion 93 in the webbing pull-out direction (in a direction of arrow 166), against the urging force by the guiding pin 42 of the pawl 23 rotatably urged by the twisted coil spring 26 in the direction away from the ratchet gear 35.

Thus, along the rotation of the clutch 85 in the webbing pull-out direction (in the direction of arrow 166), the guiding pin 42 of the pawl 23 is guided by the guiding hole 116 of the clutch 85, so that the pawl 23 is rotated toward the ratchet gear 35 side (in a direction of arrow 167). The clutch side projecting portion 146A of the elastic rib 146 is formed elastically deformable toward the radially inside, on the flange portion 118 on the substantially diametrically opposite side of the guiding hole 116 of the clutch 85. The clutch side projecting portion 146A of the elastic rib 146 is also rotated in a direction of the fixed side projecting portion 148 erected on the inner circumferential wall of the mechanism housing portion 87 of the mechanism cover 71, together with the rotation of the clutch 85.

Accordingly, if the webbing 3 is continuously pulled out, the clutch 85 is further rotated in the webbing pull-out direction (in the direction of arrow 166), against the urging force by the guiding pin 42 of the pawl 23 rotatably urged by the twisted coil spring 26 in the direction away from the ratchet gear 35. Thereby, the guiding pin 42 of the pawl 23 is guided by the guiding hole 116 of the clutch 85, and each of the engagement teeth 23A and 23B of the pawl 23 is engaged with the ratchet gear portion 35A of the ratchet gear 35. Thus, the rotation of the take-up drum unit 6 is locked, and thus the pull-out of the webbing 3 is locked.

Further, as the clutch side projecting portion 146A is further rotated toward the side having the fixed side projecting portion 148 erected on the inner circumferential wall of the mechanism housing portion 87, the elastic rib 146 of the clutch 85 makes contact with and is pressed by the fixed side projecting portion 148, and elastically deforms radially inward, and smoothly rides over the fixed side projecting portion 148. Then, each of the engagement teeth 23A, 23B of the pawl 23 makes contact with the ratchet gear portion 35A of the ratchet gear 3, stopping the rotation of the pawl 23, so that the clutch 85 stops rotating in the webbing pull-out direction (in a direction of arrow 166) at a position where the fixed side projecting portion 148 is overridden by the clutch side projecting portion 146A of the elastic rib 146.

There, the clutch side projecting portion 146A of the elastic rib 146, which is formed projecting radially outward from the outer circumference portion of the clutch 85, deforms radially inward elastically, and then rides over the fixed side projecting portion 148 provided on the inner circumferential wall of the mechanism housing portion 87, and makes contact with, or is positioned in the vicinity of, a side portion on the webbing pull-out side of the fixed side projecting portion 148.

### [Disengagement Operation]

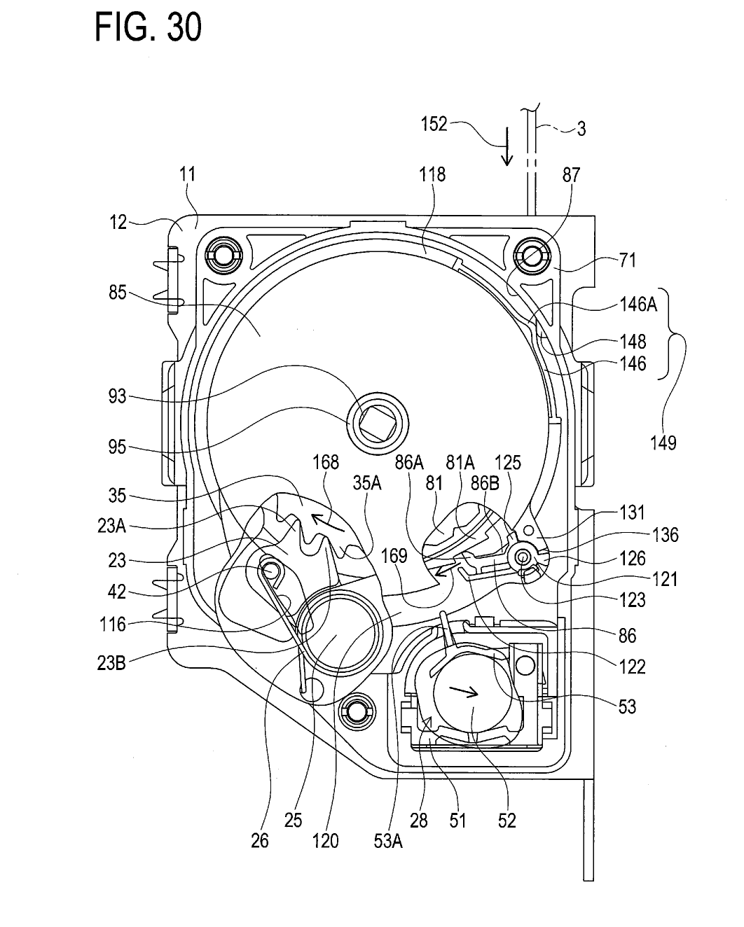

Next, the disengagement operation of the “vehicle-body-sensitive lock mechanism” is discussed referring to FIGS. 30 through 32. As illustrated in FIG. 30, after the rotation of the take-up drum unit 6 is locked and the pull-out of the webbing 3 is also locked, when the tensile force applied to the webbing 3 in the pull-out direction is slacked, and the webbing 3 is slightly taken in, (for instance, approximately 5 mm in the direction of arrow 152), the take-up drum unit 6 is slightly rotated in the webbing take-up direction (in a direction of arrow 168) by the urging force of the take-up spring unit 8. Further, if the vehicle acceleration here is equal to or lower than a predetermined value, the inertial mass 52 of the vehicle acceleration sensor 28 returns to a normal position that lies on a bowl-shaped bottom center portion of the sensor holder 51.

Thus, as connected by each convex portion 96 to the ratchet gear 35 with a relative rotation thereto prevented, the locking gear 81 is thereby slightly rotated integrally with the ratchet gear 35 in the webbing take-up direction (in a direction of arrow 169). Meanwhile, in the clutch 85, the clutch side projecting portion 146A of the elastic rib 146 makes contact with the fixed side projecting portion 148 in a state having ridden over the fixed side projecting portion 148, so that the rotation in the webbing take-up direction (in the direction of arrow 169) is relatively delayed with regard to the rotation of the locking gear 81.

Thus, as illustrated in FIG. 30, a rotary differential imparting mechanism 149 can be configured by the clutch side projecting portion 146A projecting from the elastic rib 146 integrally formed on the outer circumference portion located radially outward with regard to the rotational axis of the clutch 85, and by the fixed side projecting portion 148 erected radially inward on the inner circumferential wall of the mechanism housing portion 87 of the mechanism cover 71 fixed to the side wall portion 12 of the housing 11, projecting contactable with the clutch side projecting portion 146A at the rotation in the webbing pull-out direction of the clutch 85. The rotary differential imparting mechanism 149 capable of making the rotation of the clutch 85 in the webbing take-up direction relatively delayed with regard to the rotation of the locking gear 81.

As a result, the locking gear 81 rotates in the webbing take-up direction, relatively preceding the rotation of the clutch 85 in the webbing take-up direction, and a clearance that allows the pilot lever 86 to rotate in the rotation direction for disengaging the engagement with the locking gear tooth 81A is produced between the locking gear tooth 81A and the tip portion of the engagement claw portion 86A of the pilot lever 86. Further, a clearance that allows the pawl 23 to rotate in the rotation direction for disengaging the engagement with the ratchet gear 35 is also produced between the ratchet gear portion 35A of the ratchet gear 35 and the engagement teeth 23A, 23B of the pawl 23.

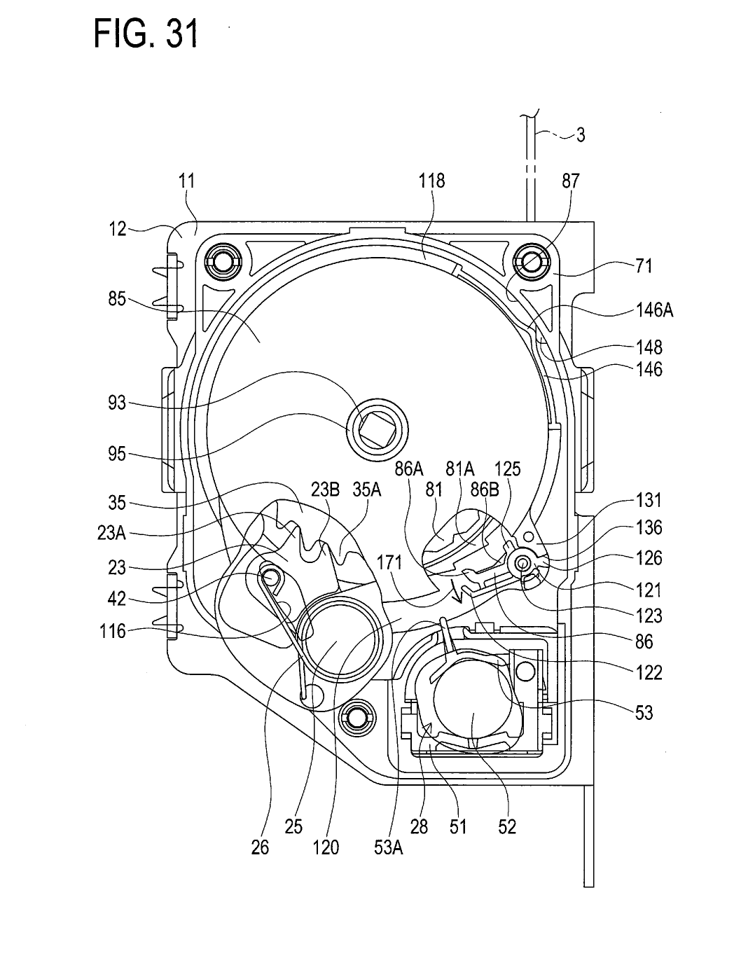

As illustrated in FIG. 31, the pilot lever 86 then becomes rotatable in the direction for disengaging the engagement between the engagement claw portion 86A and the locking gear 81, and rotates vertically downward (in a direction of arrow 171) by its own weight. The pilot lever 86 is then released from the engagement with the locking gear 81, and returns to the state of the initial position in which the downward rotation restrictor portion 126 of the pilot lever 86 abuts on the downward rotation restricting end face portion 136 of the pilot lever supporting block 131.

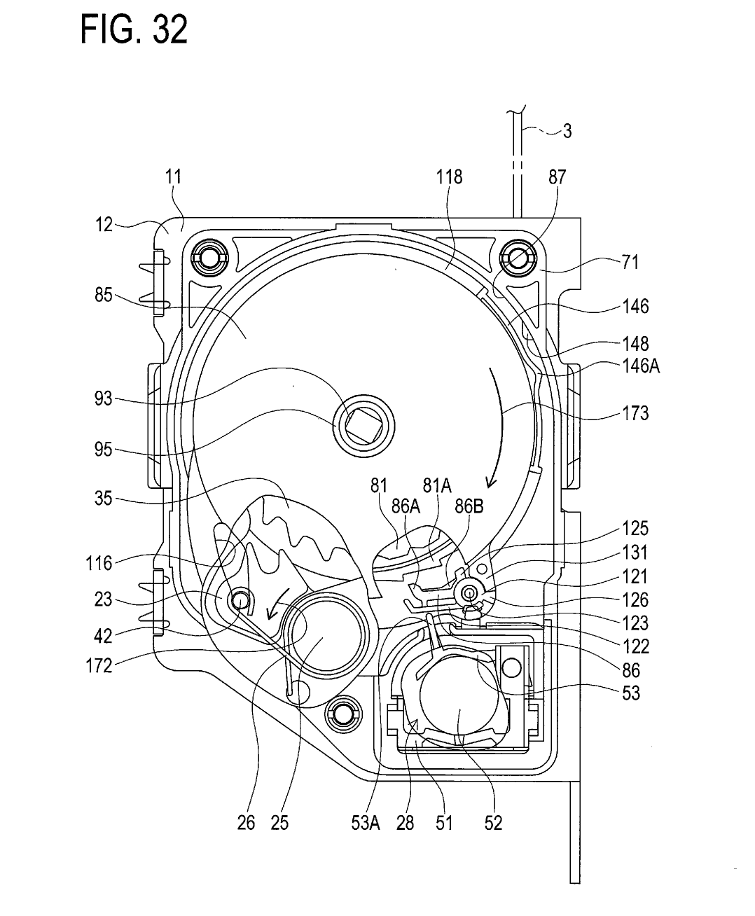

Subsequently, as illustrated in FIGS. 31 and 32, the pawl 23 becomes rotatable in the rotation direction for disengaging the engagement with the ratchet gear 35, and is rotated in the direction removed from the ratchet gear 35 (in a direction of arrow 172) by the twisted coil spring 26, so that the engagement with the ratchet gear 35 is released. Further, at the same time, along the rotation of the pawl 23 by the urging force of the twisted coil spring 26, the guiding pin 42 of the pawl 23 moves the guiding hole 116 in the opposite direction of the direction at the lock activation, so that the clutch 85 is rotatably urged in the webbing take-up direction (in a direction of arrow 173).

In the elastic rib 146 of the clutch 85, the clutch side projecting portion 146A thereby makes contact with and is pressed by the fixed side projecting portion 148 provided on the inner circumferential wall of the mechanism housing portion 87, then makes elastic deformation radially inward, and smoothly rides over the fixed side projecting portion 148. Thereafter, the clutch 85 is, along with the rotation of the pawl 23 by the urging force of the twisted coil spring 26, rotated in the webbing take-up direction (in the direction of arrow 173), and returns to the standard rotation position of the normal state in which the guiding pin 42 abuts on the end portion located most removed from the ratchet gear 35 of the guiding hole 116 (in FIG. 32, the lower end portion of the guiding hole 116).

The pilot lever 86 is rotated toward the vehicle acceleration sensor 28 by its own weight, and returns to a normal state in which the receiving plate portion 122 is positioned in the vicinity of the lock claw 53A of the sensor lever 53. Then, as the engagement of the engagement teeth 23A, 23B of the pawl 23 and the ratchet gear 35 is released and the pawl 23 moves away from the ratchet gear 35, the locked state of the take-up drum unit 6 by the pawl 23 is resolved, and it becomes possible to pull out the webbing 3. Accordingly, only a little amount of take-up of the webbing 3 is sufficient to release the lock of the rotation of the take-up drum unit 6.

[Locking Operation when Pawl is Out-of-Synchronization]

Here, the locking operation when the pawl 23 of the “vehicle-body-sensitive lock mechanism” becomes out-of-synchronization is discussed referring to FIGS. 28, 33 through 37. As illustrated in FIGS. 28 and 33, when the webbing 3 is pulled out under a state where the engagement claw portion 86A of the pilot lever 86 engages with a locking gear tooth 81A of the locking gear 81, and the locking gear 81 is rotated in the webbing pull-out direction (in the direction of arrow 165). Further, with the rotation of the locking gear 81 in the webbing pull-out direction, the clutch 85 is rotated in the webbing pull-out direction (in the direction of arrow 166), and the pawl 23 is rotated toward the ratchet gear 35 side (in the direction of arrow 167).

Thereafter, as the clutch side projecting portion 146A is rotated toward the fixed side projecting portion 148 erected on the inner circumferential wall of the mechanism housing portion 87, the elastic rib 146 of the clutch 85 makes contact with and is pushed by the fixed side projecting portion 148, elastically deforms radially inward, and smoothly rides over the fixed side projecting portion 148.

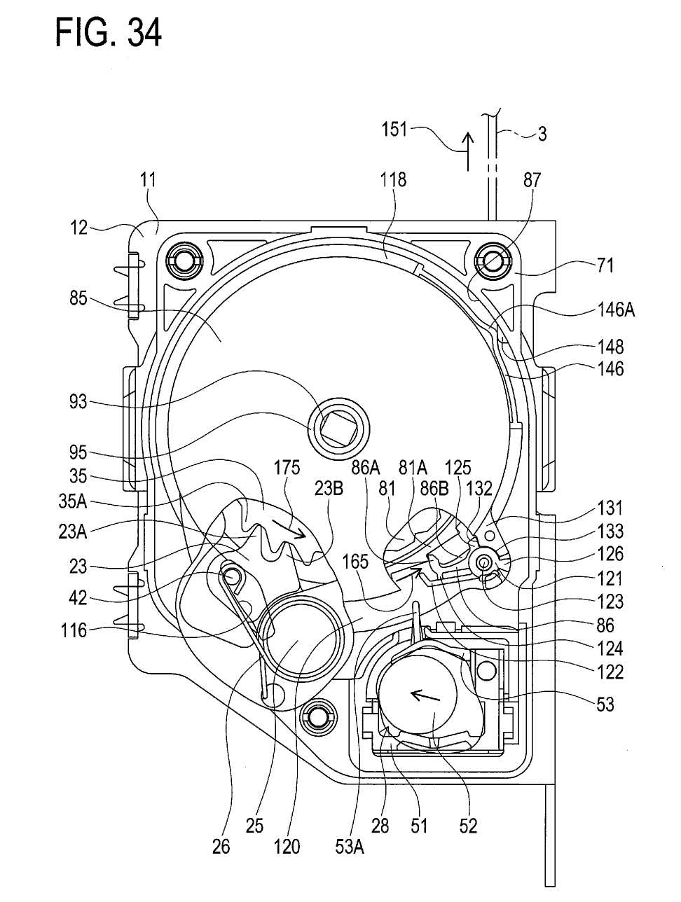

As illustrated in FIGS. 33 and 34, as each of the engagement teeth 23A and 23B of the pawl 23 makes contact with the ratchet gear portion 35A of the ratchet gear 35 to stop the rotation of the pawl 23, the rotation of the clutch 85 in the webbing pull-out direction (in the direction of arrow 166) is locked.

Meanwhile, there still is a slight clearance between the engagement teeth 23A and 23B of the pawl 23 and each tooth of the ratchet gear portion 35A that engages the engagement teeth 23A and 23B, as illustrated in FIG. 33. Accordingly, when the pull-out of the webbing 3 continues, the ratchet gear 35 rotates in the webbing pull-out direction (in a direction of arrow 175) until the lock is completed. At the same time, the locking gear 81 rotates integrally with the ratchet gear 35 and presses the engagement claw portion 86A of the pilot lever 86 engaging with a locking gear tooth 81A.

The pilot lever 86 is further rotated in a clockwise direction around an axial center of the mounting boss 123, and the upward rotation restrictor portion 125 makes contact with the upward rotation restricting end face portion 132 of the pilot lever supporting block 131, and vertically upward rotation is restricted. Further, at the same time, the mounting boss 123 deforms toward the pilot lever supporting block 131, and the sleeve portion 121 of the pilot lever 86 is made to abut on the load receiving surface 133 of the pilot lever supporting block 131.

As illustrated in FIGS. 34 through 36, the ratchet gear 35 is then further rotated in the webbing pull-out direction (in the direction of arrow 175) until the tip portion of each of the engagement teeth 23A and 23B of the pawl 23 makes contact with each tooth of the ratchet gear portion 35A and the locking operation is completed. Further, at the same time, the receiving plate portion 122 connected through the connecting plate portion 124 and the engagement claw portion 86A of the pilot lever 86 is pushed by the locking gear tooth 81A toward the sleeve portion 121 side, makes elastic deformation toward the sleeve portion 121 side, and warps into an approximately U-shape projecting radially outward. Here, the tip portion of the engagement claw portion 86A approximately L-shaped when viewed in the rotational axis direction is elastically deformed toward the sleeve portion 121 side, mainly at a portion obliquely bent toward the locking gear 81 side.

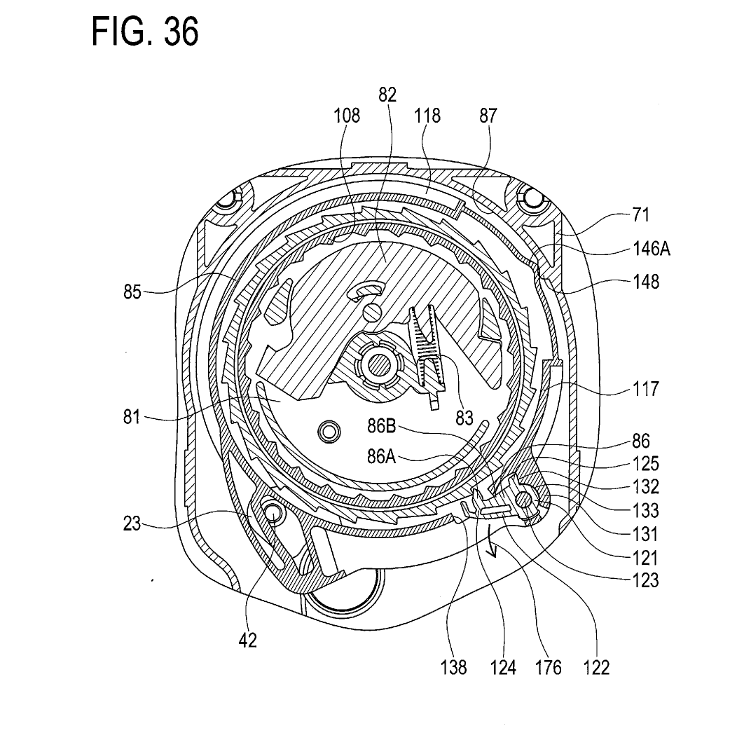

Further, as illustrated in FIG. 36, the opening portion 138 into which the pilot lever 86 of the clutch 85 enters is formed large enough to avoid contact with the engagement claw portion 86A and the receiving plate portion 122 connected through the connecting plate portion 124 even elastically deformed toward the sleeve portion 121 side and warped in an approximately radially-outward projecting U-shape. Further, as elastically deforming and warping in an approximately radially-outward projecting U-shape, the tip portion of the engagement claw portion 86A of the pilot lever 86 is gradually displaced radially outward (in a direction of arrow 176) with regard to the locking gear teeth 81A.

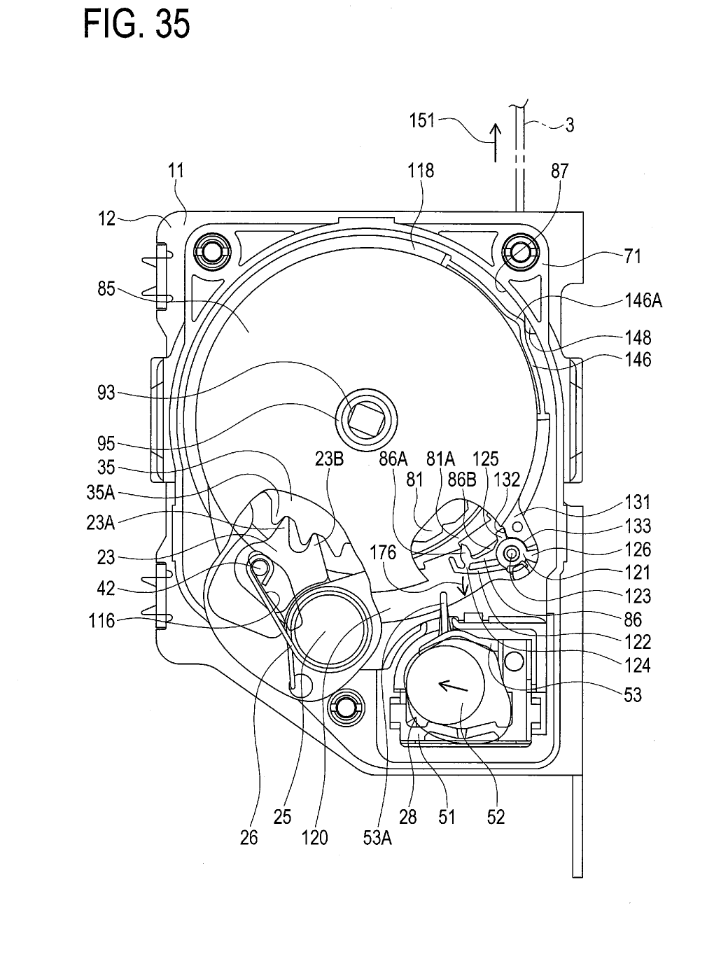

Accordingly, as illustrated in FIGS. 35 through 37, when an elastic deformation amount enough to release the engagement claw portion 86A from the locking gear tooth 81A is reached by the elastic deformation toward the sleeve portion 121 side of the receiving plate portion 122 connected through the connecting plate portion 124 and the engagement claw portion 86A of the pilot lever 86, the tip portion of the engagement claw portion 86A is disengaged radially outward from the locking gear tooth 81A.

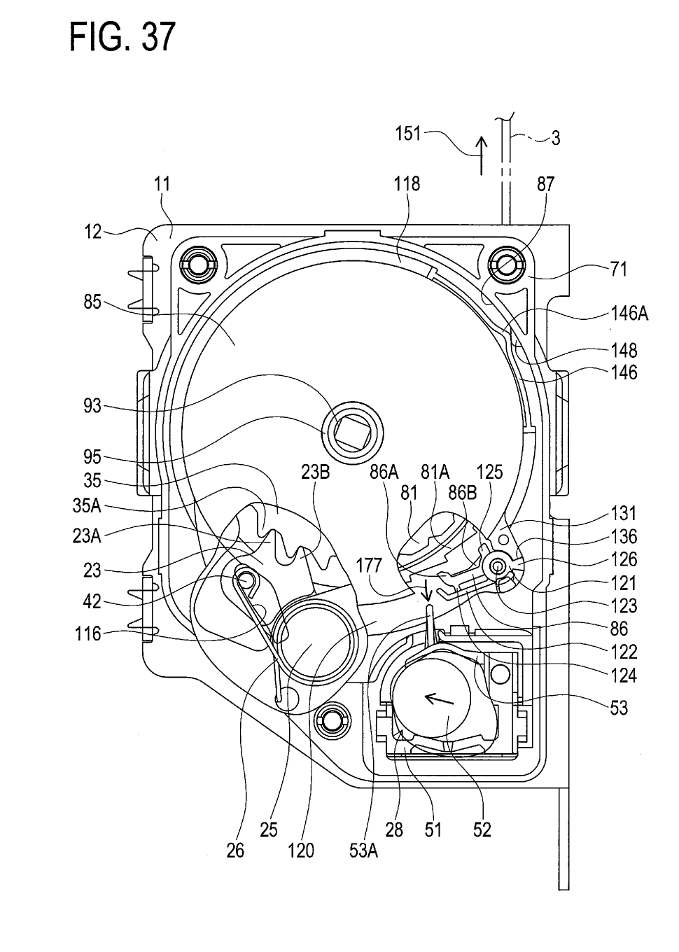

As illustrated in FIG. 37, as the elastic deformation of the engagement claw portion 86A and the receiving plate portion 122 connected through the connecting plate portion 124 is released, the pilot lever 86 disengaged from the locking gear tooth 81A returns to the shape of the normal state. Further, the pilot lever 86 rotates vertically downward (in a direction of arrow 177) by its own weight as the engagement between the engagement claw portion 86A and the locking gear 81 is released, and returns to the state of the initial position in which the downward rotation restrictor portion 126 of the pilot lever 86 abuts on the downward rotation restricting end face portion 136 of the pilot lever supporting block 131.

Further, the tip portion of each of the engagement teeth 23A and 23B of the pawl 23 makes contact with each tooth of the ratchet gear portion 35A and the lock operation is complete. Accordingly, the rotation of the take-up drum unit 6 is locked, and thus the pull-out of the webbing 3 is locked.

There, the clutch side projecting portion 146A of the elastic rib 146, which is formed projecting radially outward from the outer circumference portion of the clutch 85, deforms radially inward elastically, and then rides over the fixed side projecting portion 148 provided on the inner circumferential wall of the mechanism housing portion 87, and makes contact with, or is positioned in the vicinity of, a side portion on the webbing pull-out side of the fixed side projecting portion 148.

However, even if the elastic deformation toward the sleeve portion 121 side of the receiving plate portion 122 connected through the connecting plate portion 124 and the engagement claw portion 86A of the pilot lever 86 does not reach the elastic deformation amount that allows the engagement claw portion 86A to be removed from the locking gear tooth 81A, the clutch side projecting portion 146A of the elastic rib 146, which is formed projecting radially outward from the outer circumference portion of the clutch 85, still deforms radially inward elastically, and then rides over the fixed side projecting portion 148 provided on the inner circumferential wall of the mechanism housing portion 87, and makes contact with, or is positioned in the vicinity of, a side portion on the webbing pull-out side of the fixed side projecting portion 148.

Accordingly, in the disengaging operation of the “vehicle-body-sensitive lock mechanism,” the engagement between the pilot lever 86 and the locking gear 81 can be released with only a little amount of take-up of the webbing 3 by the rotary differential imparting mechanism 149, and the lock of the rotation of the take-up drum unit 6 can also be released.

### [Schematic Configuration of Take-Up Drum Unit]

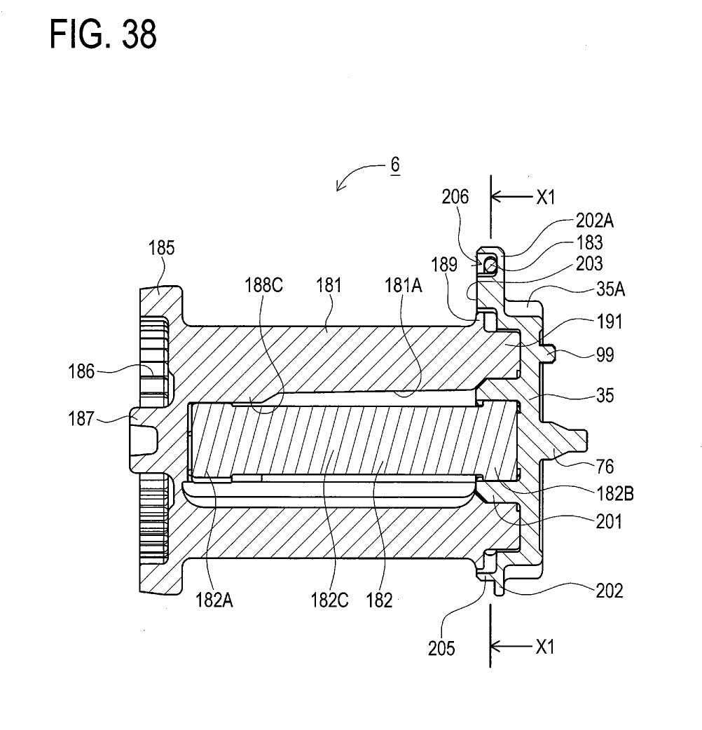

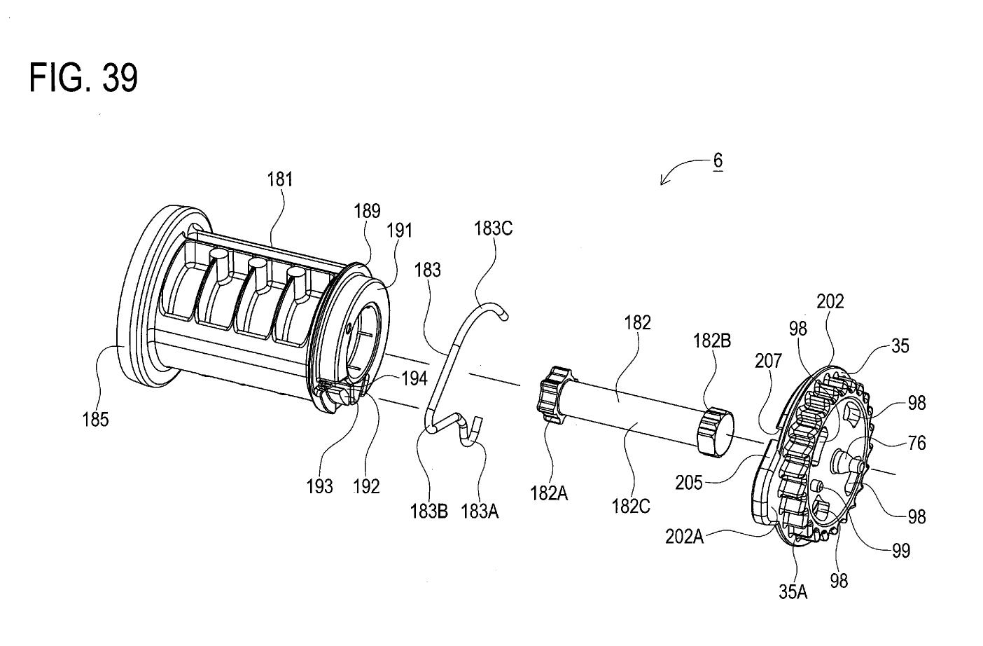

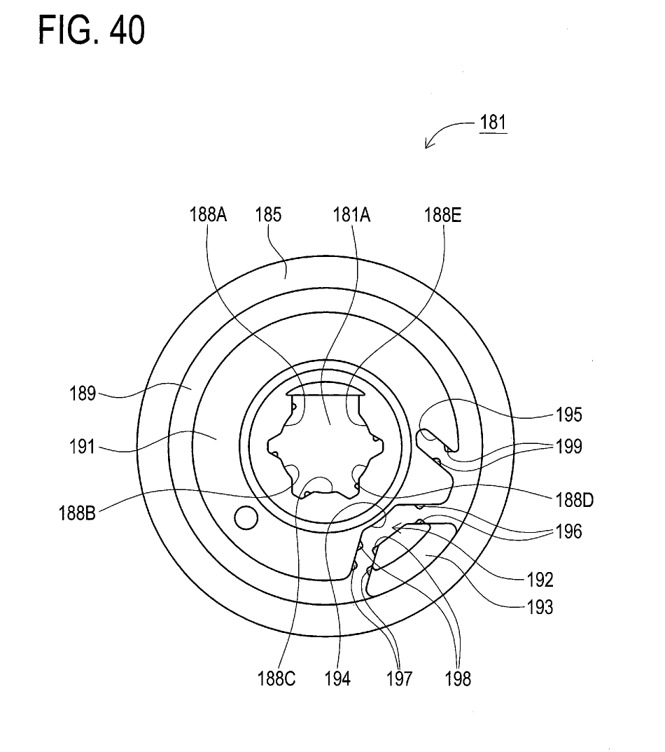

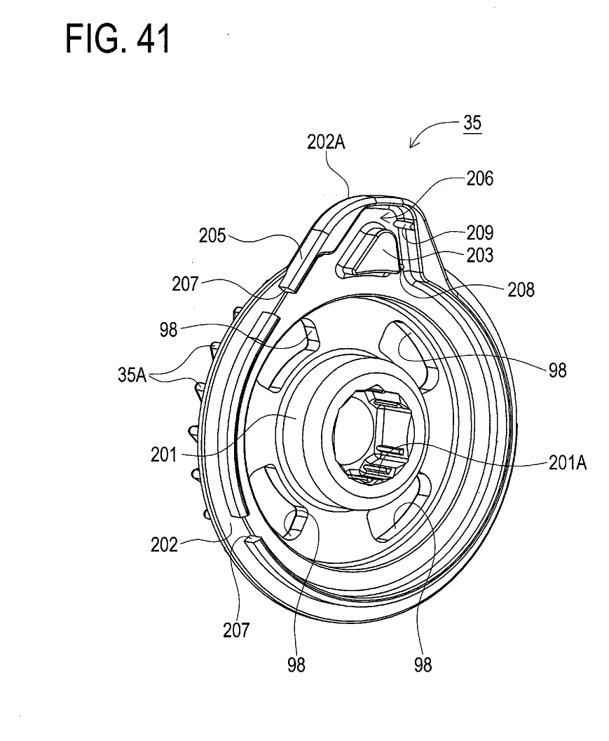

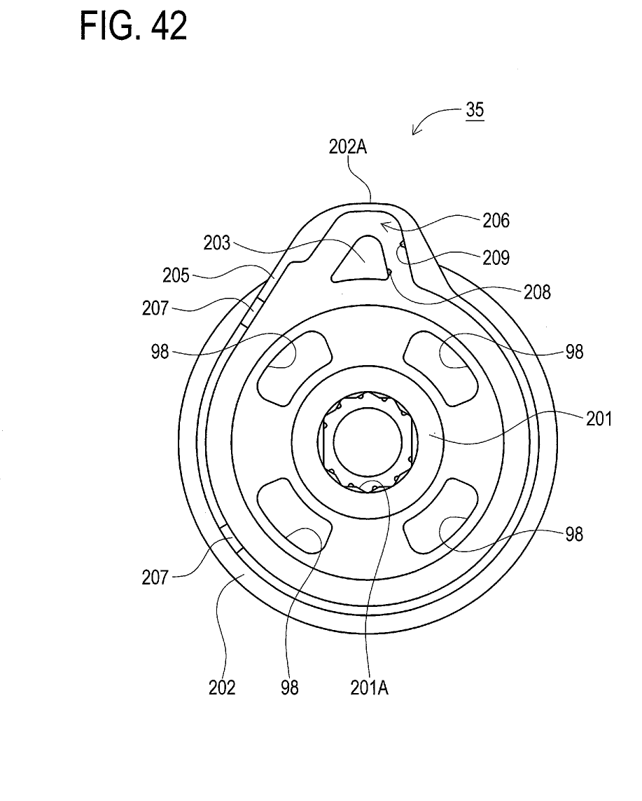

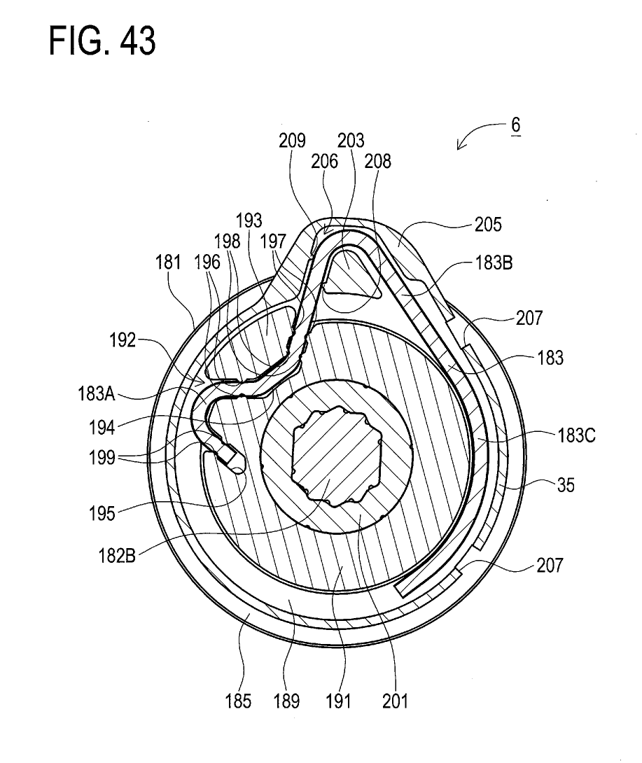

Next, a schematic configuration of the take-up drum unit 6 will be described based on FIG. 2, FIG. 3, and FIG. 38 through FIG. 43. FIG. 38 is a sectional view of a take-up drum unit 6 including an axial center thereof. FIG. 39 is an exploded perspective view of the take-up drum unit 6. FIG. 40 is a front view of the take-up drum 181 seen from a side for mounting a ratchet gear 35. FIG. 41 is a perspective view of the ratchet gear 35. FIG. 42 is a front view of an inner side of the ratchet gear 35. FIG. 43 is a cross sectional view taken along a line indicated by arrows X1-X1 in FIG. 38 and seen in the direction of the arrows.

As illustrated in FIG. 38 and FIG. 39, the take-up drum unit 6 includes the take-up drum 181, a torsion bar 182, the wire 183 and the ratchet gear 35.

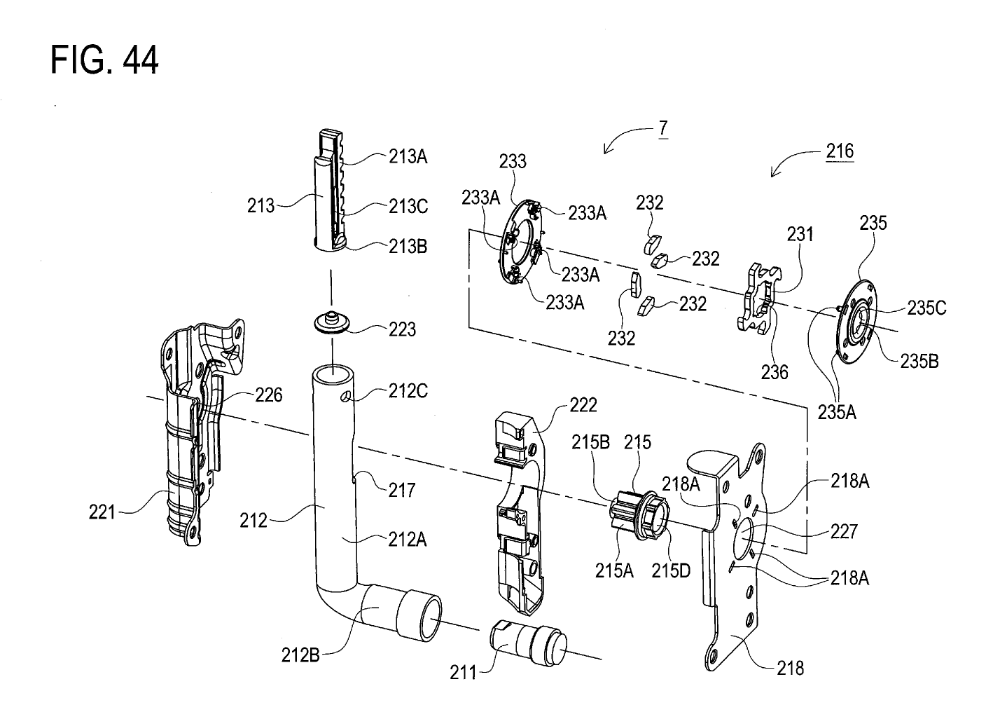

As illustrated in FIG. 2, FIG. 3, FIG. 38 and FIG. 39, the take-up drum 181 is made by aluminum die-casting, zinc die-casting or the like and is formed in a substantially cylindrical shape, with an end face on the side of the pretensioner unit 7 being walled and closed. On an edge portion of the take-up drum 181 at the side of the pretensioner unit 7 with respect to axial direction of the take-up drum 181, there is formed a flange portion 185 extending radially and outwardly at substantially right angles (leftward in FIG. 38) from an outer peripheral portion thereof. Further, on the inner circumferential surface of the flange portion 185, as later described, there is formed an internal gear 186 which engages with clutch pawls 232 (refer to FIG. 44) at vehicle collision to transmit the rotation of a pinion gear 215 (refer to FIG. 44).

A cylindrical boss 187 is erected on the center position of the end face portion on the pretensioner unit 7 side of the take-up drum 181. The boss 187 is fitted into a bearing 235 (refer to FIG. 44) formed of synthetic resin material such as polyacetal to be later described, and the base end portion of the boss 187 abuts on the bearing 235. Accordingly, one side of the take-up drum unit 6 is rotatably supported, via the bearing 235, at the boss portion 215D of the pinion gear 215 making up the pretensioner unit 7 (refer to FIG. 44). Accordingly, the pretensioner unit 7 and the locking unit 9 rotatably support the take-up drum unit 6 while preventing backlash in rotational axis direction.

The take-up drum 181 has a shaft hole 181A inside thereof. The shaft hole 181A has a draft angle in a manner tapering along a center axis. As illustrated in FIG. 38 and FIG. 40, there are formed five projecting portions 188A through 188E on the inner periphery of the shaft hole 181A on the side closer to the flange portion 185. The five projecting portions 188A through 188E each have a trapezoidal shape in cross section, with a predetermined circumferential interval, and are projecting radially inward in a rib-like shape. The torsion bar 182 is made of a steel material or the like, and includes a shaft portion 182C of a stick-like shape and circular in cross section, and splines 182A, 182B formed on both ends of the shaft portion 182C.

The projecting portions 188A through 188E are projected in a manner respectively lockable between raised portions of the spline 182A formed on one end portion of a torsion bar 182 made of the steel material, or the like. Accordingly, as illustrated in FIG. 38 and FIG. 39, the torsion bar 182 is relatively non-rotatably press-fitted inside the take-up drum 181, through pushing and putting the spline 182A side of the torsion bar 182 into the shaft hole 181A of the take-up drum 181, among projecting portions 188A through 188E.

Further, as illustrated in FIG. 38 through FIG. 40, at an end portion of the take-up drum 181 axially on the side of the locking unit 9, there is formed a flange portion 189 having substantially circular shape in front view, radially extended on the slightly axially inner circumferential surface from the end portion. Further, at a portion axially outward from the flange portion 189, a cylindrical stepped portion 191 is formed in a shape with slightly narrower outer diameter. The stepped portion 191 is provided so as to surround the spline 182B on the other side of the torsion bar 182 press-fitted inside the shaft hole 181A, forming a predetermined clearance.

Further, there is integrally formed a holding-side crooked path 192 on the outer peripheral surface of the stepped portion 191 formed on the outer side surface of the flange portion 189, having approximately circular shape in front view, as a part thereof. A crooked portion 183A at one end of linear wire 183 made of a metal material such as stainless material and having circular cross section is fixedly held at the holding-side crooked path 192.

As illustrated in FIG. 39 and FIG. 40, the holding-side crooked path 192 consists of: a convex portion 193 substantially trapezoid shaped in front view so as to go narrower in an inner radial direction and configured to project axially outward from outer side surface of the flange portion 189; a concave portion 194 configured to face the convex portion 193 on the outer peripheral surface of the stepped portion 191; a groove portion 195 formed so as to extend toward obliquely inner direction slanting in counterclockwise direction from the outer peripheral surface of the stepped portion 191 slightly away from an end portion at the counterclockwise direction in front view (counterclockwise direction side in FIG. 40) of the concave portion 194; and an outer peripheral surface between the concave portion 194 and the groove portion 195 on the stepped portion 191.

Further, as illustrated in FIG. 39 and FIG. 40, at the opposite faces on the groove portion 195 side (on a counterclockwise direction side in FIG. 40) disposed slantwise in radial direction of the convex portion 193 and that of the concave portion 194, there is erected a set of opposite ribs 196 along the depth direction of the holding-side crooked path 192. Further, on opposite faces on the opposite side (on a clockwise direction side in FIG. 40) of the groove portion 195 disposed slantwise in the radial direction of the convex portion 193 and the concave portion 194, two set of opposite ribs 197, 198 are provided along the depth direction of the holding-side crooked path 192, on a back side end portion radially inside, and on an end portion on a wire 183 exit-side radially outside, respectively.

A set of opposite ribs 199 are provided in a face opposite to the groove portion 195 along the depth direction of the holding-side crooked path 192. As illustrated in FIG. 40 and FIG. 43, the ribs 196 through 199 facing each other are aligned along the depth direction of the holding-side crooked path 192 interposing the wire 183 to be press-fitted in the holding-side crooked path 192, so as to face each other on a surface perpendicular to the axis line of the wire 183. Further, the distance between each pair of opposite ribs 196 through 199 is made smaller than outer diameter of the wire 183. Incidentally, the height of each of the ribs 196 through 199 from the bottom portion of the holding-side crooked path 192 is made higher than the outer diameter of the wire 193.

As illustrated in FIG. 39 and FIG. 43, the crooked portion 183A at the one end of the wire 183 is fitted in the holding-side crooked path 192 crushing each rib and fixedly held thereat. Further, the wire 183 includes a crooked portion 183B that is substantially inverted U-shaped in front view and formed so as to continue to the crooked portion 183A and project exterior to the outer periphery of the flange portion 189. The wire 183 further includes a crooked portion 183C that is formed so as to continue to the crooked portion 183B and shaped like an arc along outer peripheral surface outline of the stepped portion 191.

Accordingly, the crooked portion 183A of the wire 183 is held at the exist-side end portion of the holding-side crooked path 192 by two pairs of ribs 197 and 198 arranged along the axial line direction of the wire 183, so that the slant of the crooked portion 183B continued to the crooked portion 183A can be made substantially constant, with regard to the exit side of the holding-side crooked path 192.

Further, as illustrated in FIG. 38, FIG. 39, FIG. 41 and FIG. 42, the ratchet gear 35 is made by aluminum die-casting, zinc die-casting or the like, has a substantially ring shape in axial cross section and has on the outer periphery thereof the ratchet gear portion 35A. A cylindrical fixation boss 201 is erected at an inner center position of the ratchet gear 35. The inner peripheral face of the fixation boss 201 has a spline groove 201A into which the spline 182B formed on the other end side of the torsion bar 182 is press-fitted. Further, the inner peripheral portion of the ratchet gear portion 35A is configured to have an inner diameter enough to allow insertion of the stepped portion 191 of the take-up drum 181.

Here, the maximum outer diameter of the spline 182B formed on the other end side of the torsion bar 182 is configured slightly smaller than the outer diameter of the spline 182A formed on the one end of the torsion bar 182.

The ratchet gear 35 has a flange portion 202 extended radially outward in an entire periphery from the end face portion on the take-up drum 181 side of the ratchet gear portion 35A. The flange portion 202 has a ring-like shape in front view, extending radially outward than the outer diameter of the flange portion 189 of the take-up drum 181. Further, the flange portion 202 is extended radially outward from an outer circumference portion having a predetermined center angle (for instance, center angle of roughly 60 degrees) in approximately a trapezoidal shape in front view, which becomes narrower in the tip portion. Further, the outer diameter of the flange portion 202 is formed roughly the same size as the outer diameter of the flange portion 185 of the take-up drum 181.

A trapezoid-like portion 202A is extended radially outward from the flange portion 202. The trapezoid-like portion 202A is narrower at the tip portion thereof in front view and has approximately a trapezoidal shape. A convex portion 203 having approximately a conical shape in front view is formed at an approximately center portion on an inner side surface of the trapezoid-like portion 202A at the take-up-drum 181 side, and projected axially outward from the trapezoid-like portion 202A. The crooked portion 183B of the wire 183, substantially inverted U-shaped in front view, is fitted inside the convex portion 203.

Further, a flange portion 205 is formed on the inner side surface of the flange portion 202 at the take-up drum 181 side. The flange portion 205 have an inner diameter slightly larger than the outer diameter of the flange portion 189 of the take-up drum 181, erected along the outer circumference portion of the trapezoid-like portion 202A, and substantially oval-shaped in front view. Further, the inner periphery of the flange portion 205 and the outer periphery of the convex portion 203 make up a deformation-giving crooked path 206 that is substantially inverted U-shaped in front view (refer to FIG. 43). The wire 183 is guided and pulled out through the deformation-giving crooked path 206. Further, the outer circumference portion of the flange portion 205 has window portions 207 in two locations. The window portions 207 are cut out in circumferential direction so as to allow visual recognition of the installed wire 183.

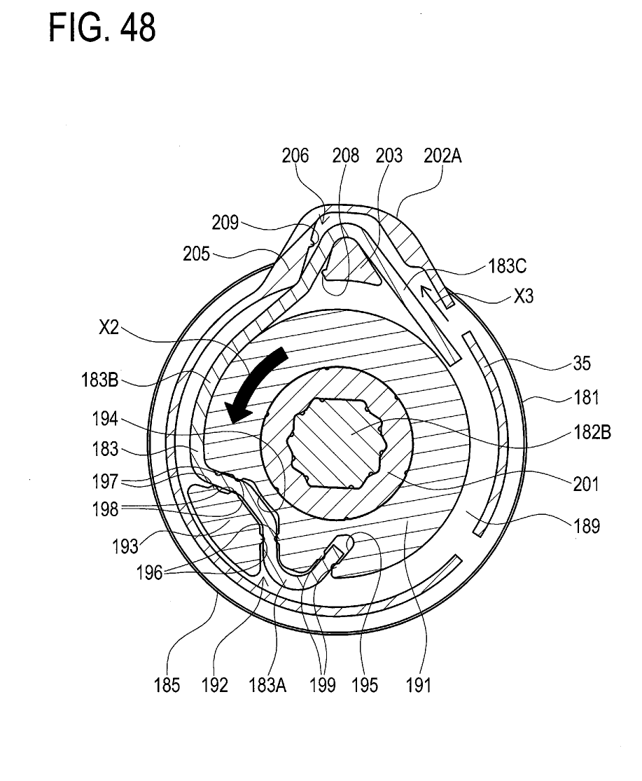

As illustrated in FIGS. 41 through 43, on a wire-pull-out-side end portion of the deformation-giving crooked path 206 from which the wire 183 is drawn out when the deformation-giving crooked path 206 makes a relative rotation with regard to the holding-side crooked path 192 as later described (refer to FIG. 48), ridge-like ribs 208, 209 are respectively formed on side face portions facing each other along a depth direction of the deformation-giving crooked path 206.

One rib 208 is erected on a wire-pull-out-side end portion at a side face opposite to the rotation direction (on the counterclockwise direction side in FIG. 43) in which the holding-side crooked path 192 relatively rotates with regard to the deformation-giving crooked path 206 when the wire is drawn out. The other rib 209 is erected on a side face of the deformation-giving crooked path 206, opposite to the rib 208 interposing the wire 183, on a side deeper in the axial line direction of the wire 183 than the rib 208 (radially outward in FIG. 42).

The distance between the ribs 208 and 209, in the direction perpendicular to the axial line of the wire 183, is configured to be substantially the same as the outer diameter of the wire 183. Accordingly, when passing through the deformation-giving crooked path 206, the wire 183 is bent and deformed at least at the apex of the convex portion 203 having a conical shape in front view, and drawing resistance is generated. The distance between the ribs 208 and 209 in the direction perpendicular to the axial line of the wire 183 may be configured to be slightly narrower than the outer diameter of the wire 183.

There will be described on attachment of the wire 183 to the take-up drum 181 and the ratchet gear 35, referring to FIG. 38, FIG. 39 and FIG. 43.

As shown in FIG. 39 and FIG. 43, the crooked portion 183A at one end of the wire 183 being bent like a substantially S-like shape is first fitted in the holding-side crooked path 192 formed on the flange portion 189 of the take-up drum 181 and the stepped portion 191. When the crooked portion 183A is fitted in the holding-side crooked path 192, the ribs 196 through 199 are crushed thereby. The crooked portion 183B that is substantially inverted U-shaped in front view and formed to continue to the crooked portion 183A is placed so as to project exterior to the outer periphery of the flange portion 189.

Further, the crooked portion 183C that is formed to continue to the crooked portion 183B and shaped like an arc is placed along outer peripheral surface outline of the stepped portion 191. Thereby, the crooked portion 183A at one end of the wire 183 is fixedly held by the holding-side crooked path 192 formed on the flange portion 189 of the take-up drum 181 and the stepped portion 191 while the crooked portion 183C is placed so as to face the flange portion 189.

Subsequently, in order to attach the ratchet gear 35 onto the take-up drum 181, first, the crooked portion 183B of the wire 183 that is substantially inverted U-shaped in front view and configured to project exterior to the outer periphery of the flange portion 189 of the take-up drum 181 is positioned by the ribs 208 and 209 and fitted in the deformation-giving crooked path 206 formed at outer peripheral portion of the convex portion 203 arranged on the trapezoid-like portion 202A of the flange portion 202 of the ratchet gear 35.

Further, at the same time, the fixation boss 201 of the ratchet gear 35 is inserted inside the stepped portion 191 of the take-up drum 181, and the spline 182B formed on the other side of the torsion bar 182 is press-fitted inside the spline groove 201A of the fixation boss 201. The wire 183 is thus arranged between the flange portion 189 of the take-up drum 181 and the flange portions 202 and 205 and the ratchet gear 35, and the ratchet gear 35 is attached on the take-up drum 181.

### [Schematic Configuration of Pretensioner Unit]

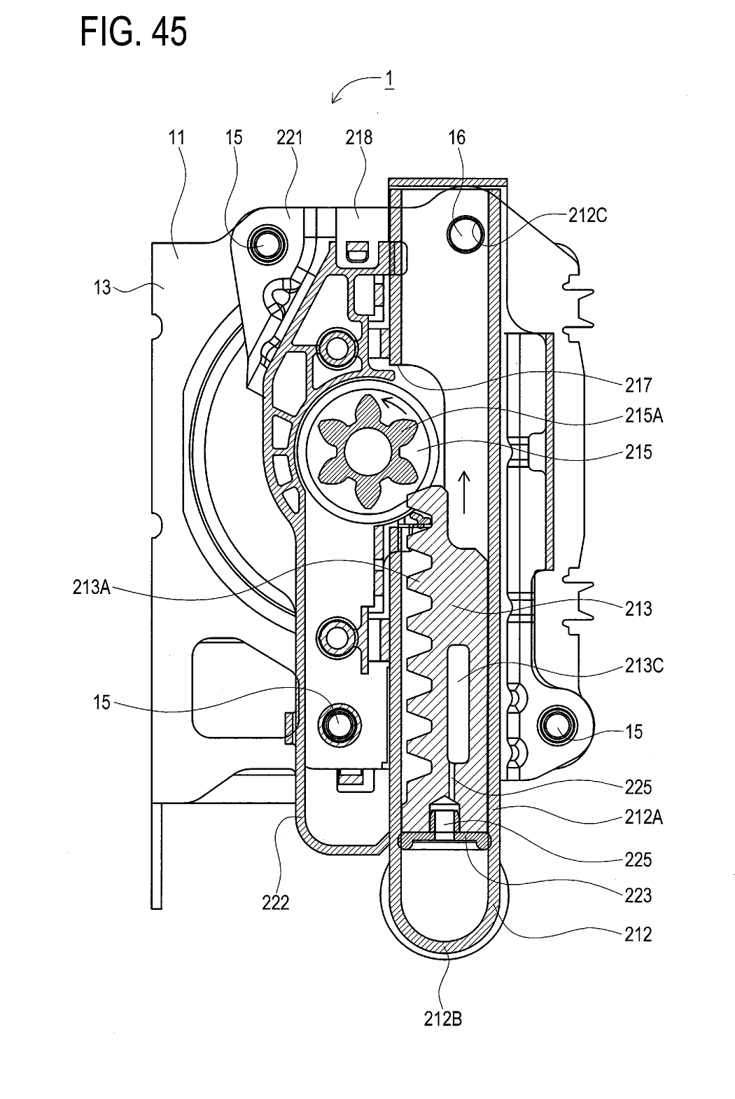

Next, a schematic configuration of the pretensioner unit 7 will be described referring to FIG. 2, FIG. 3, FIG. 44 and FIG. 45. FIG. 44 is an exploded perspective view showing the pretensioner unit 7 in a disassembled state. FIG. 45 is a cross sectional view showing an internal configuration of the pretensioner unit 7.

The pretensioner unit 7 is configured to securely restrain a vehicle occupant, through rotating the take-up drum 181 in the webbing take-up direction to remove the slack of the webbing 3, in an emergency such as vehicle collision.

As shown in FIG. 44 and FIG. 45, the pretensioner unit 7 is comprised of a gas generating member 211, a pipe cylinder 212, a piston 213, the pinion gear 215, a clutch mechanism 216, and the bearing 235.

This gas generating member 211 includes a gas generating agent such as explosive powder which is ignited in response to an ignition signal transmitted from a control portion, which is not shown, generating gas as a result of combustion of the gas generating agent.

The pipe cylinder 212 is formed as a substantially L shaped cylindrical member, with a gas introducing portion 212B connected on one end of a piston guiding cylindrical portion 212A having a linear shape. The gas introducing portion 212B is configured to house the gas generating member 211. Accordingly, the gas generated at the gas generating member 211 is introduced inside the piston guiding cylindrical portion 212A from the gas introducing portion 212B. Further, an opening portion 217 is formed in the middle portion in longitudinal direction on one side portion of the piston guiding cylindrical portion 212A, and part of pinion gear teeth 215A of the pinion gear 215 is arranged therein as later described.

The pipe cylinder 212 is held by the base plate 218 on the side wall portion 13 side of the housing 11 and by the cover plate 221 on the outside, and fixedly attached on the outer surface of the side wall portion 13 by the screws 15 under a state further held by a base block 222 and the cover plate 221 between these.

Further, a pair of through holes 212C is formed on the upper end portion of the piston guiding cylindrical portion 212A, arranged facing each other. The stopper pin 16 is inserted into the pair of through holes 212C. The stopper pin 16 attaches the pretensioner unit 7 on the side wall portion 13, and serves as a stopper for the piston 213, and also as a stopper and a rotation preventer for the pipe cylinder 212.

The piston 213 is made of a steel material or the like and has an overall lengthy shape, with a substantially rectangular shape in cross section that enables insertion thereof from the top end portion of the piston guiding cylindrical portion 212A. On a surface of the pinion gear 215 side of the piston 213, there is formed a rack 213A configured to engage with the pinion gear teeth 215A of the pinion gear 215. Further, on the end face of the gas generating member 211 side of the piston 213 is formed into a circular end face 213B corresponding to the cross sectional shape of the piston guiding cylindrical portion 212A. A sealing plate 223 formed of a rubber material or the like is attached on the circular end face 213B.

The piston 213 has a through hole 213C long along the longitudinal direction thereof. The through hole 213C has a rectangular cross-sectional shape, with both side face portions communicating. A gas releasing hole 225 is formed in the piston 213 and the sealing plate 223, and communicates from a pressure receiving side of the sealing plate 223 for receiving the pressure of the gas, to the through hole 213C. As illustrated in FIG. 45, before activation of the pretensioner unit 7, namely, in a normal waiting state in which the gas is not generated by the gas generating member 21, the piston 213 is inserted and arranged in the depth side of the piston guiding cylindrical portion 212A, up to a location in which the rack 213A is not engaged with the pinion gear teeth 215A.

The pinion gear 215 is a columnar member made of a steel material or the like. The pinion gear 215 is provided with the pinion gear teeth 215A on an outer peripheral portion thereof engageable with the rack 213A. The pinion gear 215 also has a support portion 215B formed cylindrically-shaped, extending toward the cover plate 221 side from the pinion gear teeth 215A. The support portion 215B is rotatably fitted into a supporting hole 226 formed in the cover plate 221 mountable to the side wall portion 13.

With the support portion 215B rotatably inserted in the supporting hole 226, part of the pinion gear teeth 215A is arranged inside the opening portion 217 of the piston guiding cylindrical portion 212A. As illustrated in FIG. 45, when the piston 213 moves toward the tip end side of the piston guiding cylindrical portion 212A from the normal waiting state, the rack 213A then engages with the pinion gear teeth 215A and the pinion gear 215 rotates in the webbing take-up direction.

The rotation of the pinion gear 215 is transmitted through the clutch mechanism 216 to the take-up drum 181.

That is, a cylindrical boss portion 215D projecting along the axial center direction is formed on an end portion on the side wall portion 13 side in the axial center direction of the pinion gear 215. The outer circumferential surface of the boss portion 215D has a spline formed of six projections having the outer diameter of the base end portion. The boss portion 215D is rotatably inserted in a through hole 227 formed on the base plate 218, and arranged projecting on the take-up drum 181 side.

Further, the clutch mechanism 216 is capable of switching-over from a state where the take-up drum 181 is freely rotatable with regard to the pinion gear 215 in normal time (a state where the clutch pawls 232 are housed) to a state where the rotation of the pinion gear 215 is transmitted to the take-up drum 181 at the activation of the pretensioner unit 7 (a state where the clutch pawls 232 project).

The clutch mechanism 216 includes: a pawl base 231 made of a steel material or the like; four clutch pawls 232 made of a steel material or the like; a substantially ring-like pawl guide 233 made of a synthetic resin such as polyacetal and made to have contact with the base plate 218 side of the pawl base 231; and the substantially ring-like bearing 235 made of a synthetic resin such as polyacetal, and made to have contact with the take-up drum 181 side of the pawl base 231, and to hold the pawl base 231 and the clutch pawls 232, with the pawl guide 233.

A center portion of the pawl base 231 has an engaging hole 236 having six spline grooves for the boss portion 215D of the pinion gear 215 to fit in. As the boss portion 215D of the pinion gear 215 is press-fitted in the engaging hole 236 of the pawl base 231 with the base plate 218 and the pawl guide 233 therebetween, the pawl base 231 is attached relatively non-rotatably with regard to the pinion gear 215. That is, the pawl base 231 and the pinion gear 215 are configured to rotate integrally.

Further, the bearing 235 is configured to be locked at the outer circumference portion of the pawl guide 233 by a plurality of elastic engagement pieces 235A projecting from the outer circumference portion to the pawl guide 233 side. Further, a through hole 235B having an inner diameter substantially the same size as the outer diameter of the boss 187 of the take-up drum 181 is formed in the center portion of the bearing 235. Further, a cylindrical shaft receiving portion 235C is formed, continuously projecting from the peripheral portion of the pawl base 231 side of the through hole 235B. The cylindrical shaft receiving portion 235C has the same inner diameter as that of the through hole 235B and the outer diameter substantially the same as the inner diameter of the boss portion 215D of the pinion gear 215.

When the boss portion 215D of the pinion gear 215 is press-fitted in the engaging hole 236 of the pawl base 231, the cylindrical shaft receiving portion 235C erected in the center portion of the bearing 235 is fitted inside the boss portion 215D. Further, the boss 187 is erected in the center position of end face portion on the pretensioner unit 7 side of the take-up drum 181. The boss 187 is rotatably inserted into the bearing 235. The pawl base 231 supports each clutch pawl 232 in an accommodated position. The accommodated position is a position in which the entire clutch pawls 232 are accommodated within the outer peripheral portion of the pawl base 231.

The pawl guide 233 is a substantially ring-like member, and arranged at a position facing the pawl base 231 and each clutch pawl 232. Four positioning projections (not shown) are projected on the side face on the base plate 218 side of the pawl guide 233, and the positioning projections are inserted in positioning holes 218A of the base plate 218, respectively, and in the waiting state, the pawl guide 233 is fixed to the base plate 218 in a non-rotatable state.

On a surface on the pawl base 231 side of the pawl guide 233, position changing projecting portions 233A are projecting corresponding to clutch pawls 232, respectively. When the pawl base 231 and the pawl guide 233 are relatively rotated by the activation of the pretensioner unit 7, the clutch pawls 232 respectively make contact with the position changing projecting portions 233A, so that the position is changed from an accommodated position to a locking position. The locking position is a position in which the tip portions of the clutch pawls 232 project outward of the outer peripheral end portion of the pawl base 231.

Further, when the position of the clutch pawls 232 is changed to the locking position, the clutch pawls 232 is engaged with the take-up drum 181. Specifically, the clutch mechanism 216 is inserted in the boss 187 of the take-up drum 181 via the bearing 235, so as to rotatably support the take-up drum 181. When the clutch pawls 232 project to the outside of the outer peripheral end portion of the pawl base 231, the clutch pawls 232 are engageable with the internal gear 186 formed on the inner surface of the flange portion 185.

Then, when the clutch pawls 232 change the position to the locking position, the tip portion of each clutch pawl 232 engages with the internal gear 186, so that the pawl base 231 rotates the take-up drum 181. Incidentally, the engagement of the clutch pawl 232 and the internal gear 186 has an engagement structure that allows the take-up drum 181 to rotate in one direction, namely, in a take-up direction of the webbing 3.

Further, once engaged, the clutch pawls 232 each catch the internal gear 186 with deformation, so that when the take-up drum 181 rotates in the webbing pull-out direction after engagement, the pinion gear 215 is rotated in a direction opposite to the activation of the pretensioner unit 7 through the clutch mechanism 216, and the piston 213 is pushed back in the direction opposite to the activation direction. When the piston 213 is pushed back up to the point to release the engagement between the rack 213A of the piston 213 and the pinion gear teeth 215A of the pinion gear 215, the pinion gear 215 is released from the piston 213, so as to allow the take-up drum 181 to freely rotate with regard to the piston 213.

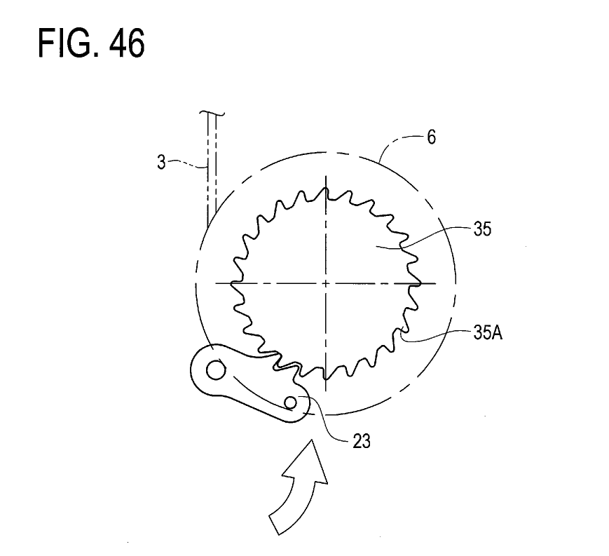

Next, the operation of the pretensioner unit 7 configured, as in the above, to be activated to take up the webbing 3 is discussed referring to FIGS. 45 and 46. FIG. 46 is an explanatory view illustrating the operation of the pawl 23 at vehicle collision.

As illustrated in FIG. 45, when the gas generating member 211 of the pretensioner unit 7 is activated at vehicle collision or the like, the pressure of the generated gas moves the piston 213 toward the tip portion of the piston guiding cylindrical portion 212A, and rotates the pinion gear 215 having the pinion gear teeth 215A engaging with the rack 213A (rotates in the counterclockwise direction in FIG. 45).

Further, at vehicle collision or the like, the inertial mass 52 of the vehicle acceleration sensor 28 moves on the bottom face portion of the sensor holder 51 to rotate the sensor lever 53 vertically upward. Thereby, as discussed above, the lock claw 53A of the sensor lever 53 rotates the pilot lever 86 vertically upward. Then the engagement claw portion 86A of the pilot lever 86 makes contact with a locking gear tooth 81A formed on the outer circumference portion of the locking gear 81.

Here, the engagement of the engagement claw portion 86A of the pilot lever 86 and a locking gear tooth 81A has an engagement structure that activates in one direction, namely, in a direction preventing the rotation of the take-up drum 181 in the pull-out direction of the webbing 3. Accordingly, when the pretensioner unit 7 is activated, even if the engagement claw portion 86A of the pilot lever 86 abuts on a locking gear tooth 81A, the take-up drum 181 is still smoothly rotatable in the take-up direction of the webbing 3.

Then, as illustrated in FIG. 45, as the pinion gear 215 rotates, the pawl base 231 rotates together with the pinion gear 215. At this time, the pawl base 231 relatively rotates with regard to the pawl guide 233; so that the position changing projecting portions 233A formed on the pawl guide 233 respectively abut on the clutch pawls 232 and the clutch pawls 232 are changed to the locking position.

As a result, the tip portion of each clutch pawl 232 engages with the internal gear 186 of the take-up drum 181, transmitting the force of the piston 213 to move to the tip end side of the piston guiding cylindrical portion 212A, to the take-up drum 181, through the pinion gear 215, the pawl base 231 the clutch pawls 232 and the internal gear 186. Thereby, the take-up drum 181 is rotatably driven in the take-up direction of the webbing 3, and the webbing 3 is taken up by the take-up drum 181.

At vehicle collision or the like, if the webbing 3 is pulled out subsequently after the activation of the pretensioner unit 7 and the take-up drum 181 rotates in the webbing pull-out direction, the engagement claw portion 86A of the pilot lever 86 engages with locking gear tooth 81A formed on the outer circumference portion of the locking gear 81 and the clutch 85 is rotated in the webbing pull-out direction. Accordingly, as illustrated in FIG. 46, the pawl 23 guided by the guiding hole 116 of the clutch 85 is made to engage with the ratchet gear portion 35A of the ratchet gear 35.

As explained, when the webbing 3 is pulled out successively after the activation of the pretensioner unit 7 at vehicle collision, etc., the engagement of the pawl 23 and the ratchet gear portion 35A serves to stop rotation of the ratchet gear 35 of the take-up drum unit 6 in the webbing-pull-out direction. Incidentally, the pawl 23 and the ratchet gear portion 35A has an engagement structure that allows the take-up drum 181 to rotate in one direction, namely, in pull-out direction of the webbing 3.

### [Energy Absorption]

Next, in a case where a vehicle occupant is relatively moved frontward with respect to the vehicle in a state that engagement of the pawl 23 and the ratchet gear portion 35A of the ratchet gear 35 is kept, after the activation of the pretensioner unit 7 at vehicle collision, etc., a significantly large pull-out load acts on the webbing 3. In a case where the webbing 3 is pulled out with the pull-out load exceeding predetermined value corresponding to threshold, rotation torque in the webbing-pull-out direction acts on the take-up drum 181.

Therefore, of the torsion bar 182, the spline 182A side press-fitted into the shaft hole 181A of the take-up drum 181 is rotated by the rotation torque acting on the take-up drum 181 in the webbing-pull-out direction so that torsional deformation starts at the shaft portion 182C of the torsion bar 182. The take-up drum 181 is rotated in the webbing-pull-out direction due to the torsional deformation at the shaft portion 182C of the torsion bar 182, whereby impact energy is absorbed in the form of the torsional deformation caused to the torsion bar 182, as “first energy absorption mechanism.”

Incidentally, since the pawl 23 and the ratchet gear 35 are engaged when the take-up drum 181 is rotated, relative rotation is caused between the ratchet gear 35 and the take-up drum 181. Consequently, relative rotation is subsequently caused between the wire 183 and the ratchet gear 35 due to rotation of the take-up drum 181, whereby the wire 183 serves to absorb impact energy, as “second energy absorption mechanism.”

### [Pull-Out-Wire Operation]

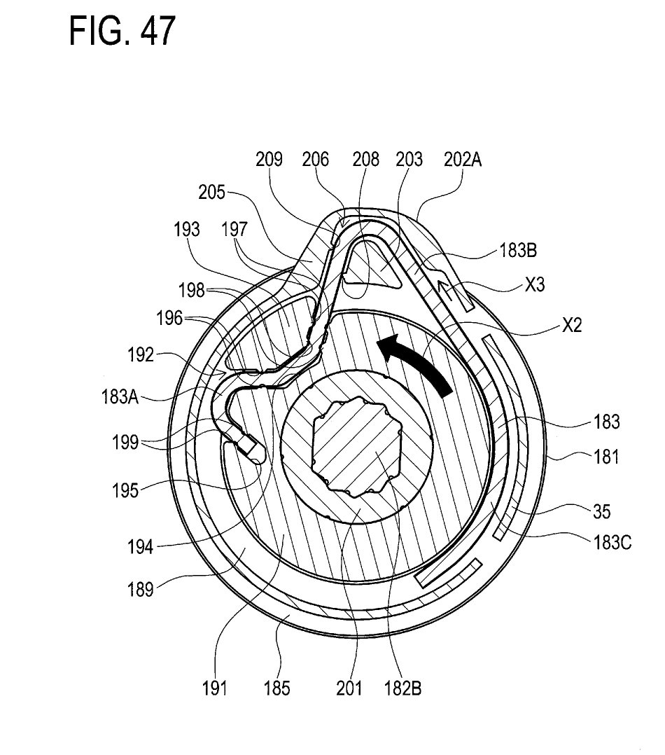

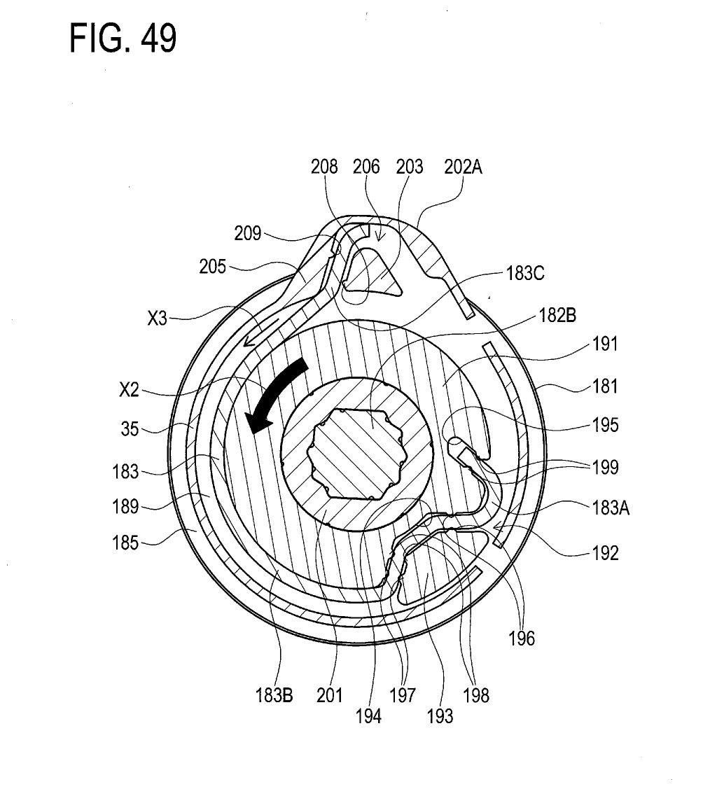

Here will be described on the operation of pulling out the wire 183 when absorbing impact energy with the wire 183 referring to FIG. 43, FIG. 47 through FIG. 50. FIGS. 43, 47 through 50 are views illustrating the operation of pulling out the wire 183.

As shown in FIG. 43, at the initial state between the take-up drum 181 and the ratchet gear 35, the end portion on the wire 183 exit-side of the convex portion 193 and that of the concave portion 194 constituting the holding-side crooked path 192 of the take-up drum 181 are located near the wire-pull-out-side end portion of the deformation-giving crooked path 206 formed on the outer periphery portion of the convex portion 203 arranged so as to project from the trapezoid-like portion 202A of the flange portion 202.

The crooked portion 183A that is a part of the wire 183 and bent like substantially S-shaped is fitted in and fixedly held by the holding-side crooked path 192 constituted by the convex portion 193, the concave portion 194 and the groove portion 195 of the take-up drum 181. The crooked portion 183B substantially inverted U-shaped in front view and formed so as to continue to the crooked portion 183A is fitted in the deformation-giving crooked path 206 formed on the outer peripheral portion of the convex portion 203 that is arranged so as to project from the trapezoid-like portion 202A.

Further, the substantially S-shaped crooked portion 183A of the wire 183 is held by the convex portion 193 constituting the holding-side crooked path 192 and by the ribs 197 and 198 provided on the opposing side faces of the concave portion 194. The crooked portion 183B having a substantially inverted U-shape and continuing to the crooked portion 183A is positioned within the deformation-giving crooked path 206 by the rib 208 provided on a side face of a wire-pull-out-side end portion of the convex portion 203 and by the rib 209 provided on a deeper side than the rib 208 of the flange portion 205 provided on the outer peripheral portion of the trapezoid-like portion 202A.

Thereby, the end portion on the wire 183 exit-side of the holding-side crooked path 192 and the wire-pull-out-side end portion of the deformation-giving crooked path 206 communicate each other almost straight via the wire 183. Further, a predetermined clearance (for instance, a clearance of approximately 0.2 mm) is formed between the side face portion facing the rib 208 on the wire-pull-out-side end portion of the deformation-giving crooked path 206 and the wire 183, and a predetermined clearance (for instance, a clearance of approximately 0.2 mm) is also formed between the outer circumferential surface of the convex portion 203 facing the rib 209 and the wire 183.

As shown in FIG. 47 through FIG. 50, when the take-up drum 181 rotates in the webbing-pull-out direction (in the direction indicated with arrow X2) in response to webbing-pull-out operation, rotation of the ratchet gear 35 is stopped by the pawl 23 (see FIG. 46) and the stepped portion 191 is relatively rotated in the webbing-pull-out direction (in the direction indicated with arrow X2) with respect to the trapezoid-like portion 202A of the ratchet gear 35.

Thereby, the wire 183 of which crooked portion 183A is fixedly held at the holding-side crooked path 192 of the stepped portion 191 is pulled out in the direction of arrow X3, while sequentially squeezed by the deformation-giving crooked path 206 substantially inverted U-shaped in front view and formed with the convex portion 203 projecting at the center of the trapezoid-like portion 202A and with the flange portion 205 projecting at the outer peripheral portion of the trapezoid-like portion 202A, and then taken up on the outer peripheral surface of the stepped portion 191. In concurrence with the pull-out operation of the wire 183, torsional deformation is caused to the torsion bar 182 by rotation of the take-up drum 181.

The wire 183 is deformed when passing through the deformation-giving crooked path 206 substantially inverted U-shaped in front view, and when passing, the wire 183 slides with friction to a side surface portion in the rotational direction of the stepped portion 191 (in the direction indicated with the arrow X2) opposite to the rib 208 on the wire-pull-out-side end portion of the deformation-giving crooked path 206 and to the outer peripheral surface of the convex portion 203, opposite to the rib 209 formed at the deeper position in axial direction of the wire 183 than the rib 208. Thereby, sliding resistance is caused between the convex portion 203 and the wire 183, and also bending resistance is caused by the wire 183 on its own. The sliding resistance and the bending resistance make up pull-out resistance, and the wire 183 absorbs impact energy with this pull-out resistance.

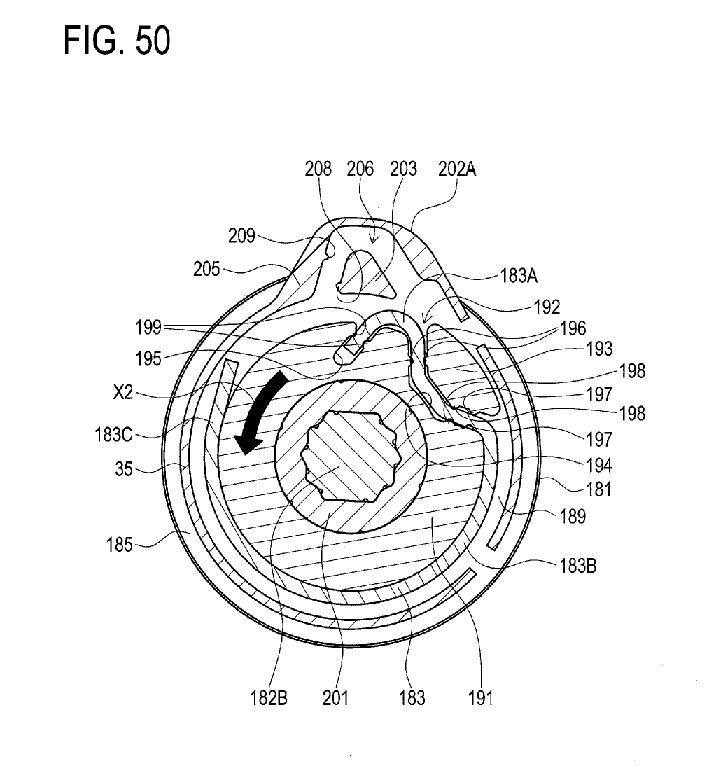

As shown in FIG. 50, when the end of the crooked portion 183C of the wire 183 leaves the deformation-giving crooked path 206 along rotation of the take-up drum 181, the impact energy absorption effect by the wire 183 terminates. Thereafter, impact energy is absorbed only by torsional deformation of the torsion bar 182 along rotation of the take-up drum 181.

As has been discussed above in detail, in the seatbelt retractor 1 according to the embodiment, when the engagement claw portion 86A of the pilot lever 86 has engaged with the locking gear tooth 81A of the locking gear 81 in an emergency, the timing for the pawl 23 to engage with the ratchet gear 35 may be delayed due to out-of-synchronization or the like. If the webbing 3 is pulled out in such a delayed state, the engagement claw portion 86A of the pilot lever 86 elastically deforms, toward the sleeve portion 121, mainly at the portion where the tip portion is bent obliquely. At the same time, the receiving plate portion 122 connected by the connecting plate portion 124 is elastically deformed toward the sleeve portion 121, so that the engagement claw portion 86A is elastically deformed into the approximately U-shape projecting radially outward.

Then, if the elastic deformation toward the sleeve portion 121 side of the receiving plate portion 122 connected by the connecting plate portion 124 and the engagement claw portion 86A of the pilot lever 86 reaches the amount of elastic deformation that causes the engagement claw portion 86A to be disengaged from the locking gear tooth 81A, the tip portion of the engagement claw portion 86A detaches radially outward from the locking gear teeth 81A. Thereafter, the elastic deformation of the engagement claw portion 86A and the receiving plate portion 122 connected by the connecting plate portion 124 is released, so that the pilot lever 86 having detached from the locking gear tooth 81A returns to the shape of the normal state.

Accordingly, after the engagement claw portion 86A of the pilot lever 86 engages with a locking gear tooth 81A in an emergency, the timing when the pawl 23 and the ratchet gear 35 engages may be delayed due to out-of-synchronization or the like. In such a case, the engagement claw portion 86A elastically deforms toward the sleeve portion 121 side in a large amount, and released from the locking gear tooth 81A having engaged with, so that the pilot lever 86 and the locking gear 81 can be prevented from damages. As the tip portion thereof is obliquely bent toward the locking gear 81 side, the engagement claw portion 86A can be smoothly disengaged from the locking gear tooth 81A if elastically deformed in large amount toward the sleeve portion 121 side.

Further, the engagement claw portion 86A and the receiving plate portion 122 connected by the connecting plate portion 124 can be made thinner and smaller enough to elastically deform toward the sleeve portion 121 side when engaged with and pushed by the locking gear tooth 81A. As a result, the pilot lever 86 can be made smaller. Both tip portions of the engagement claw portion 86A and the thin plate-like receiving plate portion 122 are connected by the thin plate-like connecting plate portion 124, so that the further thinning can be achieved while maintaining the mechanical strength of the engagement claw portion 86A, so that the pilot lever 86 can be made lighter and smaller.

After entering inside the opening portion 138 of the clutch 85 and engaging with the locking gear tooth 81A, the engagement claw portion 86A is elastically deformed by the push of the locking gear tooth 81A. A predetermined clearance is formed between the elastically-deformed engagement claw portion 86A and the sleeve portion 121 side end portion of the opening portion 138. Accordingly, the interference by the clutch 85 to the elastic deformation of the engagement claw portion 86A can be securely prevented, and the damage of the pilot lever 86 and the locking gear 81 can further be suppressed without hindering the elastic deformation of the pilot lever 86A.

Further, when a load is applied on the engagement claw portion 86A in a direction of the mounting boss 123 side, under a state where the engagement claw portion 86A is engaged with the locking gear tooth 81A, and the engagement claw portion 86A elastically deforms mainly at a portion where the tip portion is obliquely bent and further rotates, the upward rotation restrictor portion 125 of the pilot lever 86 abuts on the upward rotation restricting end face portion 132 of the pilot lever supporting block 131. Further, when the mounting boss 123 is warped, the outer circumferential surface of the sleeve portion 121 abuts on the load receiving surface 133 of the pilot lever supporting block 131.

As a result, the pressing load applied on the pilot lever 86 can be supported by the pilot lever supporting block 131 through the upward rotation restrictor portion 125 and the sleeve portion 121. Accordingly, even if the pilot lever 86 and the mounting boss 123 are downsized, deformation or damage of the sleeve portion 121 and the mounting boss 123 supporting the pressing load can be prevented with a simple configuration.

The pilot lever 86 is configured such that the upward rotation restrictor portion 125 and the downward rotation restrictor portion 126 hold the upward rotation restricting end face portion 132 and the downward rotation restricting end face portion 136 of the pilot lever supporting block 131 therebetween, securing a predetermined clearance in the rotation direction. Accordingly, with a simple configuration, rotation of the pilot lever 86 can be regulated and component shapes of the clutch 85 and the pilot lever 86 can further be simplified.

Further, the sleeve portion 121 is fitted onto the mounting boss 123 in the pilot lever 86, the convex portion 128 projecting from the outer circumferential surface of the sleeve portion 121 is contactably mounted onto the fixing projection 137A projecting from the tip portion of the elastic engagement piece 137 toward the sleeve portion 121 side from the base end side of the elastic engagement piece 137 as well as rotatably mounted to the mounting boss 123, so that slip-off of the pilot lever 86 from the mounting boss 123 can securely be prevented with a simple configuration.

The present invention is not limited to the above-described embodiment, but various improvements and modifications can be made thereto without departing from the spirit of the present invention. For instance, the following modification can be made. In the following discussion, the same reference numerals as those of the seatbelt retractor 1 according to the above-described embodiment depicted in FIGS. 1 through 50 represent the same or equivalent elements as those of the seatbelt retractor 1 according to the above-described embodiment.

### Different Embodiments

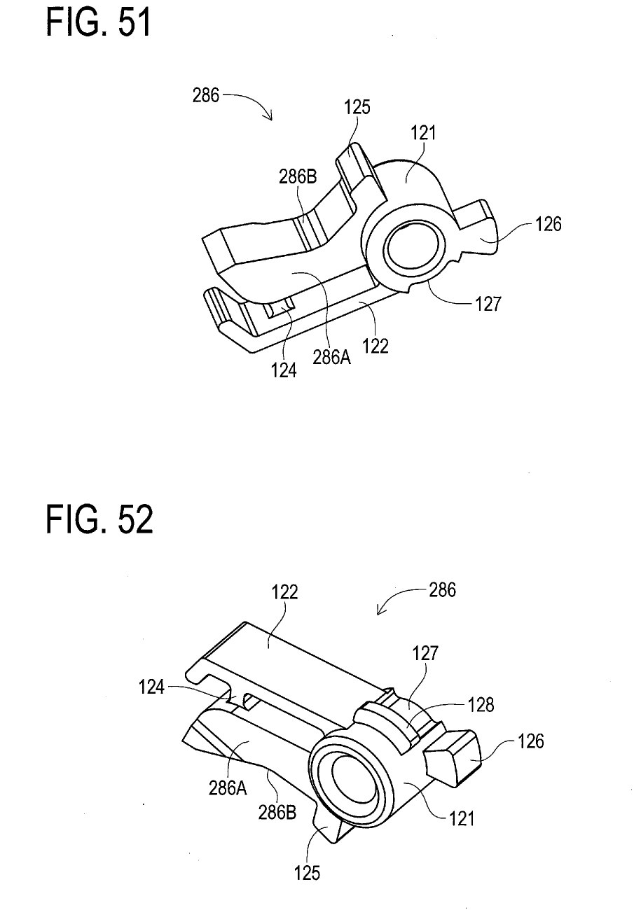

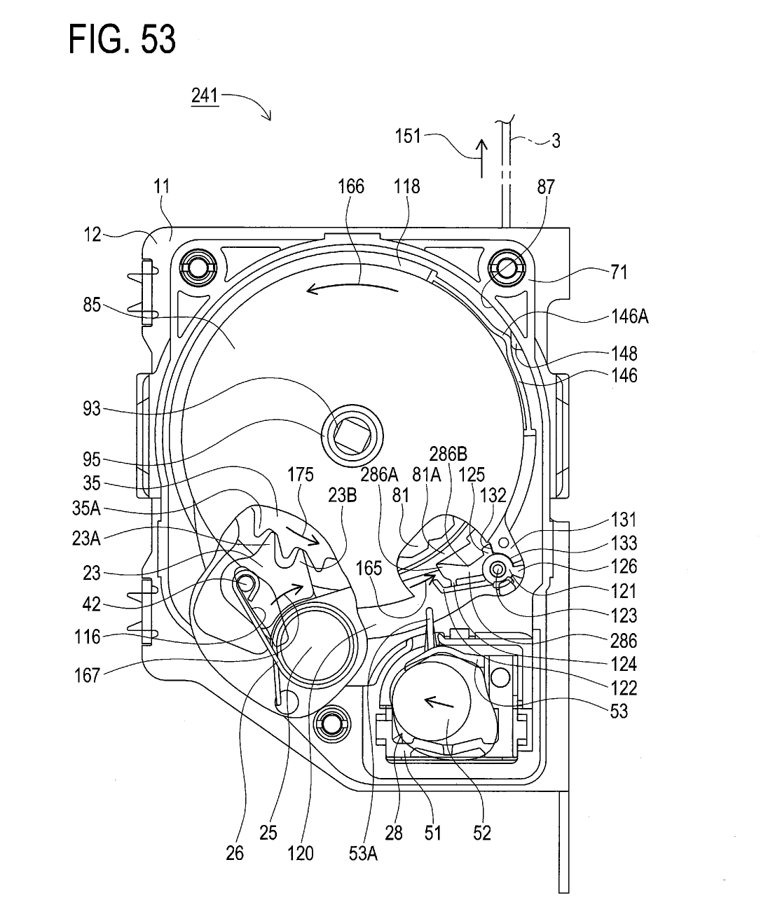

(A) A schematic configuration of a seatbelt retractor 241 according to a different embodiment will be described referring to FIGS. 51 through 56. FIGS. 51 and 52 each are a perspective view of a pilot lever 286 of the seatbelt retractor 241 according to a different embodiment. FIGS. 53 through 56 are explanatory views depicting the operations when the pawl 23 of the “vehicle-body-sensitive lock mechanism” of the seatbelt retractor 241 according to the different embodiment becomes out of synchronization. In FIGS. 53, 54 and 56, some portions are cut off to reveal the relation between the pawl 23 and the ratchet gear 35, to reveal the relation between the pilot lever 86 and the locking gear 81, and to reveal the relation between the sensor holder 51 and the sensor lever 53 of the vehicle acceleration sensor 28.

The schematic configuration of the seatbelt retractor 241 directed to the different embodiment is almost the same as that of the seatbelt retractor 1 directed to the above embodiment.

However, as illustrated in FIGS. 51 and 52, the configuration of a pilot lever 286 is almost the same as that of the pilot lever 86. An engagement claw portion 286A is formed such that the end face portion facing the locking gear 81 (the upper end face portion in FIG. 51) becomes gradually lower, from both end portions of the sleeve portion 121 side base end portion and the tip portion toward the approximately central portion, across the entire width in the rotational axis direction. Thereby, the engagement claw portion 286A has a bent portion 286B at the approximately central portion in the longer direction across the entire width in the rotational axis direction. The thickness of the bent portion 286B is thinner than those of both end portions of the sleeve portion 121 side base end portion and the tip portion.

However, the plate thickness of the bent portion 286B formed at the approximately central portion in the longer direction of the engagement claw portion 286A may be formed thinner than the plate thickness at the approximately central portion in the longer direction of the engagement claw portion 86A of the pilot lever 86 of the above embodiment. Thereby, the mechanical strength of the engagement claw portion 286A can be easily made larger than the mechanical strength of the engagement claw portion 86A of the pilot lever 86.

Next, the locking operation when the pawl 23 of the “vehicle-body-sensitive lock mechanism” becomes out-of-synchronization is discussed referring to FIGS. 53 through 56. As illustrated in FIG. 53, when the webbing 3 is pulled out in the direction of arrow 151 under a state where the engagement claw portion 286A of the pilot lever 286 engages with a locking gear tooth 81A of the locking gear 81, and the locking gear 81 is rotated in the webbing pull-out direction (in the direction of arrow 165). Further, with the rotation of the locking gear 81 in the webbing pull-out direction, the clutch 85 is rotated in the webbing pull-out direction (in the direction of arrow 166), and the pawl 23 is rotated toward the ratchet gear 35 side (in the direction of arrow 167).

Thereafter, as the clutch side projecting portion 146A is rotated toward the fixed side projecting portion 148 erected on the inner circumferential wall of the mechanism housing portion 87, the elastic rib 146 of the clutch 85 makes contact with and is pushed by the fixed side projecting portion 148, elastically deforms radially inward, and smoothly rides over the fixed side projecting portion 148.

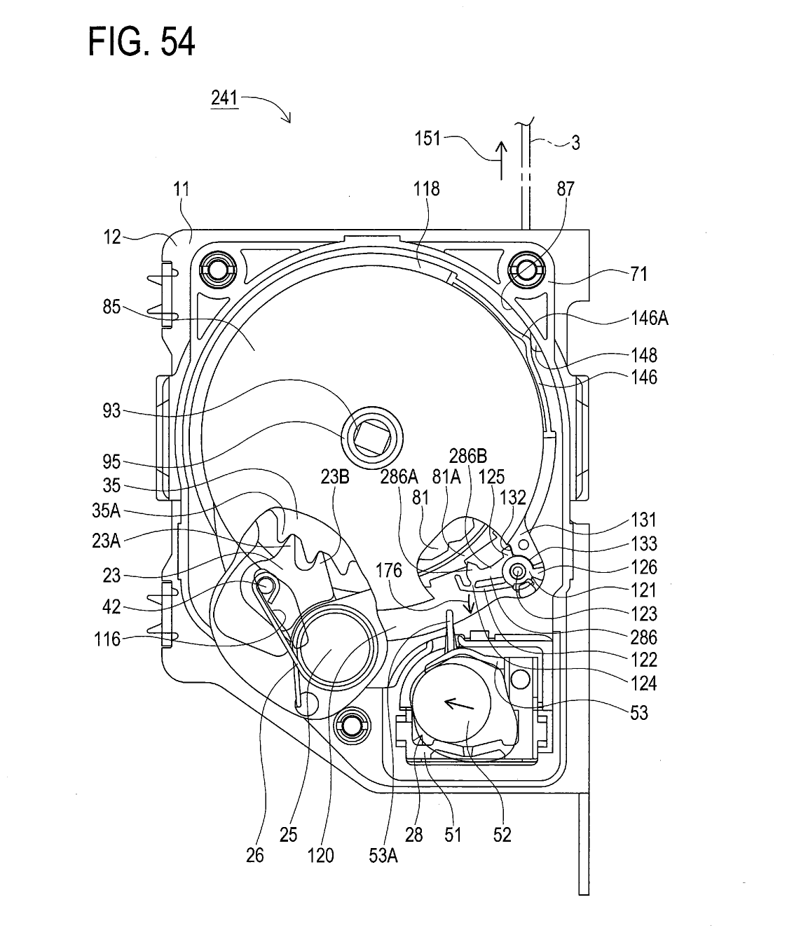

As illustrated in FIGS. 53 and 54, as each of the engagement teeth 23A and 23B of the pawl 23 makes contact with the ratchet gear portion 35A of the ratchet gear 35 to stop the rotation of the pawl 23, the rotation of the clutch 85 in the webbing pull-out direction (in the direction of arrow 166) is locked.

Meanwhile, there still is a slight clearance between the engagement teeth 23A and 23B of the pawl 23 and each tooth of the ratchet gear portion 35A that engages the engagement teeth 23A and 23B, as illustrated in FIG. 53. Accordingly, when the pull-out of the webbing 3 continues, the ratchet gear 35 rotates in the webbing pull-out direction (in a direction of arrow 175) until the lock is completed. At the same time, the locking gear 81 rotates integrally with the ratchet gear 35 and presses the engagement claw portion 286A of the pilot lever 286 engaging with a locking gear tooth 81A.

The pilot lever 286 is further rotated in a clockwise direction around an axial center of the mounting boss 123, and the upward rotation restrictor portion 125 makes contact with the upward rotation restricting end face portion 132 of the pilot lever supporting block 131, and vertically upward rotation is restricted. Further, at the same time, the mounting boss 123 deforms toward the pilot lever supporting block 131, and the sleeve portion 121 of the pilot lever 286 is made to abut on the load receiving surface 133 of the pilot lever supporting block 131.

As illustrated in FIGS. 54 through 56, the ratchet gear 35 is then further rotated in the webbing pull-out direction (in the direction of arrow 175) until the tip portion of each of the engagement teeth 23A and 23B of the pawl 23 makes contact with each tooth of the ratchet gear portion 35A and the locking operation is completed. Further, at the same time, the receiving plate portion 122 connected through the connecting plate portion 124 and the engagement claw portion 286A of the pilot lever 286 is pushed by the locking gear tooth 81A toward the sleeve portion 121 side, makes elastic deformation toward the sleeve portion 121 side, and warps into an approximately U-shape projecting radially outward. Here, the pilot lever 286 is elastically deformed toward the sleeve portion 121 side, at the bent portion 286B formed at the approximately central portion in the longer direction of the pilot lever 286.

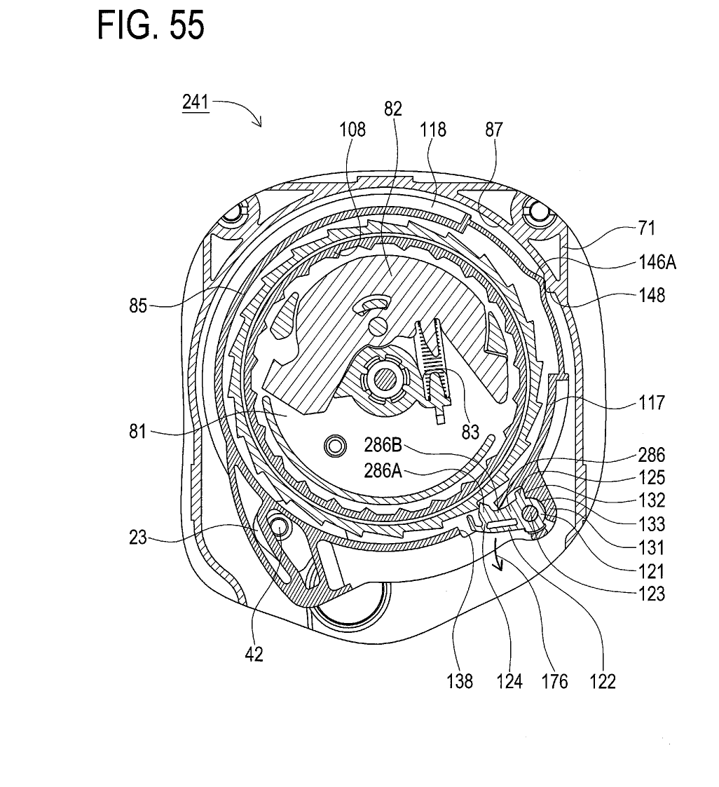

Further, as illustrated in FIG. 55, the opening portion 138 into which the pilot lever 286 of the clutch 85 enters is formed large enough to avoid contact with the engagement claw portion 286A and the receiving plate portion 122 connected through the connecting plate portion 124 even elastically deformed toward the sleeve portion 121 side and warped in an approximately radially-outward projecting U-shape. Further, as the engagement claw portion 286A elastically deforms at the bent portion 286B formed at the approximately central portion in the longer direction and warps in an approximately radially-outward projecting U-shape, the tip portion of the engagement claw portion 286A of the pilot lever 286 is gradually displaced radially outward (in a direction of arrow 176) with regard to the locking gear teeth 81A.

Accordingly, as illustrated in FIGS. 53 through 56, when an elastic deformation amount enough to release the engagement claw portion 286A from the locking gear tooth 81A is reached by the elastic deformation toward the sleeve portion 121 side of the receiving plate portion 122 connected through the connecting plate portion 124 and the engagement claw portion 286A of the pilot lever 286, the tip portion of the engagement claw portion 286A is disengaged radially outward from the locking gear tooth 81A.

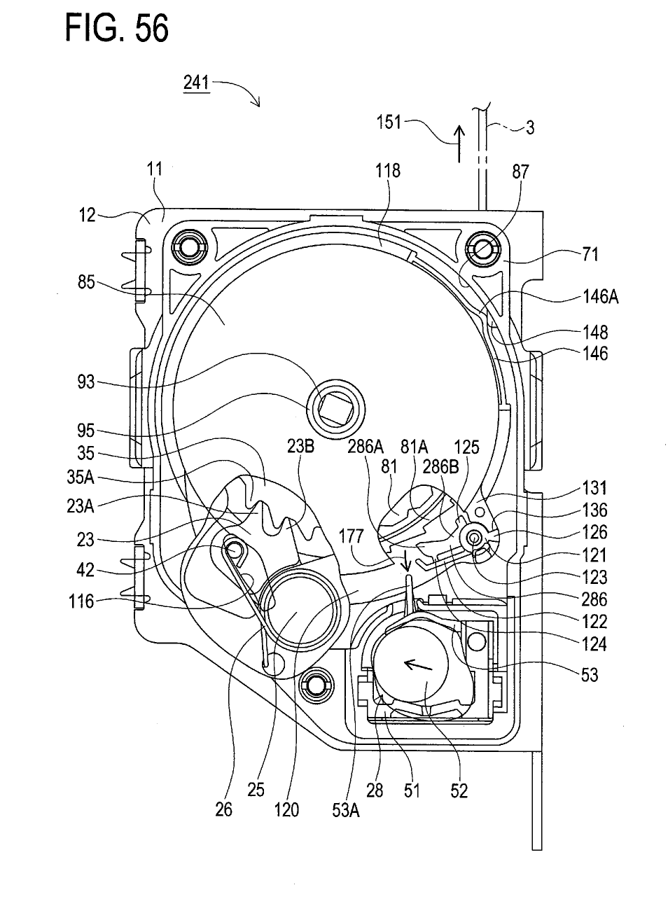

As illustrated in FIG. 56, as the elastic deformation of the engagement claw portion 286A and the receiving plate portion 122 connected through the connecting plate portion 124 is released, the pilot lever 286 disengaged from the locking gear tooth 81A returns to the shape of the normal state. Further, the pilot lever 286 rotates vertically downward (in a direction of arrow 177) by its own weight as the engagement between the engagement claw portion 286A and the locking gear 81 is released, and returns to the state of the initial position in which the downward rotation restrictor portion 126 of the pilot lever 286 abuts on the downward rotation restricting end face portion 136 of the pilot lever supporting block 131.

Further, the tip portion of each of the engagement teeth 23A and 23B of the pawl 23 makes contact with each tooth of the ratchet gear portion 35A and the lock operation is complete. Accordingly, the rotation of the take-up drum unit 6 is locked, and thus the pull-out of the webbing 3 is locked.

There, the clutch side projecting portion 146A of the elastic rib 146, which is formed projecting radially outward from the outer circumference portion of the clutch 85, deforms radially inward elastically, and then rides over the fixed side projecting portion 148 provided on the inner circumferential wall of the mechanism housing portion 87, and makes contact with, or is positioned in the vicinity of, a side portion on the webbing pull-out side of the fixed side projecting portion 148.

As a result, the engagement claw portion 286A elastically deforms toward the sleeve, portion 121 side at the approximately central portion from the tip portion to the sleeve portion 121 side base end portion of the engagement claw portion 286A when pushed by the locking gear tooth 81A, the impact load toward the pilot lever 286 and the locking gear 81 can be reduced, and the damage of the pilot lever 286 and the locking gear 81 can be effectively prevented. Further, the engagement claw portion 286A elastically deforms toward the sleeve portion 121 side at the approximately central portion from the tip portion to the sleeve portion 121 side base end portion, and elastically deforms into an approximately U-shape when viewed from the rotational axis direction at the large elastic deformation toward the sleeve portion 121 side, so that the engagement claw portion 286A can be smoothly disengaged from the locking gear tooth 81A formed on the outer circumference portion of the locking gear 81 and the engagement claw portion 286A can be made further smaller and thinner, resulting in further size reduction of the pilot lever 286.

However, even if the elastic deformation toward the sleeve portion 121 side of the receiving plate portion 122 connected through the connecting plate portion 124 and the engagement claw portion 286A of the pilot lever 286 does not reach the elastic deformation amount that allows the engagement claw portion 286A to be removed from the locking gear tooth 81A, the clutch side projecting portion 146A of the elastic rib 146, which is formed projecting radially outward from the outer circumference portion of the clutch 85, still deforms radially inward elastically, and then rides over the fixed side projecting portion 148 provided on the inner circumferential wall of the mechanism housing portion 87, and makes contact with, or is positioned in the vicinity of, a side portion on the webbing pull-out side of the fixed side projecting portion 148.

Accordingly, in the disengagement operation of the “vehicle-body-sensitive lock mechanism,” the engagement between the pilot lever 286 and the locking gear 81 can be released with only a little amount of take-up of the webbing 3 by the rotary differential imparting mechanism 149, and the lock of the rotation of the take-up drum unit 6 can also be released.

1. A seatbelt retractor comprising:
a housing;
a take-up drum rotatably housed in the housing and configured to take-up and store a webbing;
a ratchet gear configured to rotate integrally with the take-up drum;
a lock mechanism configured to prohibit the take-up drum from rotating in a webbing-pull-out direction in case of an emergency;
an inertial mass configured to oscillate in response to vehicle acceleration at a predetermined value or higher; and
a sensor lever configured to be swung vertically upward by a push of the inertial mass to activate the lock mechanism,
wherein the lock mechanism comprises:
a clutch rotatably arranged coaxially with the take-up drum, and configured, by its rotation, to guide a pawl configured to engage with the ratchet gear and then prohibit the take-up drum from rotating in the webbing pull-out direction;
a pilot lever rotatably supported at a mounting boss erected on the clutch and configured to rotate by a push of the swung sensor lever; and
a locking gear attached integrally and coaxially onto the take-up drum and configured to engage with the pilot lever having rotated,
wherein the pilot lever comprises:
a sleeve portion configured to be rotatably fitted on the mounting boss; and
an engagement claw portion projecting outward from an outer circumferential surface of the sleeve portion so as to face the locking gear, and configured to engage with the locking gear, and
wherein, the engagement claw portion is configured to:
on an emergency, engage with one locking gear tooth of locking gear teeth formed on an outer circumference portion of the locking gear;
elastically deform toward the sleeve portion by a push of the one locking gear tooth after the engagement on the emergency, and
release the elastic deformation when disengaged with the one locking gear tooth.

2. The seatbelt retractor according to claim 1, wherein the engagement claw portion is configured to elastically deform in a large amount toward the sleeve portion by a push of the one locking gear tooth and to disengage from the one locking gear tooth currently engaged, if a delay occurs in timing of the engagement of the pawl and the ratchet gear when the engagement claw portion has engaged with the one locking gear tooth.

3. The seatbelt refractor according to claim 1,
wherein the engagement claw portion is formed approximately L-shaped, when viewed in a rotational axis direction, with a tip portion thereof obliquely bent toward the locking gear, and
wherein the engagement claw portion is configured to elastically deform toward the sleeve portion, at a portion at which the tip portion of the engagement claw portion is obliquely bent, when pushed by the one locking gear tooth.

4. The seatbelt refractor according to claim 1,
wherein the engagement claw portion is formed such that an end face portion facing the locking gear becomes gradually lower from both end portions of a base end portion on a side of the sleeve portion and the tip portion, toward an approximately central portion, across an entire width in the rotational axis direction, and
wherein the engagement claw portion is configured to elastically deform toward the sleeve portion, at the approximately central portion of the engagement claw portion, when pushed by the one locking gear tooth.

5. The seatbelt refractor according to claim 1,
wherein the clutch comprises an opening portion configured to allow the pilot lever pushed and rotated by the sensor lever to enter therein and engage with one locking gear tooth, and
wherein, when the engagement claw portion is pushed by the one locking gear tooth and elastically deforms toward the sleeve portion, a predetermined clearance is formed between an end portion of the opening portion on a side of the sleeve portion and the engagement claw portion.

6. The seatbelt refractor according to claim 1,
wherein the pilot lever comprises:
a contact portion having a thin plate-like shape arranged approximately parallel to the engagement claw portion, and configured to make contact with and to be pushed by the swung sensor lever; and
a connecting plate portion having a thin plate-like shape and connecting both tip end sides of the contact portion and the engagement claw portion,
wherein the contact portion is elastically deformable toward the sleeve portion, together with the engagement claw portion.

7. The seatbelt refractor according to claim 1,
wherein the clutch comprises a pilot lever support portion projecting so as to oppose to, and form a predetermined clearance with, an outer circumferential surface of the sleeve portion fitted onto the mounting boss, on an diametrically opposite side with regard to the engagement claw portion,
wherein the pilot lever comprises an upward rotation restrictor portion erected radially outward from the outer circumferential surface of the sleeve portion so as to oppose to, and form a predetermined clearance in a rotation direction with, the pilot lever support portion, and
wherein, if the engagement claw portion engages with one locking gear tooth formed on the outer circumference portion of the locking gear on an emergency, under a state where the upward rotation restrictor portion abuts on one end face in circumferential direction of the pilot lever support portion to regulate vertically upward rotation, the pilot lever causes the clutch to rotate along rotation of the locking gear.

8. The seatbelt retractor according to claim 7,
wherein, the pilot lever comprises a downward rotation restrictor portion erected radially outward from the outer circumferential surface of the sleeve portion with a predetermined clearance in a rotation direction between the pilot lever support portion, in such a manner that the pilot lever support portion is interposed between the downward rotation restrictor portion and the upward rotation restrictor portion, and
wherein, if the engagement claw portion rotates by its own weight, the downward rotation restrictor portion abuts on another end face in the circumferential direction of the pilot lever support portion, to regulate the pilot lever with regard to vertically downward rotation.

9. The seatbelt refractor according to claim 7, wherein, if the engagement claw portion engages with one locking gear tooth formed on the outer circumference portion of the locking gear on an emergency to cause the mounting boss to warp, under a state where the outer circumferential surface of the sleeve portion abuts on the pilot lever support portion, the clutch is rotated along the rotation of the locking gear.

10. The seatbelt refractor according to claim 1,
wherein the clutch comprises an elastic engagement piece erected elastically deformably, radially outward with regard to the sleeve portion, while forming a predetermined clearance with the sleeve portion fitted on the mounting boss, and having, on a tip portion thereof, a fixing projection projecting toward the sleeve portion,
wherein the pilot lever comprises a convex portion projecting radially outward from the outer circumferential surface facing the elastic engagement piece, of the sleeve portion fitted on the mounting boss, and
wherein, through fitting the sleeve portion onto the mounting boss, the convex portion is arranged contactably with the fixing projection from a base end side of the elastic engagement piece, and the pilot lever is rotatably attached to the mounting boss.
